(19) United States
(12) Patent Application Publication
(10) Pub. No.: US 2009/0099897 A1
(43) Pub. Date: Apr. 16, 2009

(54) SYSTEM AND METHOD FOR MANAGING MOBILE ASSET WORKLOAD

(75) Inventors: Kenneth S. Ehrman, New York, NY (US); Michael L. Ehrman, New York, NY (US); Joseph M. Pinzon, Bronx, NY (US)

Correspondence Address: TROUTMAN SANDERS LLP;BANK OF AMERICA PLAZA, 600 PEACHTREE STREET, N.E., SUITE 5200, ATLANTA, GA, 30308-2216, US

(73) Assignee: I.D. Systems, Inc., Hackensack, NJ (US)

(21) Appl. No.: 12/252,297

(22) Filed: Oct. 15, 2008

Related U.S. Application Data
(60) Provisional application No. 60/979,964, filed on Oct. 15, 2007.
(60) Provisional application No. 60/979,968, filed on Oct. 15, 2007.
(60) Provisional application No. 60/979,969, filed on Oct. 15, 2007.

(51) Int. Cl. G06Q 10/00

(52) U.S. Cl. 705/9

(57) ABSTRACT

A system for managing a fleet of mobile assets is disclosed. The system comprises vehicle asset communicators coupled to mobile assets/vehicles, local monitors in wireless communication with the communicators, and a controller in communication with the communicators. The controller comprising logic configured to receive work requests to be completed by the fleet and heuristically determine which mobile asset/vehicle to assign each work request to. The controller can receive real-time operational information related to the fleet to assist in the determination of which mobile asset/vehicle is best suited to complete the work request. The communicators enable the operators of the mobile assets/vehicles to accept or decline the work request, and to cancel the work request after acceptance or report to the system that the work request has been completed.

### CROSS-REFERENCE TO RELATED APPLICATIONS

This application claims the benefit of U.S. Provisional Application Nos. 60/979,964, 60/979,968, 60/979,969, filed 15 Oct. 2007, which are hereby incorporated by reference in their entirety as if fully set forth below.

### BACKGROUND OF THE INVENTION

1. Technical Field of the Invention

The principles of the present invention are generally directed to an asset management system, and, more specifically, but not by way of limitation, to a heuristic vehicle control and work request dispatch system and method using a wireless architecture to monitor, control, and communicate with wireless devices associated with the assets.

2. Description of Related Art

The main assets of a business organization include buildings, equipment, people, money and data. Data assets are acquired, used, and maintained in the same manner as any other asset, and might include information regarding the other assets. Such assets can be mobile or fixed, tangible or intangible assets. Fixed assets may include equipment (e.g., manufacturing equipment), buildings, and fixtures. Mobile assets may include battery-powered or unpowered machines, such as forklifts, cars, boats, airplanes, loading equipment, railroad cars, and even small parcels, containers, letters, and even people. It should be understood that fixed and mobile assets may be personal, commercial, and/or military assets. Businesses must “manage” such assets to accomplish their business purposes.

The management of such assets includes financial, accounting, marketing, and regulatory issues, to name a few, related to the use of such assets for a particular business. Asset management systems facilitate the use of such assets for directing or carrying on such business and, as such, are evaluated in the context of a specific business. For example, package delivery companies are often interested in determining the location of its fleet of trucks so that the package delivery company may easily determine the time of arrival of the trucks. Car rental companies, too, are interested in determining exact locations of their vehicles for inventory purposes. Still yet, warehousing companies are interested in determining locations of particular mobile assets, such as forklifts and containers. Additionally, companies that utilize mobile assets, such as forklifts, are interested in providing access control to the mobile assets so that only those employees authorized to utilize the mobile assets may do so. Thus, asset management systems utilize different databases depending on the nature of the business and industry, which define the data elements for each database. Regardless of the variety of databases, asset management systems require robust communications systems to ensure that all of the data defined by the business is created, stored, processed and updated according to the mandates and specifications of that business.

Wireless communications systems have permeated all aspects of asset management systems and have become a prevalent tool in a variety of consumer and industrial applications worldwide. Such wireless communications systems include mobile telephones, satellite television, citizen-band radios, remote computer networking, wireless local area networks (LANs), and remote wireless devices. Typically, wireless communications systems, including those for asset management systems, include a central computing system coupled with a wireless infrastructure that communicates with multiple wireless devices associated with specific assets, i.e., an asset communicator. Conventional design methodology for the wireless communications systems requires that the asset communicator have an active communication link through the wireless infrastructure to the central computing system in order to operate and perform functions associated with the asset management system. In other words, without the communication links between the asset communicator, wireless infrastructure, and the central computing system, the asset communicator is either inoperative or not fully operative. Moreover, if either (i) the communication link between the central computing system and wireless infrastructure or (ii) the link between the wireless infrastructure and the asset communicator is not operating properly, many features of the asset communicator become inoperative. A useful asset management system must continue to manipulate the data as described above regardless of the loss or intermittent operation of the communication links and, therefore, requires a wireless communication architecture that facilitates the manipulation of this data. For example, an asset management system for vehicles might include access control data for authorized operators. However, as previously discussed, conventional communications systems utilized for asset management purposes require a communication link be established between the asset communicator and the central computing system. Hence, the asset management system must utilize a wireless communication architecture that is not fully dependent upon instantaneous or active communication between the central computer and the asset communicators.

As indicated above, asset management systems and their associated wireless communications systems are developed and operated in the context of a specific business to resolve specific business problems. Continuing with the example of a mobile asset or vehicle (e.g. a forklift) and an asset communicator attached to the vehicle that processes access control for the vehicle, a manager of a fleet of vehicles is generally interested in optimizing the usage of such vehicles to execute tasks associated with work requests. Conventional asset management systems do not have to ability to track an asset and its status in real time. Consequently, such conventional systems do not have the ability to determine which vehicle in the fleet is best suited to handle the next work request that must be completed. Therefore, there is a need for an asset management system that is capable of tracking vehicles in a fleet, receiving and processing work requests, determining which vehicle is best suited to complete the work request, and assigning the work request to such a vehicle.

### SUMMARY OF THE INVENTION

To overcome the inherent deficiencies of conventional fleet management systems, a heuristic mobile asset management system for use with a wireless communications system has been developed. The heuristic mobile asset management system of the present invention comprises a work request dispatch engine that can be operable to receive work requests from both internal and external sources, and assign a task associated with the work request to the next available operator based on a variety of heuristic. The work request dispatch engine preferably can maintain and manage the work requests and based on system configuration parameters load balance the work between operators.

The system can comprise vehicle asset communicators coupled to mobile assets/vehicles, local monitors in wireless communication with the communicators, and a controller in communication with the communicators. The controller can comprise logic configured to receive work requests to be completed by the fleet and heuristically determine which mobile asset/vehicle to assign each work request to. The controller can receive real-time operational information related to the fleet to assist in the determination of which mobile asset/vehicle is best suited to complete the work request. The communicators enable the operators of the mobile assets/vehicles to accept or decline the work request and to cancel the work request after acceptance or report to the system that the work request has been completed.

In accordance with an exemplary embodiment, a system for managing a mobile asset/vehicle fleet may comprise a first and second vehicle asset communicator adapted to couple to a first and second mobile asset/vehicle and monitor operational parameters of the first and second mobile asset/vehicle, respectively. The system may also comprise a first controller having a wireless transceiver. The first controller is capable of communication with the first vehicle asset communicator and the second vehicle asset communicator. The first controller comprises a logic element. The logic element is configured to: receive a work request to be performed by a mobile asset/vehicle; determine whether to assign the work request to the first mobile asset/vehicle or the second mobile asset/vehicle based at least in part upon the operational parameters of the first mobile asset/vehicle and the operational parameters of the second mobile asset/vehicle; and transmit the work request to the first vehicle asset communicator if the first mobile asset/vehicle is selected to perform the work request.

In accordance with another exemplary embodiment, an asset control system for managing a fleet of mobile assets/vehicles may comprising a work request receipt interface for receiving a work request from a user and storing the work request to a work request queue. The system may further comprise a work request assignment engine for: receiving operational parameters for a plurality of mobile asset/vehicles; selecting a work request from the work request queue to assign to a mobile asset/vehicle; and determining which mobile asset to assign the task to based on the operational parameters of the mobile asset/vehicles. The system may further comprise a work request handler module for transmitting the work request to the assigned mobile asset/vehicle.

In accordance with a further exemplary embodiment, a method for managing a plurality of mobile assets/vehicles each having a vehicle asset communicator may comprise receiving a work request to be executed by one or more of the plurality of mobile asset/vehicles, the work request having associated operational requirements and monitoring one or more operational parameters of the mobile assets/vehicles. The method may further comprise selecting a first mobile asset/vehicle of said plurality of mobile asset/vehicles to assign the work request to based upon the monitored operational parameters of the mobile assets/vehicles and the operational requirements of the work request. Additionally, the method may comprise transmitting the work request to the vehicle asset communicator of the first mobile asset/vehicle.

These and other features as well as advantages, which characterize various exemplary embodiments of the present invention will be apparent from a reading of the following detailed description and a review of the associated drawings.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is an exemplary block diagram of a robust wireless communications system for performing asset management according to the principles of the present invention;

FIG. 2 is a more detailed block diagram of the robust wireless communications system of FIG. 1;

FIG. 3 is another exemplary block diagram of the robust wireless communications system of FIGS. 1 and 2;

FIG. 4 is an exemplary interaction diagram for performing downlink and uplink communications between components of the robust wireless communications system of FIG. 3;

FIG. 5 is an exemplary interaction diagram for performing immediate communications between the components of FIG. 3;

FIGS. 6A and 6B are exemplary databases operating in the robust wireless communications system of FIG. 3;

FIG. 7 is an exemplary flow diagram for communicating data in the robust wireless communications system of FIG. 3;

FIG. 8 is another exemplary flow diagram for communicating data in the robust wireless communications system of FIG. 3;

FIGS. 9A and 9B are exemplary flow diagrams for performing uplink communication on the robust wireless communications system of FIGS. 3, 4, and 6B;

FIG. 10 is a graphical representation of entities associated with the robust wireless communications system of FIG. 3 and relational databases associated therewith;

FIG. 11 is an exemplary flow diagram for determining and providing authorization of an asset for an operator utilizing the robust wireless communications system of FIGS. 3, 4, and 6A;

FIG. 12 is an exemplary flow diagram describing altering system parameters for the robust wireless communications system of FIG. 3;

FIG. 13 is an exemplary flow diagram for the asset communicator to start and stop utilization monitoring as utilized on the robust wireless system of FIGS. 3 and 6B;

FIG. 14 is an exemplary illustration of a mobile asset having a power monitor for monitoring power usage according to FIG. 13;

FIG. 15 is an exemplary chart indicating vehicle usage during the course of a 24-hour time period on the robust wireless communications system of FIG. 3;

FIG. 16 represents an exemplary flow diagram for determining and communicating position of an asset utilizing the robust wireless communications system of FIGS. 3-5 and 6B;

FIG. 17A is an exemplary flow diagram for performing the OSHA compliance utilizing the robust wireless communications system of FIGS. 3-5, 6A and 6B;

FIG. 17B is an exemplary block diagram for integrating a checklist database and event/trigger database into the relational databases of FIG. 10;

FIG. 17C is an exemplary tree structure representative of a question list that may be utilized by the asset communicators of FIG. 1 to ask questions directed to OSHA or for other purposes;

FIG. 18 is an exemplary flow diagram providing a process for performing the two-way messaging on the robust wireless communications system of FIG. 3;

FIG. 19 is an exemplary flow chart providing a process for measuring battery voltage of an asset utilizing the robust wireless communications system of FIGS. 3, 4, and 6B;

FIG. 20 is an exemplary flow diagram 1900 providing for a process of changing the battery with a charged battery utilizing the robust wireless communications system of FIGS. 3-5, 6A, and 6B;

FIG. 21 is a typical working environment for a mobile asset utilizing the robust wireless communications system of FIG. 3 to charge and replace a battery;

FIG. 22 is a top view of an exemplary mobile asset of FIG. 1 capable of measuring impact of the mobile asset;

FIG. 23 is an exemplary flow diagram for monitoring of an impact to the mobile asset of FIG. 21;

FIG. 24 is an exemplary block diagram indicative of a method for managing scheduled maintenance of assets utilizing the robust wireless communications system of FIG. 3 and communication technique of FIG. 4;

FIG. 25 is an exemplary embodiment of the wireless infrastructure of FIG. 1 for providing wireless communications on a remotely populated fleet of assets, such as railcars;

FIG. 26 is an exemplary flow diagram for managing the remotely populated assets utilizing the robust wireless communications system of FIG. 3;

FIG. 27 illustrates a block diagram of an exemplary embodiment of a work request dispatch engine;

FIG. 28 illustrates a block diagram of an exemplary embodiment of a work request receipt interface in accordance with an exemplary embodiment of the present invention;

FIG. 29 is a flow diagram illustrating the assignment and queuing table management process of an exemplary embodiment of a work request assignment engine;

FIG. 30 is a flow diagram illustrating the cancellation process administered by a work request assignment engine in accordance with an exemplary embodiment of the present invention;

FIG. 31 is a flow diagram illustrating operation of a work request handler module in accordance with an exemplary embodiment of the present invention; and

FIG. 32 illustrates a flow diagram of a process for identifying work request handler module responses in accordance with an exemplary embodiment of the present invention.

FIG. 33 illustrates an exemplary embodiment of a work request dispatch engine.

FIG. 34 illustrates a flowchart of an exemplary embodiment of a process for submitting a new job request from a LAC.

FIG. 35 illustrates a flowchart of an exemplary embodiment of a process for canceling a work request submitted by a LAC.

FIG. 36 illustrates a flowchart of an exemplary embodiment of a process for completed work requests submitted by a LAC.

FIG. 37 illustrates a flowchart of an exemplary embodiment of an interaction process between a LAC and a LAC handler module.

FIG. 38 is a flowchart of an exemplary embodiment of a job code selection process.

### LIST OF TABLES

TABLE 1. Vehicle Information;
TABLE 2. Operator Information;
TABLE 3. Group Information;
TABLE 4. Vehicle Utilization Information;
TABLE 5. Vehicle Location Information;
TABLE 6A. OSHA Question List Details;
TABLE 6B. Vehicle Profile Information;
TABLE 7. Low Battery Information;
TABLE 8. Impact Information;
TABLE 9 Layout of the submission module;
TABLE 10 Validation routines and return codes of the submission module;
TABLE 11 Layout for web based submission module;
TABLE 12 Validation routines and return codes of the web based submission module;
TABLE 13 Layout for work request receipt interface;
TABLE 14 Validation routines and return codes of the status module;
TABLE 15 Layout for canceling a work request with the work request receipt interface;
TABLE 16 Validation routines and return codes for canceling a work request with the work request receipt interface;
TABLE 17 Layout for indicating a work request as being completed with the work request receipt interface;
TABLE 18 Validation routines and return codes for indicating a work request as being completed with the work request receipt interface; and
TABLE 19 Work request status identifiers.
TABLE 20 Pallet rider Job Codes
TABLE 21 Sit Down Rider Job Codes

### DETAILED DESCRIPTION OF THE EXEMPLARY EMBODIMENTS OF THE INVENTION

Asset management and tracking has become an important issue for large and small companies due to financial considerations, customer concerns, and governmental regulations, for example. Technology in the fields of information technology (IT) and telecommunications has evolved to enable robust wireless communications to perform asset management, especially in a variety of aspects that solve business problems that do not necessarily require instantaneous or active communication between a central computer and an asset (i.e., mobile or fixed). As even the most stable communications networks tend to fail, depending on the particular asset management application, failure of the communications network may severely disrupt business operations. Additionally, communications networks may be bandwidth and/or cost prohibitive for many asset management applications.

The principles of the present invention provide for a robust wireless communications system that performs asset management of mobile and/or fixed assets. The robust wireless communications system accounts for network failures and throughput issues by providing intelligence in both the wireless infrastructure and mobile wireless devices (e.g., asset communicators) associated with the assets. By including intelligence in the wireless infrastructure and asset communicators, the assets may remain substantially operational even in the event of a communication link failure between the central computer and the wireless infrastructure and/or between the wireless infrastructure and the asset communicator(s). Additionally, an asset that becomes out-of-range of the wireless infrastructure may still perform intended duties and utilize the associated asset communicator to perform the asset management functions. Furthermore, by incorporating intelligence into the wireless infrastructure and asset communicators, business decisions can be made that are simply not possible without such intelligent devices, often without transmitting any data.

The robust wireless communications system is capable of distributing downlink data utilized in performing the asset management functionality in a sequential, but not necessarily simultaneous, transmission from the central computing system to the wireless infrastructure and from the wireless infrastructure to the asset communicators. In that regard, and in contrast to traditional wireless communications systems, the asset communicators need not have active links between (i) the central computing system and wireless infrastructure, and (ii) the wireless infrastructure and asset communicators for the data to be downloaded to the asset communicators. Accordingly, the data may be transmitted to the asset communicators by the wireless infrastructure irrespective of the communication link between the central computing system and wireless infrastructure. In the uplink direction, the asset communicators are able to receive data from the asset and/or generate data without an active communication link with either the wireless infrastructure and/or the central computer. Upon the communication link between the asset communicator and wireless infrastructure becoming established, the data may be uploaded to the wireless infrastructure, stored therein, and further uploaded from the wireless infrastructure to the central computing system upon a connection being established thereto.

To enable synchronization of the downlink and uplink between the central computing system, wireless infrastructure, and asset communicators, transaction codes may be applied to individual datasets or data records. By applying transaction codes that are temporal (i.e., based on time of creation), the synchronization process may be maintained even if a communication failure occurs during synchronization of the data by determining the transaction codes that exist in the different locations, and continuing synchronizing therefrom. On the downlink communication, the transaction code is used to indicate the most up-to-date data. On the uplink communication, the transaction code is used to create a unique key for ensuring the integrity of data such that the order and uniqueness of each dataset is maintained.

In the central computing system, datasets may be generated by a supervisor or operator who enters new data or edits existing data to download to the asset communicator(s). The asset communicators operate in an intelligent manner by, in general, forming data records based on events or based on receiving data from an operator interfacing with the asset communicator. One example of an event may include a vehicle operator logging on, performing various duties with the vehicle, and logging off. Upon logging off, because the asset communicator is intelligent, a summary of operational information (i.e., dataset) that a customer desires may be generated, applied a transaction code, and stored on the asset communicator. The dataset, including the associated transaction code, may thereafter be transmitted to the wireless infrastructure and/or be used by the asset communicator to make decisions about future transactions (e.g., re-use of previously entered data, such as an OSHA checklist, for future operator(s)).

By the asset communicator summarizing the information rather than periodically transmitting the intermittent information to the wireless infrastructure, (i) the asset management may occur without an active communication link between the asset communicator and the wireless infrastructure, (ii) the bandwidth (and potentially communication cost) of the system may be reduced, (iii) the central computing system need not be overloaded with computational responsibilities that the distributed asset communicators are capable of handling, and (iv) the cost of system components (e.g., asset communicators, communication devices, and infrastructure installation costs) may be reduced due to the amount of memory and communication requirements being reduced. Additionally, and more importantly, the robust communications system may solve many business problems that otherwise could not be solved as the asset communicator and system are capable of performing many, if not all, of the intended business functions on future transactions without either (i) a link between the wireless infrastructure and the asset communicator and/or (ii) a link between the wireless infrastructure and the management computer system.

### Robust Wireless Communications System Architecture

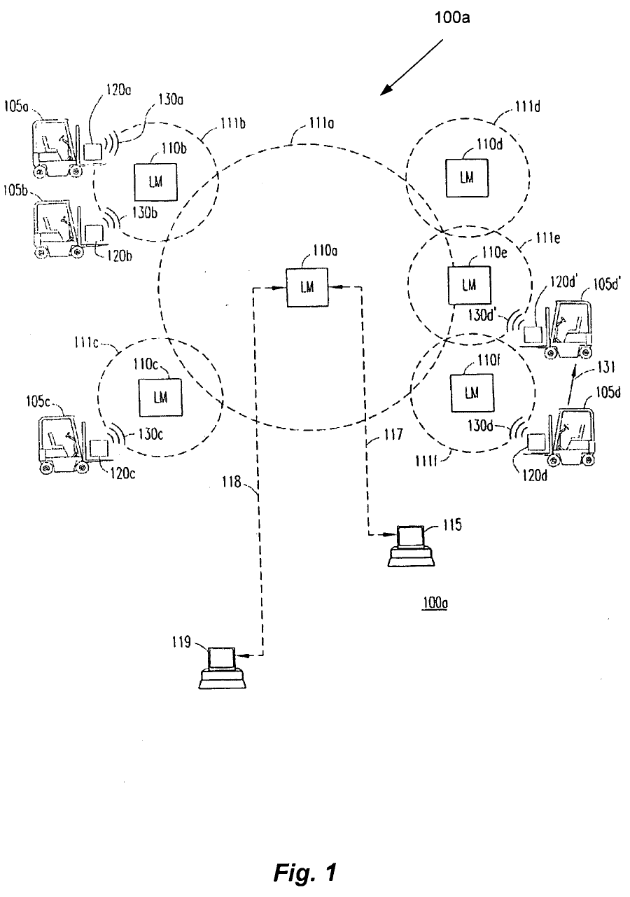

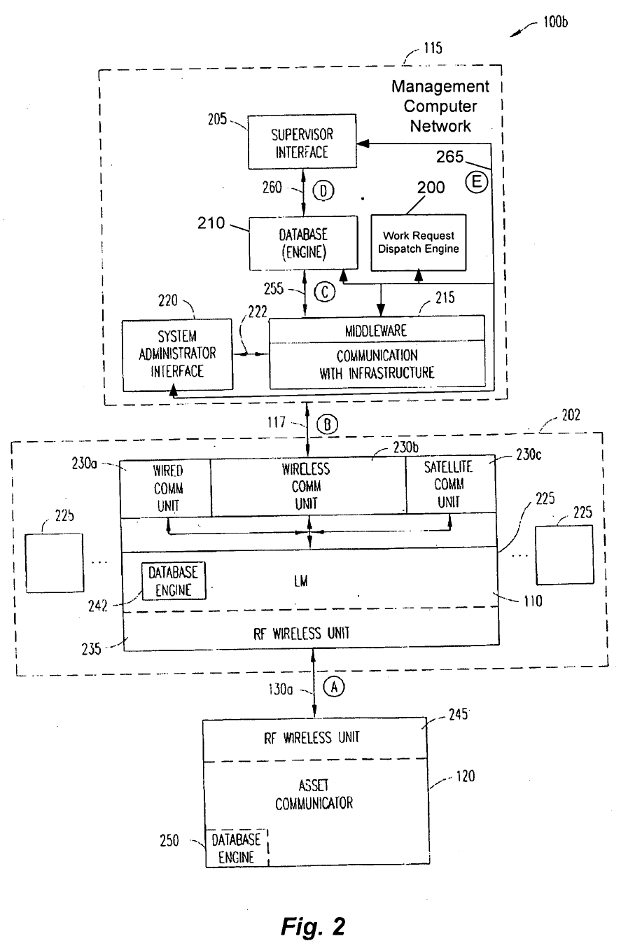

FIG. 1 shows an exemplary block diagram of a wireless communications system 100a for an asset management system according to the principles of the present invention, and more specifically, but without limitation, an asset management system for managing forklifts 105a-105d (collectively 105), each forklift 105 run by an operator. The robust wireless communications system 100a includes at least one local monitor (LM) 110a-110f (collectively 110) having a wireless unit operative with a communication range defined by the cells 111a-111f, respectively (collectively 111), of various radii, and a management computer network 115, configured in a central or distributed processing configuration, coupled to the local monitors 110 via a local communication link 117. For the local monitor to communicate with the management computer network 115, communication equipment (see, FIG. 2, units 230a-230c) is utilized.

The local monitors 110 may be coupled to the management computer network 115 as shown by the local monitor 110a, or indirectly through a local supervisory computer (not shown) operating as a monitor to the management computer network 115. The cells 111 of the local monitors 110 may overlap (as shown by the cells 111d-111f) or not (as shown by the cells 111b-111c) depending on the particular business needs and the space to be monitored. When more than one local monitor 110 is utilized, they may be positioned to cover a larger and/or more asymmetric service area as defined by the particular needs of the business. For example, a multiple cell III structure may be designed to cover all the areas of a manufacturing facility that might be visited by a forklift 105, including both permissible and prohibited areas for a particular forklift operator. The local monitors 110 have the ability to use directional antennas, as understood in the art, and/or dynamically change coverage range to cover certain areas. To dynamically change coverage range, the local monitors 110 may be software controlled to adjust transmission power. In one embodiment, a variable attenuator may be utilized to reduce the amount of output power from a local monitor. The adjustment of coverage range may be utilized to further refine the location of assets. In another embodiment, a local monitor near a door, such as a warehouse loading dock door, may be configured to have a limited communication range for the immediate area in front of the door.

It should be understood that the wireless architecture between the management computer network 115 and the local monitors 110 vary depending on the type of asset being managed for a specific business need. The local monitors 110 also have data processing and storage capability along with its wireless communication equipment. The local monitors 110 may also be coupled via a network communication link 118 to other networks (not shown) such as, for example, the Internet to a web server 119 or wireless local area network. The web server 119 may be accessed by a customer renting a vehicle or a manager of certain databases in the asset management system to inspect parameters and operating conditions of the system.

The robust wireless communications system 100a also includes asset communicators 120a-120d (collectively 120), each one associated with a specific asset, and in this embodiment, a forklift 105a-105d, respectively, for communicating with the local monitors 120 via their associated asset communication links 130a-130d (collectively 130), respectively. The asset communication links 130 may be any form of wireless communication link including, without limitation, cellular, radio frequency (RF) (possibly including adjustable range), wireless Ethernet (i.e., the 802.11b wireless communication standard), paging, satellite, or a combination of any of the foregoing. The asset communicators 120 also have data processing and storage capability along with their wireless communication equipment.

In operation, the asset communicators 120 become active for uplinking or downlinking data when it comes within the range of the cell 111 of one of the local monitors 110 to establish the corresponding asset communication link 130 with the local monitor 110. The establishment of the asset communication links 130 is independent of the local communication link 117 for any of the local monitors 110. Each asset communicator (i) identifies the local monitor(s) 110 in communication therewith and (ii) determines what, when, and how often to communicate. To identify the local monitor(s) 110, the asset communicator 120 receives identifier(s) associated with the local monitor(s) 110 and determines the available communication link(s) 130. The data being communicated is dependent on the business problems currently being performed by the asset communicators 110. When and how often to communicate the data may be determined by current operating conditions and/or predetermined rules and system parameters.

Data is uplinked or downlinked between one of the asset communicators 120 and one of the local monitors 110 only when the corresponding forklift 105 moves within the range of the cell 111 of that local monitor 110. For example, when a first forklift 105a moves within the range of the cell 111b, the asset communication link 130a is established between the asset communicator 120a and the local monitor 110b, whereupon data stored on either one of the devices can be uplinked to, or downlinked from, the other device. A second forklift 105b might move within the range of the same cell 111b to establish a similar asset communication link 130b between its asset communicator 120b and the same local monitor 110b. A third forklift 105d might move within the range of the cell 111f to establish a first asset communication link 130d between its asset communicator 120d and the local monitor 110f, and then move out-of-range into the range of the cell 111e as shown by the arrow 131 to establish a second asset communication link 130d′ at a later time between the asset communicator 120d′ and a second local monitor 110e. An asset communicator 120b may have multiple links open simultaneously with different local monitors 110, and use the best communication link for both uplink and downlink communications.

Referring more specifically to the example of a forklift operator above, in the robust wireless communications system 100a may be a multi-cell system as just described including a database that permits a specific forklift operator to be operating the forklift 105d in an area covered by the local monitor 110f, but prohibits the same operator from driving that forklift to another area covered by the local monitor 110e. This part of the database is stored by the asset communicator 120d setting forth the permissible and prohibited areas of operation for that operator as soon as she identifies herself by logging-in to start the forklift 105d. If she drives the forklift 105d into the range of the cell 111e, the asset communicator 120d′ may determine its communication link status and communicate the presence and identification of both the forklift and the operator to the local monitor 110e via the asset communication link 130d′. The asset communicator 120d′ may take active measures to alert the operator of the location violation and/or disable the forklift. Alternatively or additionally, the data would then be stored in the memory of local monitor 110e and processed to alert the operator of the violation, shut down the forklift 105d′, and/or notify a supervisor of the breach by uplinking the data from the local monitor 110e to the management computer network 115 via the local communication link (not shown), but only when that local communication link is established. As indicated above, the establishment of the asset communication links 130 is independent of the local communication link 117 to the management computer network 115. For example, the database could have been updated by the management computer network 115 to update the database on the local monitor 110e, but not the asset communicator 120d, authorizing the operator to be in the area covered by the cell 111e before the operator entered that area. Upon entering this area, the local monitor 110e would update the asset communicator 120d′ so that it would not transmit a breach signal to the local monitor 110e.

FIG. 2 is a more detailed block diagram of the robust wireless communications system of FIG. 1. The robust wireless communications system 100b includes the management computer network 115, wireless infrastructure 202, and asset communicator 120. The management computer network 115 includes a work request dispatch engine 200, supervisor interface 205, database engine 210, middleware 215, and system administrator interface 220. The work request dispatch engine 200 can be operable to receive work requests from both internal and external sources, and assign a task associated with the work request to the next available operator based on a variety of heuristic. The work request dispatch engine 200 preferably can maintain and manage the work requests and based on system configuration parameters load balance the work between operators. The supervisor interface 205 can be operable to provide a supervisor (e.g., a user or an external computing system operable to perform supervisory functions) of the management computer network 115 the capability to view data or update data (i.e., create new data, edit existing data, and/or delete existing data) stored in a database. For example, a supervisory user (i.e., supervisor) may use the supervisor interface 205 to view an asset location report stored in the database, and a supervisory computing device may automatically update a list of employees stored in the database. The database engine 210 may be any software operable to manage data stored in the database. For example, the database engine 210 may be a commercial (e.g., Oracle) or non-commercial database engine. The middleware 215 is software and/or hardware operable to provide communication between the database engine 210 and wireless infrastructure 202. The middleware 215 may also provide other management or functional operations as understood in the art. The system administrator interface 220 provides a system administrator the ability to perform a variety of functions in direct communication with the middleware via a communication link 222. One function that may be performed by the system administrator interface 220 includes altering the communication range of one or more local monitors 110.

The wireless infrastructure 202 includes at least one wireless infrastructure unit 225. The wireless infrastructure unit 225 includes a local monitor 110, at least one of which is coupled to a wired communication unit 230a, a wireless communication unit 230b (e.g. cellular or wireless LAN), and/or a satellite communication unit 230c (collectively 230) that communicates with the middleware 215 via the local communication link 117. The local monitor 110 includes a processor for operating a database engine 242, which may be the same or similar to the database engine 210 of the management computer network 115, and other software (not shown) that performs specific business functions. The wireless infrastructure unit 225 further includes a radio frequency (RF) wireless unit 235. The RF wireless unit 235 may include hardware and software for performing wireless communications utilizing any wireless protocol as understood in the art. For example, a wireless Ethernet standard may be utilized by the wireless infrastructure unit 225 to communicate with the asset communicators 120 via the asset communication link 130a. A local monitor 110a may communicate with another local monitor 110b via the respective RF wireless units 235. Although the local monitor 110 is shown to be coupled to the communication units 230 and RF wireless unit 235, an alternative embodiment of the local monitor 110 may include either or both units 230 and 235 in the same physical box.

The asset communicator 120 includes an RF wireless unit 245 for communicating with the RF wireless unit 235 of the wireless infrastructure unit 225. Additionally, the asset communicator may include a wired unit (not shown) for direct wire communication with a portable computing system, for example, for downloading to or uploading from the asset communicator 120.

The asset communicator 120 further includes a database engine 250 operable to manage data being collected or received by the asset communicator 120. The asset communicator 120 also contains a computer program on-board to determine what, when, where, and how often to communicate as previously discussed.

Both the asset communicators 120 and the wireless infrastructure units 225 may be considered embedded systems, where an embedded system is defined as a combination of hardware and software that together form a component of a larger system. An example of an embedded system is a microprocessor that controls an automobile engine. Embedded systems are designed to execute without human intervention, and may be required to respond to events in real-time.

The asset communicator 120 is coupled to the wireless infrastructure 202 via the asset communication link 130a (link A). The wireless infrastructure 202 is coupled to the management computer network 115 via the local communications link 117 (link B). The middleware 215 is coupled to the database engine 210 via a communication link 255 (link C). The database engine 210 is coupled to the supervisor interface 205 via a communication link 260 (link D). The work request dispatch engine 200 is coupled to at least one of the middleware 215, database engine 210, supervisor interface 205, and system administrator interface 220 via communication link 265 (link E).

Traditionally, mobile wireless devices, such as asset communicators, are capable of performing their intended operation by having communication links A, B, and C simultaneously operating. The principles of the present invention, however, allow for the asset communicators 120 to operate autonomously without having links A, B, and/or C simultaneously operating. As previously discussed, the asset communicator 120 and wireless infrastructure unit 225 are intelligent in that they are capable of performing decisions that traditionally only the management computer network 115 performed.

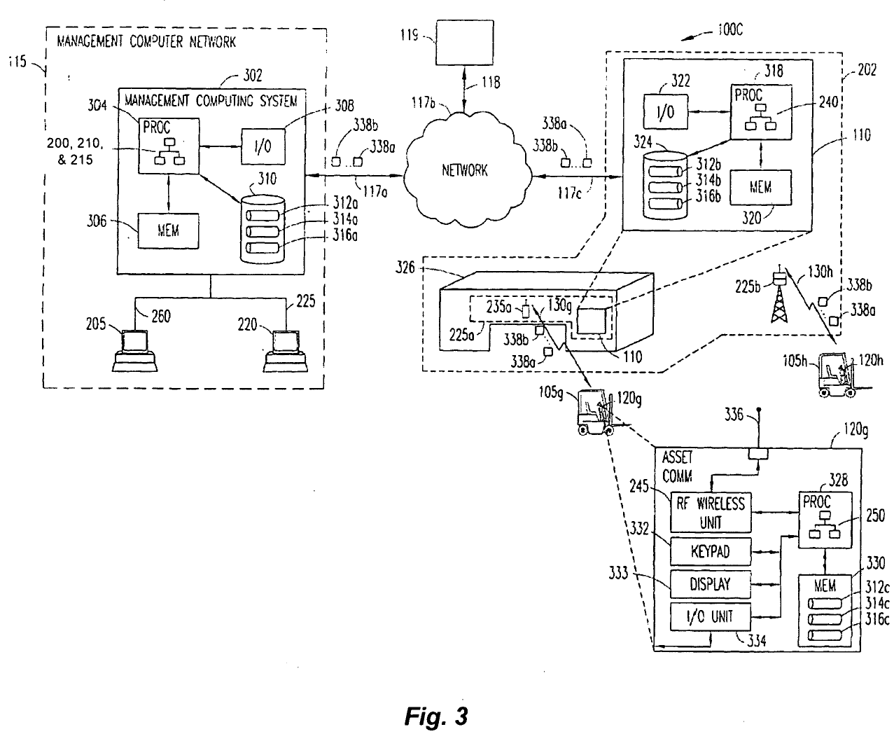

FIG. 3 is another exemplary block diagram of the robust wireless communications system of FIGS. 1 and 2. The management computer network 115 includes a management computing system 302 having a processor 304 coupled to a memory 306, I/O device 308 and storage device 310. The storage device 310 may include one or more databases 312a, 314a, and 316a, for example. The databases 312a-316a may be used to store various data associated with performing asset management. The databases may operate as relational databases in that each database may have corresponding or associated data elements with one or more other databases. For example, multiple databases may have a vehicle number so that any data associated with the vehicle number in either database may be related utilizing the database engine 210.

The management computing system 302 may further be coupled to the supervisor interface 205 via the communication link 260 (link D), and the system administrator interface 220 via the communication link 222. The supervisor interface 205 and system administrator interface 220 may be utilized to interact with the management computing system to modify and view the data stored in the databases 312a-316a. The supervisor 205 and system administrator 220 interfaces may utilize the same processor 304 as the management computing system 302.

The processor 304 may execute the work request dispatch engine 200, database engine 210, and middleware 215. Alternatively, the database engine 210 may be executed on a different processor in conjunction with the storage device 310. In that regard, the storage device 310 may be external from the management computing system 302 and be formed of one or more storage devices. The storage devices 310 may be a magnetic and/or optical disk, or be of another memory device type, such as random access memory.

The management computing system 302 may further be coupled by the local communication link 117, which includes communication link 117a, network 117b (e.g., the Internet), and communication link 117c. The web server 119 may be coupled to the network 117b via the network communication link 118. The wireless infrastructure 202a may be coupled to the network 117b via communication link 117c, and include a local monitor 110 that includes a processor 318 coupled to a memory 320, I/O unit 322, and storage device 324. The storage device may be internal or external from the local monitor 110, and be utilized to store databases 312b, 314b, and 316b. The databases 312b-316b may be replicated from the databases 312a-316a. The processor 318 may execute the local monitor database engine 242 that operates to maintain the replicated databases 312b-316b. As indicated by the dashed lines, the local monitor may be maintained in a facility 326 that the operator of the facility utilizes to perform asset management for mobile and/or fixed assets.

The local monitor 110 may be coupled to the RF wireless unit 235 via a wired or wireless communication link (not shown), thereby forming a wireless infrastructure unit 225a. A second wireless infrastructure unit 225b formed of a local monitor 110 and RF wireless unit is also utilized to communicate with assets 105 on the premises. The wireless infrastructure units 225a and 225b communicate with asset communicators 120g and 120h associated with mobile assets 105g and 105h (e.g., forklifts)

The asset communicator 120g includes the RF wireless unit 245 coupled to a processor 328. The processor 328 may further be coupled to a memory device 330, keypad 332, display 333, and input/output (I/O) unit 334. The memory 330 may be random access memory, flash memory, or programmable read-only memory as understood in the art. Alternatively, the memory 330 may be a magnetic or optical disk. The memory 330 may be operable to store databases 312c, 314c, and 316c.

The I/O unit 334 may include receiving and/or transmitting devices, and be coupled to power, sensors, or other input and output devices (not shown). The I/O unit 334 of the asset communicator 120 may receive power from a power source, such as a battery, located on the asset 105 or from a battery coupled to the asset communicator 120. The decision as to whether to receive power from an internal (e.g., battery of asset communicator 120) and/or external power source (e.g., battery of asset 105, wall power, etc.) may be based on the application that the asset communicator is being utilized. For example, if the asset communicator 120 is being used for tracking a forklift, it may be appropriate to draw power from the forklift. If, however, the asset communicator 120 is being used for tracking a parcel, then a battery of the asset communicator 120 is used to provide power as, in general, a parcel does not have a battery. It should be understood that a battery may be included with the asset communicator 120 and be utilized as a backup power supply as understood in the art upon the asset communicator 120 losing power from the asset 105. The sensors may include temperature, current, voltage, impact, motion, pressure, weight, or any other such electronic sensors. Input devices may include barcode scanners, proximity card readers, magnetic card readers, and other biometric reading devices. The output devices may include relays, switches, lights, sirens, horns, or any other electronic output device. The RF wireless unit 245 may further be coupled to an antenna 336.

The size, structure, and configuration of the asset communicator 120 may be dependent upon the environment and asset 105 that the asset communicator 120 is associated. For example, if the asset communicator 120 is utilized in an industrial or outdoor environment, then a heavy duty housing being substantially water resistant may be used. If, however, the asset communicator 120 is utilized to perform parcel tracking, then the size, weight, thickness, and flexibility, for example, is an issue. In such a case, the asset communicator 120 may be constructed of multiple circuit boards. In one embodiment, three circuit boards having minimal dimensions (e.g., one-by-two inches) may be coplanar and coupled via a flexible, flat cable and/or circuitry having transmission lines for communicating data between the circuit boards. By using the flexible, flat cable, the asset communicator 120 is capable of being bent without breaking during shipping of the parcel. Additionally, the circuitry on the circuit boards may be coated with a durable, compressible material, such as rubber, to prevent damage to the circuitry and to reduce stresses on the circuit boards during shipping of the parcel. A battery may further be coupled to the asset communicator 120 via the cable to provide power to the circuit board and allow for replacement. It should be understood that while the size, structure, and configuration of the asset communicator may vary, the functionality of the asset communicator 120 remains substantially the same.

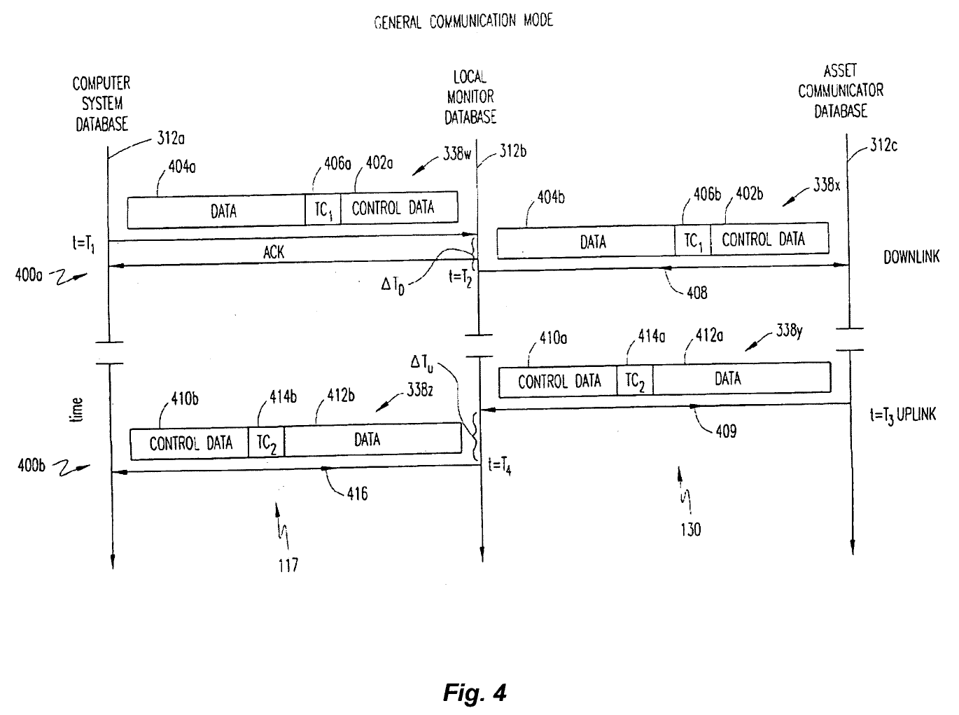

In operation, the management computing system 302 may operate as a central computing system for the robust wireless communications system 100c. An operator of the supervisor interface 205 may view or update (i.e., create, edit, or delete) information or data stored in the database(s) 312a-316a utilizing the database engine 210. For each addition, edit, or deletion, a transaction code (see FIG. 4) is associated with the data, thereby forming a data record or dataset, which is stored in a database 312a, for example. The management computing system 302, utilizing the database engine 210 and middleware 215, communicates the data stored in the database 312a utilizing the I/O unit 308 in data packets 338a-338b over the network 117b to specified local monitors 110 based on business functions being performed and current communication links. For example, a text message may be transmitted to only the local monitor 110 in communication with the asset communicator 105g as determined by the middleware 215 in conjunction with the database engine 210. As another example, a broadcast text message may be transmitted to all local monitors 110 servicing asset communicators 120.

The local monitor 110, utilizing the database engine 240, stores the data in the database 312b, if necessary, to replicate the database 312a. By replicating the database 312a in the local monitor 110, it is possible for the local communication link 117 to fail and the local monitor 110 to operate independently. The data stored in the local monitor 110 may thereafter be transmitted or broadcast the data temporally to the asset communicators 120g and 120h operating in the range of the RF wireless units 235a and/or 235b. While the local monitor 110 is storing the data for further communication, the local monitor 110 may determine that the data becomes obsolete before communicating the data to asset communicator(s) 120. Such a situation may occur upon (i) the data becoming expired or out-of-date (e.g., notification for scheduled maintenance becoming past due), (ii) the data being superseded by newer data (e.g., work instructions being modified by the supervisor), or the data becoming irrelevant (e.g., text message having utility for a duration of five minutes), for example. If the data becomes obsolete, the local monitor 110 may simply not communicate and/or delete the data being stored therein.

An asset communicator 120g that receives the data via data packets 338a-338b may determine that the data is associated with the particular asset communicator 120 by identification of a data field, and store the data in a database 312c. The database 312c is a subset of the data stored in the databases 312a and 312b. In other words, the data stored by the management computing system 302 is communicated to the local monitor 110, stored therein for an indefinite period of time, and transmitted from the local monitor 110 to all asset communicators 120 in range thereof, if needed. The asset communicators 120 are intelligent and capable of parsing the received data to determine the data associated therewith. Therefore, the databases 312c-316c are subsets of the databases 312a-316a and 312b-316b. It should be understood that each asset communicator 120 may receive and store data in similarly configured databases.

FIG. 4 is an exemplary interaction diagram 400 for performing downlink and uplink communications between components of the robust wireless communications system of FIG. 3. The three associated databases 312a, 312b, and 312c are indicated by the vertical lines. Additionally, time increases down the vertical lines. Data communicated between the computer system database 312a and local monitor database 312b in the downlink direction is transmitted over the local communication link 117. The data is communicated in a data packet 338, which may include control data 402a and data 404a and datasets stored in the databases 312a-316a, for example. The data 404a includes a transaction code (TC₁) 406a. As understood in the art, the control data 402a is associated with data communicated via data packets 338 as part of a data communication protocol. Acknowledgement packets 407 may be used to ensure that the downlink data is successfully replicated as determined by the local monitors 110 utilizing a checksum or other data verification technique as understood in the art. The acknowledgement 407 may occur upon completion of all data being transmitted from the computer system database 312a to the local monitor database 312b to minimize network bandwidth requirements.

Upon the data being successfully received by the local monitor database 312b, the data is stored for an unspecified period of time ΔT_{D}. At some random or non-random time T₂ the data may be read and transmitted from the local monitor 110 via data packet 338x to an area or cell 111 that the local monitor 110 services. As indicated, the control data 402b, data 404b, and transaction code 406b may be different than the control data 402a, data 404a, and transaction code 406a due to (i) the time delay between T₁ and T₂ and (ii) new data received by the computer system database 312a not having been transmitted to the local monitor database 312b. An acknowledgement packet 408 may be used to confirm the receipt of the data packet 338x depending upon whether confirmation is desired for a particular business function. For example, if a text message is transmitted to a particular asset communicator 120g, then the acknowledgement 408 is desirable. Alternatively, if a broadcast text message is transmitted to all asset communicators 120, then an acknowledgement is not necessary. Ultimately, however, the data from the computer system database 312a is transmitted and may be stored in the asset communicator database 312c. While the data communicated across the communication links 117 and 130 may be transmitted sequentially (i.e., first across the local communication link 117 and second across the asset communication link 132), the data need not be communicated simultaneously across the communication links 117 and 130. Upon the data being received by the asset communicator database 312c, an acknowledgment 408 may be communicated back to the local monitor database 312b, and the data 404b may be deleted therein. By deleting the data 404b within the local monitor database 312b, repetitive transmission of the data 404b may be eliminated.

With regard to uplinking, upon the asset communicator 120 collecting and storing the data in the asset communicator database, the asset communicator 120 may perform the uplink communication 400b from the asset communicator database 312c to the local monitor database 312b. At T₃, a data packet 338y, including control data 410a and data 412a associated with a transaction code (TC₂) 414a, is transmitted from the asset communicator database 312c to the local monitor database 312b. If there is sufficient storage capacity, the data 412a is stored by the local monitor database 312b for an indefinite period of time ΔTᵤ and an acknowledgement 409 is sent to the asset communicator. This time period ΔTᵤ may extend for a minimal duration or any duration of time until the local communication link 117 becomes operational or active. Once the acknowledgement 409 is received, the asset communicator 110 may delete the data packet 338y from its memory. If there is not sufficient storage capacity in the local monitor 312b, the asset communicator 110 continues to store or transmit the data 338y to another local monitor database 312b. At time T₄ the data 412b, including transaction code 414b, is transmitted from the local monitor database 312b to the computer system database 312a via data packet 338z. An acknowledgment 416 may be communicated back to the local monitor database 312b from the computer system 312a so that (i) the local monitor database 312b does not continue to communicate the data 412b to the computer system database 312a, and (ii) the data may be deleted from the local monitor database 312b. The control data 402a, 402b, 410a, and 410b may include authentication and/or encryption data to ensure validity and security of communications to protect confidential information. It should be understood that in both the downlink 400a and uplink 400b communications that additional acknowledgment from the local monitor database 312b may be communicated back to both the computer system database 312a and the asset communicator database 312c to notify each to stop communicating the information associated with the particular transaction codes transmitted.

The communication technique of FIG. 4 is realizable 15 because of the intelligence built into both the local monitor 110 and asset communicator 120. And, because of the communication technique, the robust communications system 100c is capable of handling and solving many business problems involved in managing assets remotely.

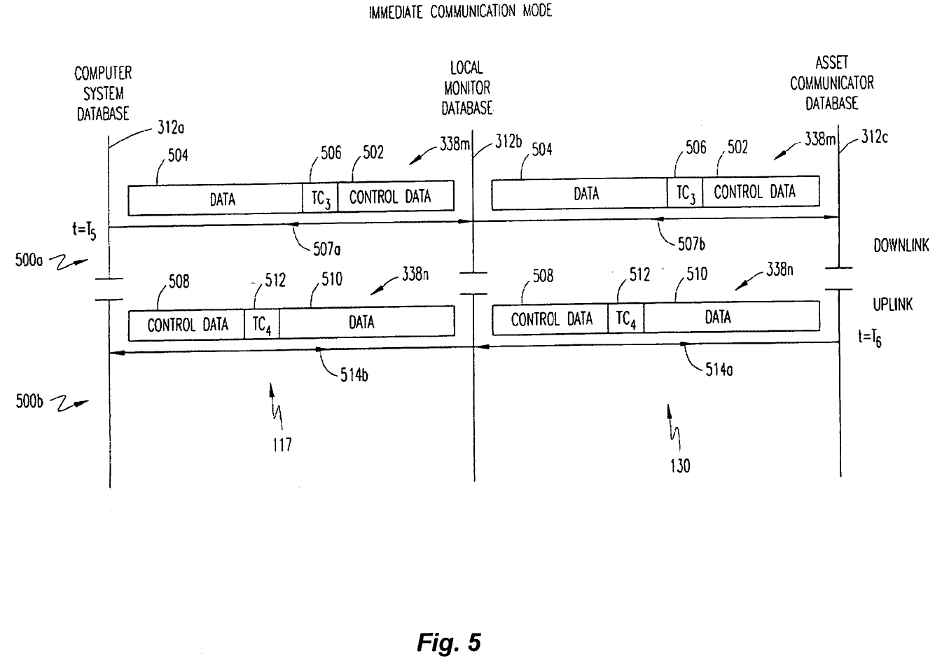

FIG. 5 is an exemplary interaction diagram 500 for performing immediate communications between the components of FIG. 3. A downlink communication 500a and uplink communication 500b are shown for the paging communications that may be utilized on the robust wireless communications system 100c. For the downlink communication, at time T₅, a data packet 338m may be communicated between the computer system database 312a and local monitor database 312b, and include control data 502 and data 504 associated with transaction code (TC₃) 506. Upon the local monitor database 312b receiving the data packet 338m, an acknowledgement signal 507a may be communicated back to the computer system database 312a for verification purposes. The local monitor database 312b may operate as a pass-through to the asset communicator database 312c in the immediate communication mode. Alternatively, the local monitor 110 may not store the data in the local monitor database 312b. In other words, there is little or no delay for the data being communicated from the computer system database 312a to the asset communicator database 312c. Accordingly, the data communicated from the local monitor database 312b to the asset communicator database 312c is the same or substantially similar data packet 338m including the control data 502, data 504, and transaction code (TC₃) 506. An acknowledgement signal 507b may be communicated from the asset communicator 120 back to the local monitor 110 upon receipt of the data packet 338m by the asset communicator database 312c.

Similarly, the uplink communication 500b in the immediate communication mode transmits data at time T₆ from the asset communicator database 312c to the computer system database 312a with a minimal amount of delay via the local monitor database 312b. The data may be communicated in a data packet 338n, which includes control data 508 and data 510 associated with a transaction code (TC₄) 512. The data packet 338n is thereafter communicated from the local monitor database 312b to the computer system database 312a with minimal or no alterations or delay. Acknowledgement signals 514a and 514b may be communicated from the local monitor 110 to the asset communicator 120 and from the management computing system 302 to the local monitor 110, respectively, upon receipt of the data packets 338n. As understood in the art, the immediate communication mode may operate similar to conventional wireless data communication techniques as understood in the art utilizing any communication standard thereof.

### Data Synchronization

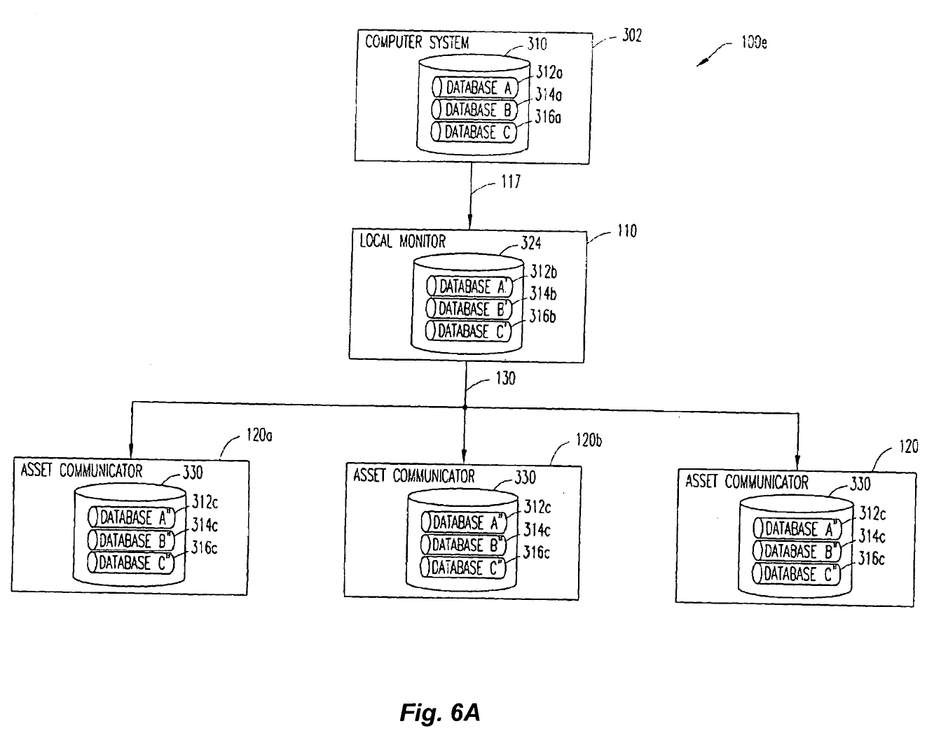

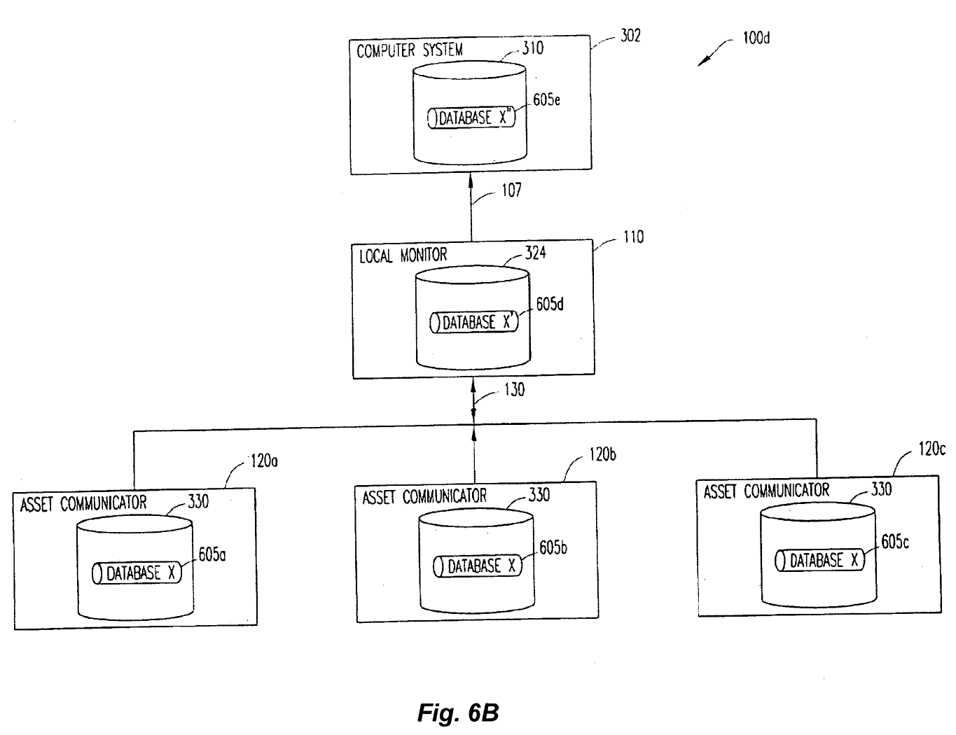

FIGS. 6A and 6B are exemplary databases operating in the robust wireless communications system of FIG. 3. FIG. 6A illustrates the downlink functionality of the robust communications system 100d. As shown, the management computing system 302 includes the storage device 310 and databases 312a, 314a, and 316a (databases A, B, and C). To indicate the database that a dataset is associated, a transaction type specifier may be included with each dataset. The transaction type specifier (e.g., “collision”, “low battery”, “location”, and “text message response”) may be utilized to differentiate different dataset types communicated to the asset communicator 120. The transaction code associated with each dataset may be included to indicate the most up-to-date data from the associated database. The data stored in the databases 312a-316a may be transmitted to the local monitor 110 while the local communication link 117 is established. The local monitor 110 stores the data on the storage device 324 in databases (A′-C′) 312b-316b. While databases 312b-316b are intended to be replicas of the databases 312a-316a, it may not be possible to have exact replicas at any given point in time due to the local communication link 117 or other hardware or software failures during operation and/or synchronization of the data between the management computing system 302 and local monitor 110. Additionally, depending on the application and type of data, a complete replication of the databases 312a and 312b may not be needed.

Generally, the local monitor 110 communicates the data stored in the databases 312b-316b in a broadcast fashion (i.e., without regard to asset communicators 120 in the broadcast area of the local monitor 110). Alternatively, the local monitor 110 may broadcast to only those asset communicators 120 that have registered with the local monitor 110 upon being within broadcast range. However, by broadcasting a data without regard to asset communicators 120 in the broadcast area, the bandwidth of the broadcast may be increased due to the acknowledgement 408 not needing to be transmitted and received, and the broadcast process may be simplified. It should be understood that the data communicated via the asset communication link 130 is made from each of the databases 312b-316b, and may be performed in a temporal order based on transaction codes associated with the datasets stored in the databases 312b-316b.

Each asset communicator 120a-120c receives the data broadcast from the local monitor 110. Each asset communicator 120a-120c parses the data received and stores only the data associated therewith as determined by the contents of the data (e.g., mobile asset identifiers and transaction codes). Once the asset communicator 120 has received a dataset having a particular transaction code, the asset communicator 120 does not store a dataset having a transaction code indicating that the dataset is not up-to-date. As shown, the databases 312c-316c are indicated as being databases A″, B″, and C″ to indicate that the data stored in the databases is a subset of the databases (A′-C′) 312b-316b. It should be understood that although the data is indicated as being stored in three databases, other embodiments may use one or other numbers of databases for performing particular functions on the robust wireless communications system 100d. It should further be understood that the asset communicators 120 may receive all communicated data from the databases A′, B′, and C′ and store all of the data in databases A″, B″, and C″. However, such a communication technique may be problematic in terms of storage capacity in the asset communicators 120 depending on the volume of data located in the databases A′, B′, and C′.

FIG. 6B is the uplink representation for the robust wireless communications system 100d. As indicated, each asset communicator 120 forms a database (X) 605a, 605b, and 605c. The databases 605a-605c may be utilized for storing location or utilization information particular to each of the asset communicators 120a-120c. A transaction type specifier, transaction code, and asset number, may be included in each dataset. The transaction code may be utilized along with the asset number to form a unique dataset key. The transaction type specifier, again, is utilized to identify the database that the dataset is associated. When the asset communicators 120a-120c are individually in range of the local monitor 110, the asset communicators 120a-120c may transmit the data stored in the databases 605a-605c to the local monitor 110 via the asset communication link 130. The data is stored in the database (X′) 605d. The local monitor 110 communicates an acknowledgment to the asset communicator 120a indicating that the data was received by the local monitor 110. The asset communicator 120a thereafter does not continue transmitting that particular dataset associated with the particular transaction code. The data may remain stored on the asset communicator 120a, but is eventually overwritten with new data or used for future calculations.

The local monitor 110 may thereafter transmit the data stored in the database 605d to the management computing system 302. The data may be stored in the database (X″) 605e via the local communication link 117. Although the data is intended to be replicated between databases (X) 605d and 605e, due to the local communication link 117 and the hardware/software operation of the local monitor 110 and the management computing system 302, the databases may not be synchronized at all points in time as the database 605d continues to receive data from the asset communicators 120.

In the event that the local communication link 117 becomes disabled, the local monitor 110 maintains the data stored in the database 605d without transmitting to the management computing system 302. As the database 605d fills up and eventually becomes full, a message is communicated to the asset communicators 120a-120c in the broadcast area of the local monitor 110 indicating that the local monitor 110 may no longer receive data from the asset communicators 120a-120c due to a temporary memory full condition. If any of the asset communicators 120a-120c are within range of another local monitor 110, then the data may be transmitted to the other local monitor 110. Because the asset communicators 120a-120c are intelligent, the asset communicators may be configured to transmit the data to the local monitor 110 over incremental periods of time (e.g., 30 seconds, 1 minute, 5 minutes, 30 minutes, etc). And, if the asset communicators 120 are unable to transmit the data to a local monitor 110 due to communication problems or simply being out of range, the asset communicators 120 are capable of storing the data for many months due to the ability of the asset communicators 120 to summarize and consolidate, or purge the data being collected based on business rules. In addition, intelligent wireless communication techniques, such as re-transmissions, frequency hopping, communication back-off (i.e., reducing communication rate based on communication failure), and communication termination also may be used to improve communication link and system-wide communication. Upon an asset communication link 130 being re established with the local monitor 110 by the asset communicators 120, all the backlogged data may thereafter be transmitted to the local monitor 110.

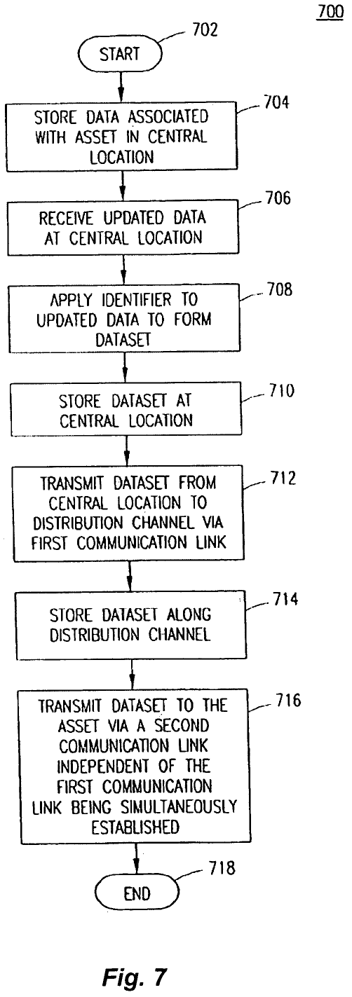

FIG. 7 is an exemplary flow diagram for communicating data in the robust wireless communications system of FIG. 3. The process starts at step 702. At step 704, data associated with an asset is stored in a central location. Updated data may be received at the central location at step 706. At step 708, an identifier is applied to the updated data to form a dataset. At step 710, the dataset may be stored at the central location. The central location may transmit the dataset to a distribution channel via a first communication link at step 712. At step 714, the dataset is stored along the distribution channel. At step 716, the dataset is transmitted to the asset via a second communication channel independent of the first communication link being simultaneously established. The process ends at step 718.

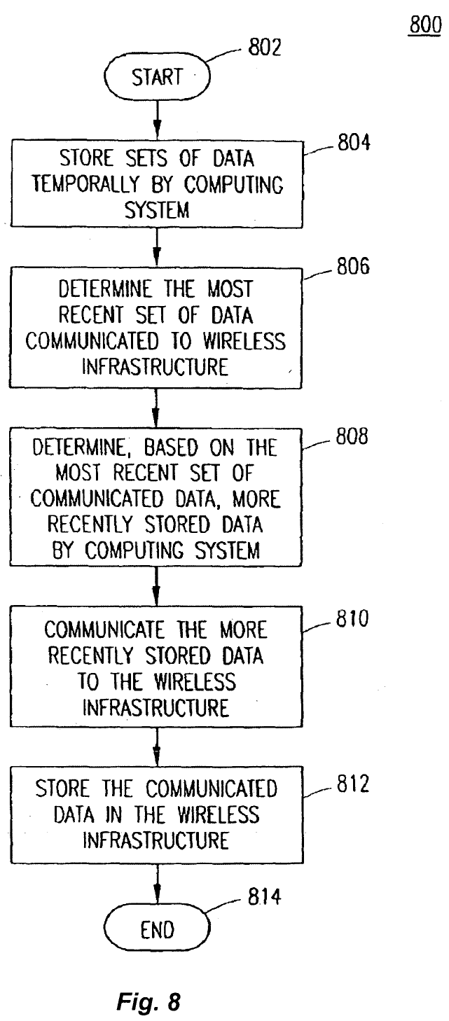

FIG. 8 is another exemplary flow diagram 800 for communicating data in the robust wireless communications system of FIG. 3. The process starts at step 802. At step 804, sets of data are stored temporally by a computing system. At step 806, the most recent set of data communicated to a wireless infrastructure is determined. One method to determine the most recent set of data communicated (and stored) is to transmit a query to the wireless infrastructure 202. Based on the most recent set of communicated data, more recently stored data by the computing system is determined at step 808. At step 810, the more recently stored data is communicated to the wireless infrastructure 202. At step 812, the communicated data is stored in the wireless infrastructure 202. The process ends at step 814.

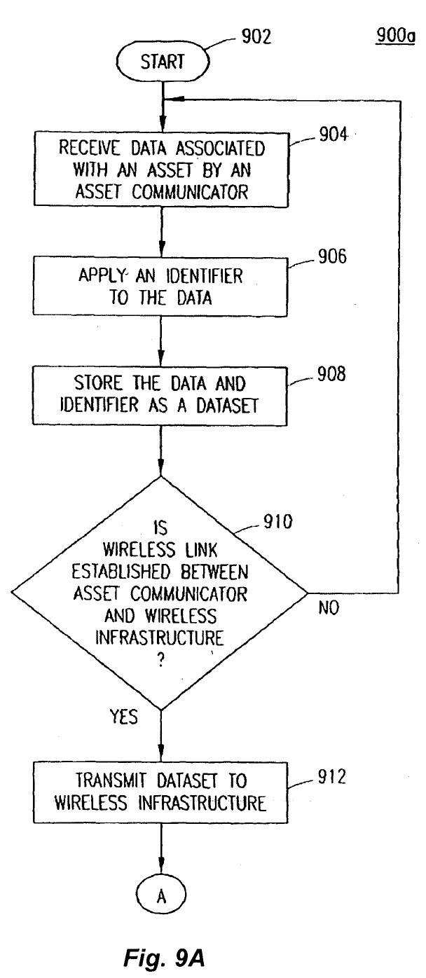

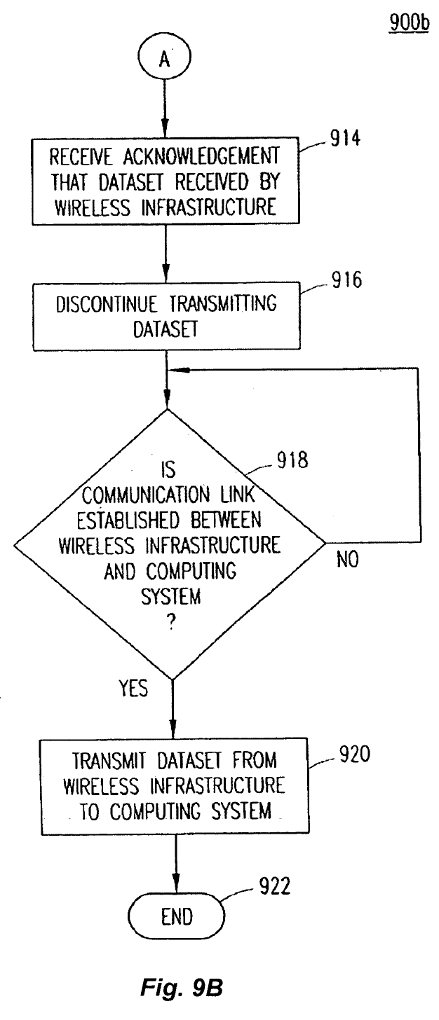

FIGS. 9A and 9B (collectively FIG. 9) illustrate exemplary flow diagrams 900a and 900b for performing uplink communication on the robust wireless communications system of FIGS. 3 and 6B. The process starts at step 902. At step 904, data associated with an asset 105 is received by an asset communicator 120. The data may be measured by sensors located on the asset 105 or may be data entered by an operator of the asset communicator 120. The data may also include location data or data created through the receipt of wireless data. At step 906, an identifier, such as a transaction code, is applied to the data. The identifier may be temporal in relation to identifiers associated or applied to other data received by the asset communicator 120. The identifier may be a transaction code having an indicator associated with the asset communicator 120. At step 908, the data and identifier are stored as a dataset.

At step 910, a determination is made as to whether a wireless link is established between the asset communicator 120 and wireless infrastructure 202. If an asset communication link 130 is currently established between the asset communicator 120 and the wireless infrastructure 202, then the dataset is transmitted to the wireless infrastructure 202 at step 912. Otherwise, the process returns to step 904, and the asset communicator 120 continues to receive and collect data associated with the asset 105 by the asset communicator 120. At step 914, the asset communicator receives an acknowledgment that the dataset was received by the wireless infrastructure 202, and the asset communicator discontinues transmitting the dataset at step 916.

At step 918, a determination is made as to whether a local communication link is established between the wireless infrastructure 202 and a management computing system 302. If a local communication link 117 is established, and, if the dataset must be transmitted to the management computing system, then the dataset is transmitted from the wireless infrastructure unit 225 to the management computing system 302 at step 920. Otherwise, the data is stored or maintained by the wireless infrastructure 202 until the local communication link 117 is re-established. The process ends at step 922.

### Asset Management Applications Utilizing Robust Wireless Communications System Architecture

The following applications to provide various asset management functions utilize the robust wireless communications system as discussed hereinabove. Depending upon the particular application and business problem being solved, the communication techniques of FIGS. 4 and 5 are utilized to communicate data within the system.

### Relational Database Configuration

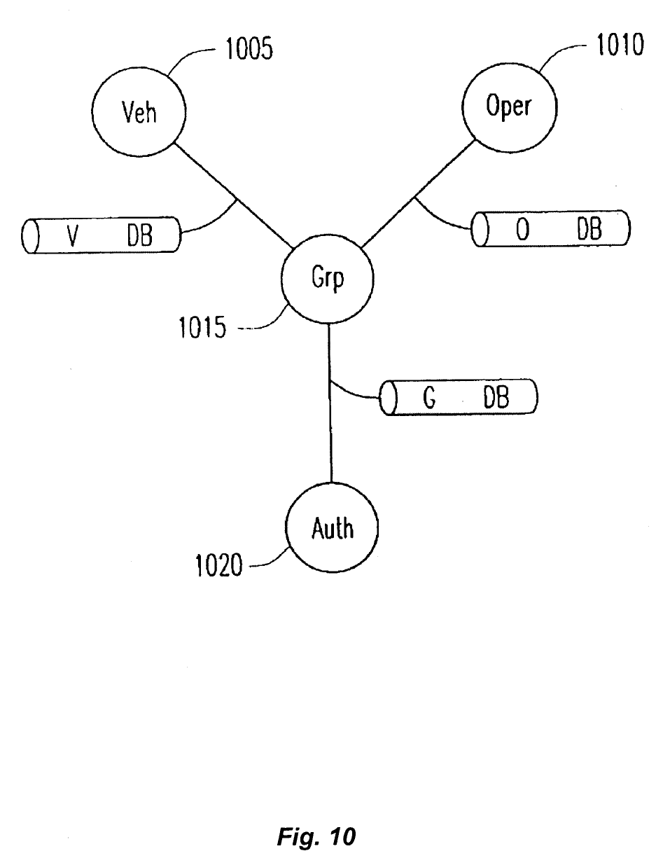

FIG. 10 is a graphical representation 1000 of entities associated with a robust wireless communications system based on that of 100c of FIG. 3, and relational databases associated therewith. The information associated with the entities are 25 utilized to provide access control and authorization for operators to utilize the assets 105. Four entities, including vehicles 1005, operators 1010, groups 1015, and authorizations 1020 are linked together by relational databases (V, O, G). A vehicle (V) database links the vehicle 1005 and group 1015 entities. An operator (O) database links the operator 1010 and group 1015 entitles. And, a group (G) database links the authorization 1020 and group 1015 entities. Each of these databases (i.e., V, O, and G) may be generated and maintained in the management computer network 1005 by a supervisor utilizing the supervisor interface 205. As understood in the art, each of the databases includes information associated with the particular entities of which the databases are associated.

TABLES 1, 2, and 3 hereinafter provide exemplary information stored in the vehicle, operator, and group databases, respectively. As shown in TABLE 1, each dataset includes a transaction code, group identification (ID), and vehicle number. For each dataset, the transaction code is incremented based on the number of updates to the vehicle database. The group identifier associated with a particular vehicle is indicative of a particular group of operators or employees who have access rights to operate the vehicle. For example, a group may be defined as a shipping department or group identified with a head of a department. For example, vehicle number “372A7C” may be operated by any member associated with the group “A4”, which may represent the shipping department. As indicated by the asterisk behind each vehicle number, the vehicle number information is not stored in the asset communicator databases 312c, for example, as the vehicles need not utilize such information.

TABLE 1
Vehicle Information

| Transaction Code | Group ID | Vehicle Number |
|---|---|---|
| 0173842 | A4 | 372A7C* |
| 0173843 | A4 | 382B2G* |
| 0173844 | A5 | 382B2G* |

*Not stored in asset communicator database

TABLE 2 includes datasets having operator (employee) number, password/PIN, and group ID data elements. As indicated, the group ID's match the group ID's provided in the vehicle database of TABLE 1. For example, group “A5” is associated with operator number “00050” has a password of “871734”. As indicated in TABLE 1, operator “00050” may have access to vehicle “382B2G”. Each dataset stored in the operator database also includes a transaction code. As shown, the transaction codes for the operator database are independent of the transaction codes for the vehicle database (TABLE 1).

TABLE 2
Operator Information

| | Operator | | |
|---|---|---|---|
| Transaction Code | (Employee) Number | Password/PIN | Group ID |
| 0024187 | 03421 | 781242 | A4 |
| 0024188 | 00050 | 871734 | A5 |
| 0024189 | 00279 | 473892 | A4 |

TABLE 3 is the group database that provides authorization based on various parameters for the groups to utilize the vehicles associated therewith. The group database includes group ID (to provide relation to TABLES 1 and 2), days, times, and locations. Again, a transaction code is associated with each dataset for synchronization purposes within the different databases (e.g., databases 312a, 312b, and 312c). As shown, members of group “A4” are authorized to operate vehicles between Monday and Friday during the hours of 8:00 a.m. to 5:00 p.m., (i.e., 0800-1700) in locations “L8” and “L17”. It should be understood that while multiple databases may be utilized to form relations between the data (e.g., group information database provides a relationship between the operator and vehicle information databases), that less-relational databases (e.g., each operator and vehicle pair may be stored in one database) may be utilized to perform the same or similar functionality. However, the use of relational databases allows the system to (i) limit the amount of data communicated across the communication links 117 and 130, and (ii) simplify the process of associating vehicles and operators. For example, if a new vehicle is added to a fleet of vehicles, then the supervisor may simply add the vehicle to a group rather than having to assign individual operators to the vehicle directly.

TABLE 3
Group Information

| Transaction | | Authorization | | |
|---|---|---|---|---|
| Code | Group ID | Days | Times | Locations |
| 0047184 | A4 | Mon-Fri | 0800-1700 | L8, L17 |
| 0047185 | A5 | Mon-Sat | 1500-2300 | L9, L17, L20 |
| 0047186 | A6 | Sun-Thu | 2300-0700 | L3, L8, L19 |

The information on stored in the databases may be generated, edited, and/or deleted by an operator of the supervisor interface 205, and may be maintained by the database engine 210. For each creation, edit, and deletion, a transaction code may be assigned thereto. Alternatively, a time-stamp may be assigned to the information. However, by utilizing a transaction code, memory requirements may be reduced. The databases may be maintained separately or integrated into a single database as understood in the art. The datasets stored in the databases are thereafter downloaded from the management computer network 115 to the wireless infrastructure unit 225 and, ultimately, the asset communicators 120 as discussed with regard FIGS. 3 and 6A.

The asset communicators 120 in the cell 111 of the local monitor 110 of the wireless infrastructure unit 225 receive each dataset that is transmitted from the wireless infrastructure unit 225. However, the asset communicators 120 parse the datasets received from the wireless infrastructure 120 based on vehicle number, as understood in the art. For example, from the vehicle database (TABLE 1), vehicle number “372A7C” receives the information associated with transaction code “0173842” having a group identifier of “A4”. Any data record thereafter received being associated with group identifier “A4” is received and stored and/or updated by the vehicle “372A7C”. For example, from the operator database (TABLE 2), transactions “0024187” and “0024189”, and information associated therewith are stored by the asset communicator 120. Additionally, from the group database (TABLE 3), the dataset having transaction code “0047184” is stored and/or updated in the asset communicator 120.

Once the asset communicators are updated by the datasets received, operators of the assets 105 may only access the asset communicators 120 and utilize the vehicles associated therewith by having their operator number and password accepted by the asset communicator 120. In other words, a potential operator unauthorized to access the asset 105 is unable to start the asset 105 if not authorized by a supervisor of the asset 105 by downloading access data to the asset 105 to provide access rights for the potential operator.

Because the asset communicator 120 is intelligent and not required to have access to the management computer network 115, an asset 105 that does not have a communication link to the wireless infrastructure unit 225 and management computer network 115 still is operable by an operator. Therefore, the utilization of the assets 105 is unaffected by communication outages and out-of-range situations for the assets 105 to be operated. Thus, a robust wireless communication and asset management system is provided.

Also, since the intelligent asset communicator 120 may have a user interface, including a keypad 332 and display 333, an authorized operator can directly modify the authorization database stored on the asset communicator using the keypad and display. For example, an authorized operator may permit another operator to use the asset 105 by typing the identification number of the other operator directly into the asset communicator 120.

In addition to the access control allowing an operator to turn on the asset, the access control also allows for turning off the asset based on location and time. Because the asset communicator 120 is intelligent, the asset communicator does not shut down the asset while in use and in motion, for example. Rather, the asset communicator 120 determines when a “significant” stop has occurred (e.g., the vehicle has stopped for a predetermined period of time), and the asset 105 is disabled by the asset communicator 120.

In addition to the asset communicator 120 being capable of taking action based on access control, the asset communicator 120 and/or wireless infrastructure device 225 may provide access to unauthorized operators based on business rules. For example, if the asset 105 becomes out-of-range for an extended period of time, the asset communicator 120 may provide access to a select number or any operator as the asset communicator 120 may consider that a communication problem exists (e.g., receiver failure). In the case of the wireless infrastructure device 225 not receiving communications from the management computing system 302 over an extended period, the wireless infrastructure device 225 may discontinue broadcasting data as it may be assumed that some or all of the data stored by the wireless infrastructure device 225 is invalid.

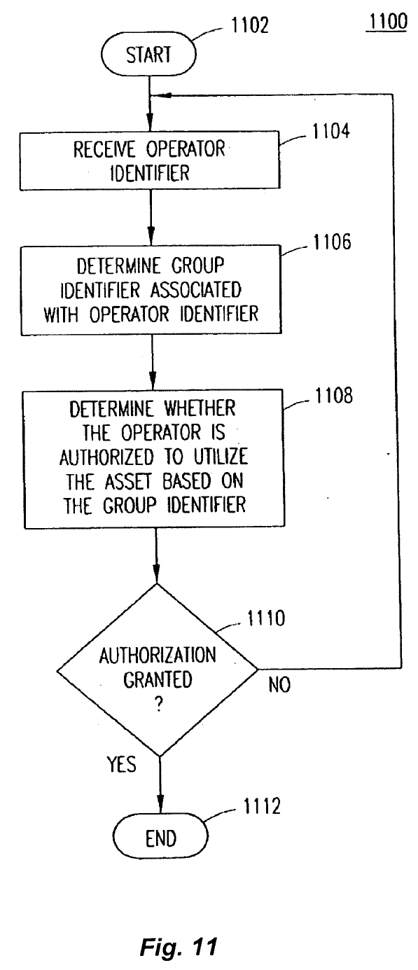

To summarize the access control process, FIG. 11 is an exemplary flow diagram for determining and providing authorization of an asset for an operator utilizing the robust wireless communications system of FIGS. 3 and 6A. The process starts at step 1102. At step 1104, an operator identifier is received via at least one of a variety of input devices, including, but not limited to, a keypad 332, card reader, memory chip reader, barcode scanner, wireless receiver, and biometric scanner. It should be understood that a password may also be received depending upon the business and/or security requirements. At step 1106, a group identifier associated with the operator identifier is determined utilizing the database(s) stored in the asset communicator 120. A determination is made at step 1108 as to whether the operator is authorized to utilize the asset based on the group identifier. At step 1110, a determination is made as to whether authorization to the asset 105 is granted based on the group, time of day, day of week, and/or location, for example. If authorization is granted, then the process ends at step 1112. Otherwise, the process returns to step 1104 to receive a new operator identifier.

### Distributed Wireless System Behavior Control

The robust wireless communications system 100c may have system behavior altered in a distributed manner. The system parameters may be utilized to control a wide variety of functions of the wireless infrastructure unit 225 and asset communicators 120. In general, a generic wireless communications system may be provided to a customer, and the customer may alter the system parameters to customize the system according to desires and needs.

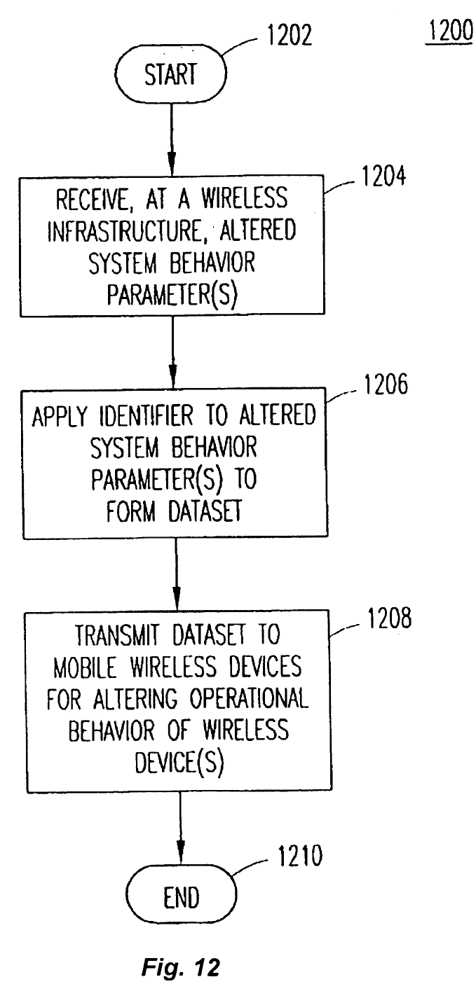

FIG. 12 is an exemplary flow diagram 1200 describing altering of system parameters for the robust wireless communications system of FIG. 3. The process starts at step 1202. At step 1204, the wireless infrastructure unit 225 receives altered system behavior parameters. The system behavior parameters may include data transmission rates, access control rules, screen behavior, keypad behavior, power modes, and scheduling of communication, for example. The system parameters may be utilized in the wireless infrastructure unit 225 for communicating to the asset communicators 120 or may be downloaded to the asset communicators 120 utilizing the communication technique of FIG. 4 to alter operational behavior. The changes may affect different asset communicators differently, unless a universal command is desired.

At step 1206, an identifier is applied to the altered system behavior parameter(s) to form a dataset. As discussed with regard to the databases, the identifier may be a transaction code utilized to indicate a temporal relationship between edits made to other system behavior parameters. The dataset may be stored in a system behavior parameter database on the management computer network 115 and downloaded to the wireless infrastructure unit 225 as discussed hereinabove. At step 1208, the dataset is transmitted to the asset communicators 120 for altering operational behavior of the asset communicator(s) 120. It should be understood, however, that the system behavior parameters may be directed toward the wireless infrastructure unit 225 and not the asset communicators 120, and therefore are not communicated to the asset communicators 120. The process ends at step 1210.

To alter the system behavior parameters, the system administrator interface 220 may be utilized rather than the supervisor interface 205. By utilizing the system administrator interface 220, a system administrator, who does not perform supervisory duties over the assets 105 or operators, is able to make the changes to the system parameters for controlling functionality of the wireless infrastructure unit 225 and asset communicators 120.

A general concept that the robust wireless communications system 100c is capable of providing is the ability to perform actions based on business rules being violated. A supervisor may define business rules that, upon being violated by an asset, operator, supervisor, supervisory computer, for example, trigger one or more events by at least one component of the system. And, because each of the components (e.g., management computing system 302, wireless infrastructure device 225, and asset communicator 120) are capable of making decisions, one or more of the components, individually or in combination, are capable of triggering event(s). For example, if a forklift 105 enters an unauthorized area of a facility, the associated asset communicator 120 may (i) shut down the forklift 105, and (ii) communicate a message to the wireless infrastructure device 225, which, in turn, may command all or some forklifts 105 in the area to be shut down. Additionally, the message may be received by the management computing system 302 and a system-wide message may be communicated to some or all asset communicators 120. And, because the asset communicator 120 is capable of making decisions, actions may be taken independent of the communication link 130 being established. It should be understood that the business rules may be varied depending on the system requirements, business functions being solved, and creativity of the system operators.

### Vehicle Utilization Monitoring

The robust wireless communications system 100b provides the ability to perform vehicle utilization monitoring in an event driven manner due to the asset communicators 120 being intelligent (i.e., having an on-board processor and associated software). Vehicle utilization relates to how the vehicle is utilized as attributed to an operator, for example. Other associated parameters, such as location, shift, etc., may be utilized. TABLE 4 provides an exemplary dataset of utilization parameters for the asset 105 that are measured using sensors in combination with the asset communicator 120 and associated software. It should be understood that the parameters are exemplary and that others may be utilized depending on the particular asset associated with the asset communicator 120. For example, a fixed asset utilizes different parameters than a mobile asset 105, and different mobile asset types may have different parameters.

TABLE 4
Vehicle Utilization Information

Segment Number
Transaction Code
Vehicle Number
Start Time
End Time
Operator ID
Log-out Method
Global Motion Time
Global Engine idle Time
Session Motion time
Session Lift Time
Session Engine idle Time
Session Number of Impacts
Current Fuel level
Current Odometer Reading
Battery ID
Session Number of Starts/Stops
Battery Level

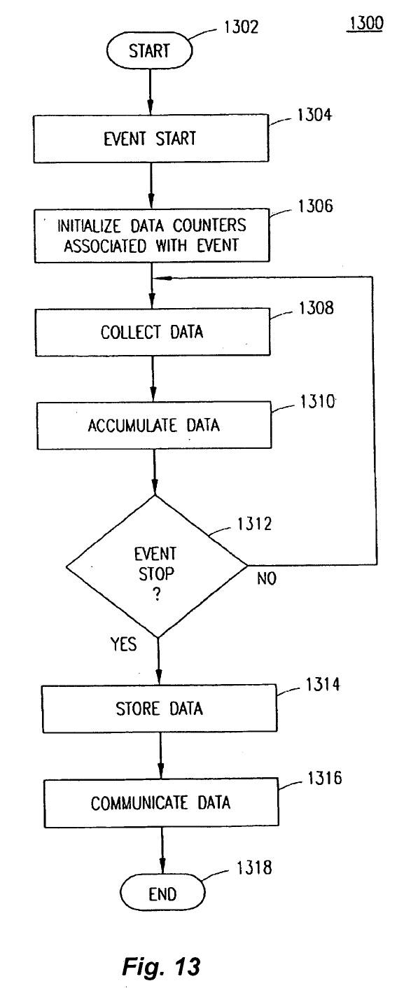

The vehicle utilization monitoring according to the principles of the present invention is event driven. One embodiment utilizes the events of an operator logging on and logging off of the asset communicator 120. FIG. 13 is an exemplary flow diagram 1300 for the asset communicator to start and stop utilization monitoring as utilized on the robust wireless system of FIGS. 3 and 6B (uplink). The process starts at step 1302. At step 1304, an event start is received an operator logging onto the asset communicator 120. At step 1306, data counters are initialized for the particular operator. The asset communicator 120 may (i) record lifetime or global counters, such as motion time and engine idle time, for the asset 105, and (ii) reset or initialize session counters, such as motion time, lift time, engine idle time, number of impacts, number of starts, and battery level.

At step 1308, data is collected by the asset communicator 120 for at least the global and session counters. At step 1310, the collected data is accumulated. In accumulating the data, both raw data and summary data based on the raw data may be generated. At step 1312, a determination may be made as to whether an event stop has occurred. The event stop may be initiated by the operator logging off of the asset communicator 120. Alternatively, an event start and stop may be generated by a predetermined time period, such as a 24-hour time period (i.e., at midnight), so as to generate utilization data for each and every time period. Additionally, in the case of the asset communicator 120 becoming idle, the event start is triggered from a logout and event stop is triggered from a logon. If an event stop has not occurred, then the process continues to collect data at step 1308. Otherwise, at step 1314, the collected data is stored for the global and/or session counters. As discussed in relation to FIG. 6B, a transaction type specifier and transaction code may be included in the dataset. It should be understood that other information may be collected and stored by the asset communicator 120 based on the same or different events. At step 1316, the stored data may be communicated from the asset communicator 120 to the wireless infrastructure 202 using the process of FIG. 9. The process ends at step 1318.

By summarizing the information based on events, the asset communicator 120 may operate independent of the wireless infrastructure 202 and management computer network 115. In other words, the asset communicator 120 need not have an active communication link with the wireless infrastructure 202 to perform its intended business function, thereby providing for a more robust asset management system. Additionally, by having the asset communicator 120 being able to perform its own monitoring (i.e., not merely transmitting the information to the wireless infrastructure in a “blind” manner), the amount of data communicated to the wireless infrastructure is greatly reduced. Moreover, because the asset communicator 120 summarizes the information collected during the session for the operator, the information becomes more useful in terms of monitoring and tracking the asset 105 as utilized by the particular operator. The summary data may also be stored in the asset communicator 120 as discussed with regard to the operation of the robust wireless communications system 100b until the asset communicator 120 forms an active asset communication link 130 with the wireless infrastructure 202. It should be understood that because the asset communicator 120 is capable of performing its own monitoring that the process of creating data is independent of the process of transmitting data, which, again, allows the asset communicator 120 to operate independent of the wireless infrastructure 202 and management computer network 115. Also, data can be used to affect future decisions, like whether or not OSHA needs to be entered by next operator.

### Asset Power Monitoring

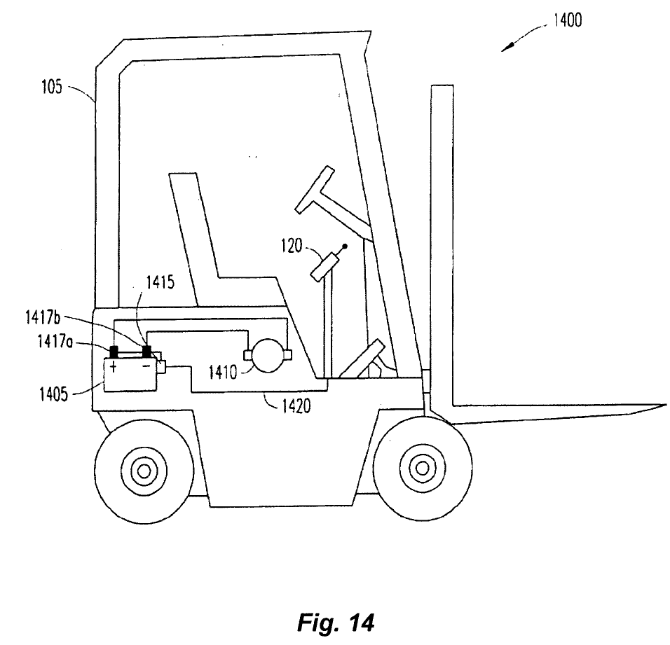

FIG. 14 is an exemplary illustration 1400 of a mobile asset 105 having a power monitor for monitoring power usage according to FIG. 13. By wirelessly monitoring power usage over time, trend analysis and real-time monitoring of battery levels may be performed to provide a supervisor with visibility regarding battery operation and realization. As shown, the mobile asset 105 includes the asset communicator 120 coupled thereto. The mobile asset 105 further includes a battery 1405 coupled to a motor 1410 for driving the mobile asset 105. A power sensor 1415, which may be either voltage or current, is coupled to terminals 1417a and 1417b. One or more lines 1420 may couple the power sensor 1415 to the asset communicator 120 that, in turn, converts an analog voltage or current into a digital value indicative of the voltage level of the battery 1405. Alternatively, an analog to digital conversion unit (not shown) may be electrically coupled between the power sensor 1415 and asset communicator 120.

The asset power monitoring may further include in-line, tap-in, and contactless current and voltage sensors affixed to different parts of the mobile asset 105 and connected via a cable to a logic board (not shown), which may or may not be part of the asset communicator 120. Currents may be converted to voltages by utilizing either a remote sensor or a converter, as understood in the art, located on the logic board. The logic board converts the incoming voltage level to digital data. The asset communicator may use configurable settings, such as filter time and voltage conversion factors, to determine, based on the digital data, the meaning of the incoming signals. To set or change the configurable settings, manual, automatic, or event triggered processes may be utilized. Typically, filtering may be utilized to filter the data over a period of time, and compare the data to a threshold level. The sensor data may be combined or utilized individually by the logic board to monitor the utilization of the mobile asset 105. Upon the battery level dropping below the threshold level, an indicator, such as a visual or audible signal, may be provided by the asset communicator 120.

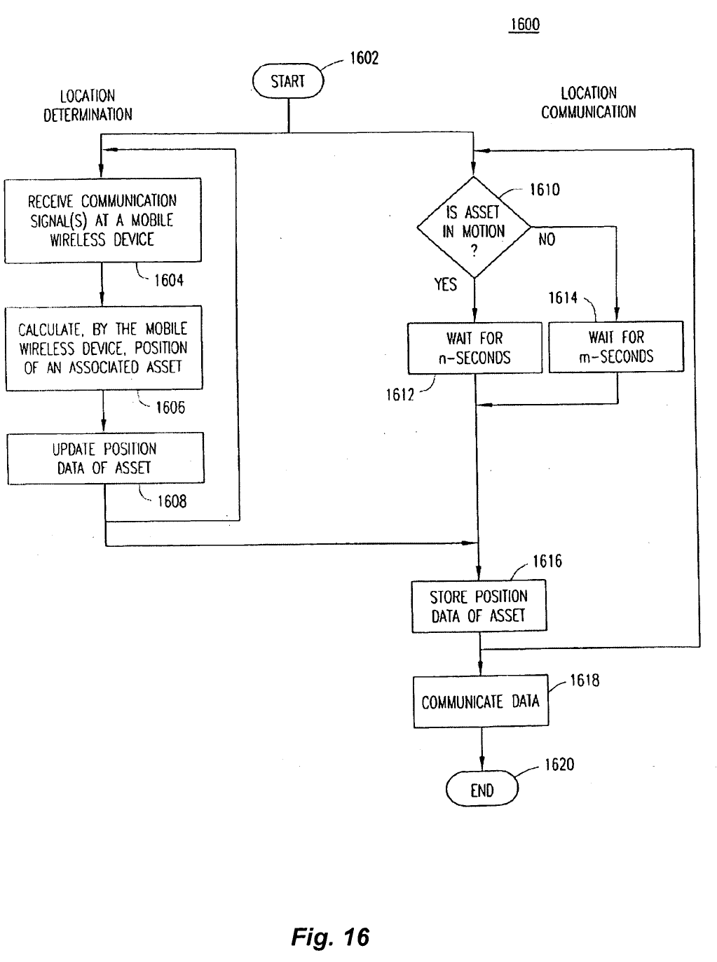

As in the case of vehicle utilization, the power information may be stored by the asset communicator 120 and communicated to the wireless infrastructure 202 using the communication technique of FIG. 9. Additionally, the power information may be event driven in that the data is determined based on an operator logging on and logging off of the asset communicator 120. A transaction type specifier and transaction code may be applied to the power information based on the events. It should be understood that the process for communicating power usage data of the mobile asset 105 may be the same or similar to that of the FIG. 13. Alternatively, communicating power usage data of the mobile asset 105 may be the same or similar to that of FIG. 16.

By monitoring the battery, a supervisor may determine how well a battery is operating based on historical data. The supervisor also may be able to determine misuse or disuse of the battery by an operator if the battery is being charged too soon or being charged too late. In other words, if a battery is being prematurely charged or being “deep” discharged, the battery may become damaged and the supervisor may be able to disrupt such practices by the offending operator(s). Because the asset communicator 120 is intelligent, the asset communicator 120 may be able to actively control improper practices. The battery usage may be monitored over time based on utilization of the assets 105 to determine whether the battery is operating properly based on usage.

### Asset Monitoring Analysis

A desire of any asset or fleet supervisor is to have aggregate information about the assets and have all information about the fleet or groups/segments of the fleet without gaps in the information. Because the asset communicators 120 are capable of generating and storing information without having an active asset communication link 130 to the wireless infrastructure unit 225, utilization data of the assets are collected without having gaps in the information. And, because the asset communicators 120 store the information based on events until an active asset communication link 130 is established, information for the asset is not lost. In other words, the supervisor at some point in time has utilization information for all assets in the fleet at any given point in time. The supervisor interface 205 may execute a software program, such as the database engine 210, that accesses the databases 312a-316a, for example, and generates aggregate information. For example, a supervisor may desire to know the number of vehicles being utilized on each hour during the course of a particular day.

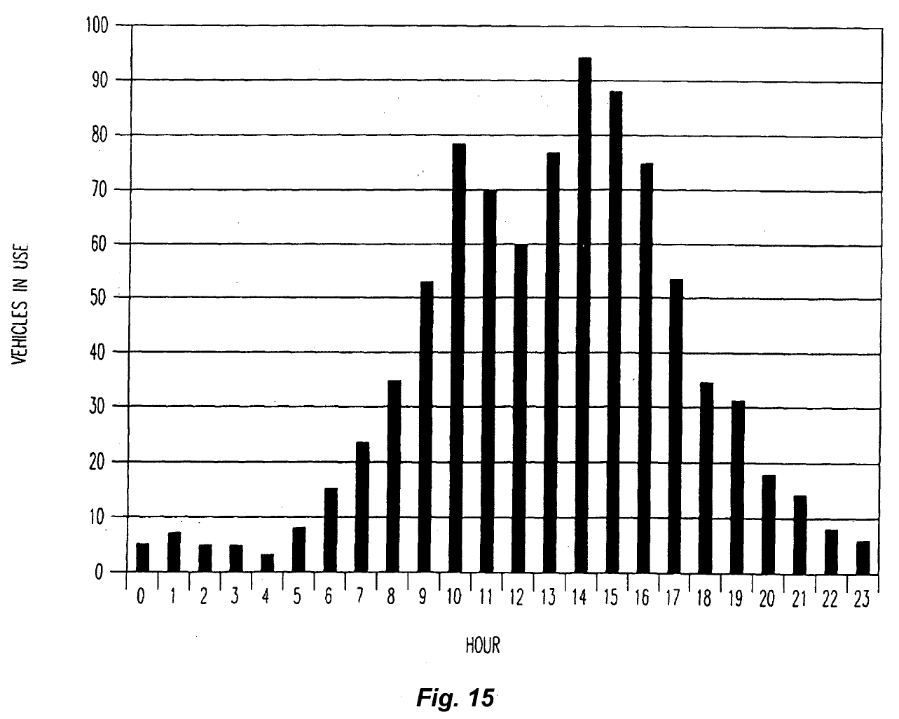

FIG. 15 is an exemplary chart 1500 indicating vehicle usage during the course of a 24-hour time period on the robust wireless communications system of FIG. 3. As indicated, an aggregate of vehicles in use are provided during the course of the day. At 2:00 p.m. (i.e., hour 14), 93 vehicles were in use. As expected, the vehicles being utilized simultaneously during first shift are more than those being utilized during second and third shifts.

The combination of time and utilization from every vehicle in the fleet may be used to make numerous determinations about vehicle fleet utilization both real-time and historically. It should be understood that the utilization information of the assets may be based on any of the utilization information generated and stored by the asset communicator 120. Accordingly, the information is uploaded from the asset communicator 120 to the wireless infrastructure unit 225 and the management computer network 115 according to FIG. 4. Such information may include in-use/unassigned, motion/idle, speed, etc. Because the utilization information is collected and accumulated, and/or summarized based on time, vehicle, and/or operator, a wide variety of aggregate data may be generated by the supervisor. The robust wireless communications system 100c may further be utilized to determine the total number of different vehicle used each day, the maximum number of simultaneous vehicles used by group, and the total number of vehicles used by the group. It should be understood that other aggregate data may be collected and processed. The functional utility of the system is achieved by the fact that data collection is automated and wirelessly communicated.

### Asset Location Monitoring

Another application that may be utilized on the robust wireless communications system 100c is asset location monitoring. Because the asset communicator 120 is intelligent, the asset communicator 120 is capable of determining its own location based on signal(s) received by the asset communicator 120. By having the asset communicators 120 determine their own locations or positions, the computations are distributed to the asset communicators 120, which reduces computational requirements for the management computing network 115 and bandwidth requirements for the robust wireless communications system 100c.

The signal(s) that are received by the asset communicators 120 may be either terrestrial or satellite based. In the case of a terrestrial signaling system, the asset communicators 120 may receive signals from multiple local monitors 110 and perform a triangulation computation as understood in the art. In one embodiment, an averaging algorithm as understood in the art may be utilized to correlate the percentage of messages received over time from a local monitor 110 with relative distances. In other words, if the asset communicator 120 receives transmissions from one local monitor 110 during every transmission, and from another local monitor 110 during half of the transmissions, then the asset communicator 120 determines that it is closer to the first local monitor 110 by an approximate percentage. The asset communicator may use configurable settings, such as filter time and conversion factors, to determine, based on the data, the meaning of the incoming signals. To set or change the configurable settings, manual, automatic, or event triggered processes may be utilized. The combination of the signals received from multiple local monitors with a current motion status of the asset communicator 120 also may be used to determine the location of the asset 105 (e.g., if the asset is not moving, the asset communicator knows that the RF readings cannot show the asset moving). In the case of utilizing satellite communication, a positioning system, such as the global positioning system (GPS), may be utilized. Other techniques, such as signal strength, direction finding, and dead-reckoning, may also be utilized by the asset communicator to determine location.

FIG. 16 represents an exemplary flow diagram 1600 for determining and communicating position of an asset utilizing the robust wireless communications system of FIGS. 3-5 and 6B. The process starts at step 1602. At this point, two processes operate in parallel (i.e., location determination and location transmission processes).

At step 1604, communications signal(s) are received by a mobile wireless device 120. The mobile wireless device 120 calculates the position of the associated asset 105 at step 1606. Information, such as motion/idle status, odometer/compass (e.g., dead-reckoning as understood in the art), or other sensory data, also may be utilized in calculating the position of the asset. At step 1608, the position of the asset 105 is updated in the mobile wireless device 120.

At step 1610, a determination is made as to whether the asset is in motion. If the asset is in motion, then at step 1612, a wait time is set to n-seconds. Otherwise, at step 1614, if the asset is idle, the wait time is set to m-seconds. At step 1616, the position of the asset, as determined at step 1608, is stored by the mobile wireless device 120 in a location database as provided in TABLE 5.

TABLE 5
Vehicle Location Information

Transaction Type Specifier
Transaction Code
Vehicle Number
Driver ID
Current Location Start Time
Operator ID
Current Time
Location Reading
Engine State
Battery Level

TABLE 5 is an exemplary list of data elements stored in an asset location database on the asset communicator 120. As shown, a transaction type specifier, transaction code, vehicle number, driver ID, current location start time, current time, location readings, engine state, and battery level may be stored in the asset location database. Additionally, the vehicle location information may include a utilization status of the vehicle. In one embodiment, the current driver ID may itself provide the utilization status, whereby if the current driver ID is not specified (e.g., −1), then the vehicle is identified as being unutilized. Each time that location of the asset is stored, a transaction code may be assigned to form a dataset. And, by associating asset location with vehicle number and driver ID, the supervisor of the robust wireless communications system may determine an operator utilizing a particular vehicle at any given point in time or determine the location of vehicles that are unutilized at any given point in time.

The data of TABLE 5 is communicated from the mobile wireless device 120 to the wireless infrastructure 202 at step 1618 as provided by the communication process of FIGS. 6B and 9. In other words, the position data may be stored by the mobile wireless device 120 for an indefinite period of time based on the communication link status with the wireless infrastructure 202, thereby providing for a substantially continuous position tracking system. The process ends at step 1620. As shown, the location determination process is continuous (i.e., after step 1608), and the location communication process repeats upon storage of the position data at step 1616.

The wait times for an asset that is idle or stationary may be set to a very long time period (e.g., once per hour), and an asset that is in motion may have a shorter wait time, such as once per two seconds, for example. Alternatively, wait time may be independent of motion status of the asset. The wait times are system parameters that may be altered by the system administrator. It should be understood that in the event that an operator logs into the mobile wireless device 120, that the wait time may be automatically updated such that the mobile wireless device 120 determines its position at the shorter wait time (i.e., higher frequency rate). It should also be understood that the storage of the position of the asset in the mobile wireless device 120 of step 1616 may be performed based on the wait time. By storing the location information at lower frequency rates, the memory of the mobile wireless device 120 is less apt to be filled during periods of the asset 105 being idle. Also, because the asset communicator 120 is continuously determining its location, if the associated asset 105 moves to a specific area, such as cell 111, between intervals, the asset communicator 120 may communicate or take other actions, such as shutting down the asset 105. For example, if a forklift enters a classified area of a factory (regardless of the wait time), the asset communicator 120 may shut down the forklift and communicate an alert message to the supervisor.

### OSHA Compliance

The robust wireless communications system 100c provides for OSHA compliance with regard to the vehicle safety checklist information at the vehicle to keep an automatic record of safety checklists and identify safety issues. The asset communicators 120 allow checklist information to be customized by vehicle, and allows for the information to be updated wirelessly and automatically. The wireless communicator 120 allows an operator to answer the OSHA questions (e.g., operational status of a vehicle) independent of the asset communicator 120 being in active communication with the wireless infrastructure 202. In other words, the OSHA related questions may be answered when out-of-range of the wireless infrastructure and the answers may be communicated with the wireless infrastructure 202 upon the asset communicator 120 re-establishing a communication link with the wireless infrastructure 202.

The OSHA compliance system is bi-directional in that downlink and uplink communication is utilized to provide the questions and receive the responses. A supervisor may utilize the supervisor interface 205 to (i) generate lists of OSHA questions and possible responses, and (ii) associate each asset with the appropriate list of OSHA questions. TABLE 6A contains the specific OSHA questions and possible responses for each question list. Each asset may be associated with the appropriate list of OSHA questions using the data in TABLE 6B. As shown in TABLE 6B, the vehicle profile information may include vehicle type, vehicle number, and question list number, for example. Additionally, a transaction code may be stored with each dataset as entered and/or amended for the OSHA questions list details and vehicle OSHA question list information. And, because the database is relational, the questions may be specifically targeted toward a vehicle type and/or vehicle number.

TABLE 6A
OSHA Question list Details

Transaction Type Specifier
Transaction Code
Question List Number
Question Number
Question Text (e.g., “Horn operational?”)
Response Text (e.g., “Yes”, “No”)
Response Severity (e.g., “Normal”, “Critical”)

TABLE 6B
Vehicle Profile Information

Transaction Type Specifier
Transaction Code
Vehicle Number
Vehicle Type
Question List Number
Impact Threshold
Low Battery Threshold
Vehicle Specific Behavior

On the downlink side, once the OSHA question databases are formed, the datasets may be downloaded to asset communicators 120 utilizing the robust wireless communications system and download protocol of FIGS. 4 and 6A for synchronization of the OSHA question list for the asset communicators 120. Each asset communicator 120 stores the OSHA questions of TABLE 6A associated with the question list number of TABLE 6B associated with the vehicle number and/or vehicle type. If the question list number is updated for the asset communicator 120 associated with a particular vehicle number/vehicle type, then the asset communicator 120 updates and/or replaces the OSHA questions with the updated set of questions associated with the updated question list number.

If a hierarchical question list is utilized, then questions of TABLE 6A associated with the question group number of TABLE 6B may be associated with the vehicle type or associated with a question trigger and/or response action that is valid for the associated vehicle type. It should be understood that the question lists may be assigned and/or associated with individual assets, asset types (e.g., fork lifts), individual operators, groups of operators, events, conditions, or any other data related to the assets 105 or operators of the assets 105. The assignment process may be performed by designating an identifier in one database and utilizing the same identifier in a second database to form a relation there between as understood in the art.

The uplink communication follows the protocol of FIGS. 4 and 6B for performing synchronization of the responses from operators answering the OSHA questions. Again, upon the asset communicator 120 establishing a communication link to the wireless infrastructure 202, the datasets stored by the asset communicator 120 are transmitted from the asset communicator 120 to the wireless infrastructure 202. The supervisor may utilize the supervisor interface 205 to review and monitor results of the OSHA questions.

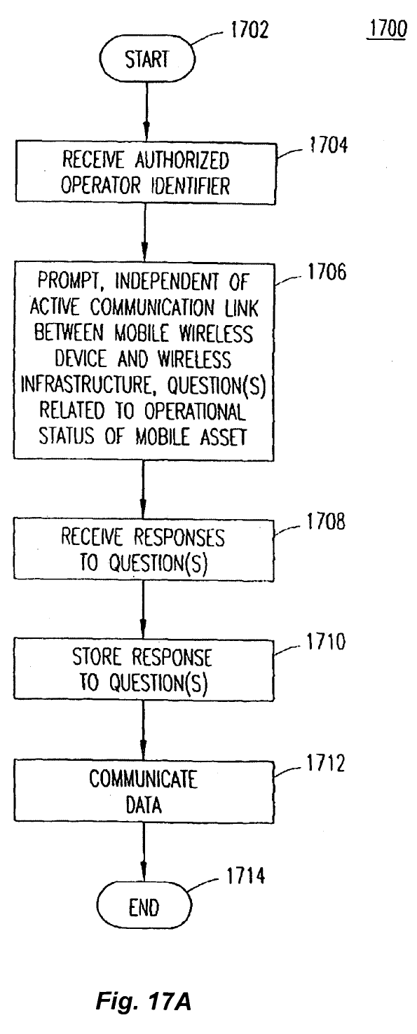

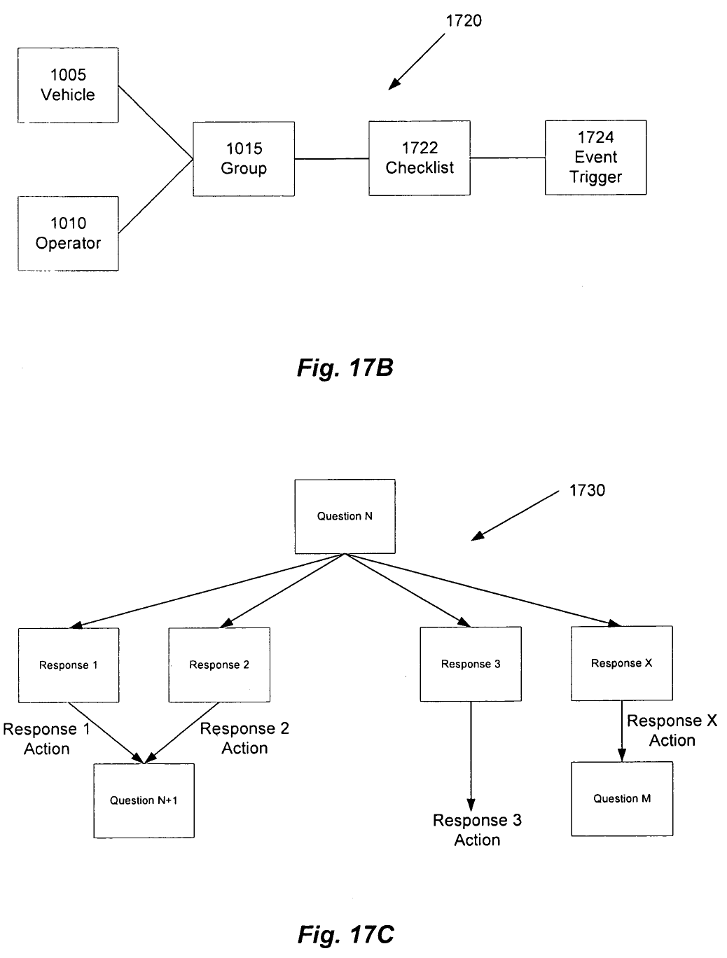

FIG. 17A is an exemplary flow diagram 1700 for performing the OSHA compliance utilizing the robust wireless communications system of FIGS. 3, 6A and 6B. The process starts at step 1702. At step 1704, an authorized operator identifier is received by the asset communicator 120. At step 1706, question(s) related to operational status of the mobile asset 105 may be prompted independent of an active asset communication link 130 between the asset communicator 120 and wireless infrastructure unit 225. Additionally, the asset communicator may use previously stored responses to the OSHA questions to limit the prompting of questions. For example, depending on the OSHA requirements, the checklist only may be required for every new operator, once per shift, once per every 24 hours, etc. Also, the OSHA questions may be prompted having a predetermined duration between each prompt to encourage an operator to properly inspect the asset 105 rather than simply assuming the answer. Therefore, because the asset communicator 120 is intelligent and is capable of storing data therein, OSHA compliance may be performed in accordance with specifications of a given business. Therefore, the asset communicator 120 may not prompt questions for answers if not required at that time. Additionally, based on certain conditions (e.g., mileage) of the asset 105, a different checklist may be prompted on the asset communicator 120. At step 1708, responses to the questions are received by the asset communicator 120. The responses may be entered using a keypad, touch screen, or verbal input (if the asset communicator 120 utilizes voice recognition software), for example. At step 1710, the responses to the questions are stored by the asset communicator 120. The responses may be communicated at step 1712 using the communication technique of FIG. 9. At step 1714, the process ends.

In addition to the questions being answered by the operator, different questions may be associated with different levels of severity as defined in TABLE 6A. The levels of severity may be determined by system parameters maintained by a supervisor. Upon a question being answered in a certain way, different results may occur. For example, if the answer to the question of whether the headlights are working is negative, then the asset communicator may perform an immediate action in shutting down the associated mobile asset 105 or performing another action such as entering a low-speed mode or turning on a siren or light. A less immediate action may result in an event occurring based on a particular answer. For example, a negative response to the question of whether the headlights work may result in an e-mail, page, or other notification being communicated to the management computer network 115 to indicate that maintenance is required for the particular mobile asset to which the asset communicator 120 is coupled.

Still yet, because the components (e.g., management computing system 302, wireless infrastructure device 202, and asset communicator 120) of the robust wireless communications system 100c are each capable of making decisions, any of the components individually or combined may determine that responses to the OSHA questions have not been answered in a timely manner (i.e., a business rule has been violated). If such an event occurs, action may be taken by one or more of the components. For example, if a response to an OSHA question or questions is not received by an asset communicator 120, then the asset communicator 120 may shut down the vehicle, notify the supervisor of the non-responsive operator, and/or generate a visual and/or audible display, such as a light or siren. Additionally, the management computing system 302 may communicate a message to all or some of the assets 105 that prevents the non-responsive operator from having access thereto. Additionally, the supervisor may receive a message, page, or e-mail indicating the non-responsiveness of the operator.

Conventional checklists, including paper and electronic checklists, typically utilize a single checklist that is to be completed from the first question to the last. While the checklists may change over time, only one checklist exists at any given time on each asset 105. The checklist may be different on each type of asset 105, but is not related to the specific operator utilizing the asset 105.

To make the checklists more business flexible, hierarchical question lists may be utilized to obtain more specific information in a more flexible way than can be obtained from conventional checklists. Rather than a fixed, sequential list, the hierarchical list permits changing of questions, based on responses, operators, or other vehicle or date-based conditions. For example, two different types of operators using the same asset 105 may be presented with different checklists. Additionally, should one response signify an issue that requires clarification, additional, more detailed questions may be asked of the operator. Alternatively, if the same response does not need more clarification, then either no or different questions may be asked of the operator. Further, if the asset (e.g., lift truck) is in a specific location or encounters an impact, a new checklist may be displayed.

FIG. 17B is an exemplary block diagram 1720 for integrating a checklist database 1722 and event/trigger database 1724 into the relational databases of FIG. 10. By using relational databases, the flexibility of the checklists may be increased as a function of the information stored in the vehicle database 1005, operator database 1010, group database 1015, event/trigger database 1724, or any combination thereof.

The robust wireless communications system 100c enables creation and management of the hierarchical questions. The infrastructure for creating the questions hereby enables these hierarchical questions. In one such implementation, software, as understood in the art, executed by the supervisor interface 205 of the management computer system 115, permits the administrator to designate the question text, the response option text, and response option actions. Response option actions may include: proceed to next question, branch to question N, end checklist, and deactivate vehicle, for example. Such response actions permit a tree-like structure for the checklist questions.

The software further permits the creation of numerous such checklists, where each checklist is associated with a vehicle type and/or operator type. Alternatively, the checklist may be associated with a vehicle-identified condition. By assigning a checklist to an equipment type or single piece of equipment, the equipment is designated to ask the single checklist to any operator. By assigning a checklist to an operator type or single operator, the same checklist is presented to the operator regardless of the equipment operated. By assigning the checklist to a combination of equipment and operator types, different operators on the same vehicle may be presented with different checklists. By assigning a checklist to a condition, the vehicle can ask questions when certain events take place, including, but not limited to, certain dates or times, certain locations, after an impact is detected, when battery voltage is low, or when a monitored meter level reaches a threshold. In one embodiment, the assignment of the check list may be performed by selecting from a list of assignments (e.g., operator group or asset type).

In the event of an assigned condition occurring, for example, when a battery voltage is low, a checklist can ask ‘Did you notice that the battery is low?’ with responses: ‘Yes, but I'm busy’, ‘No—I'll recharge it now’, ‘Yes—but it is OK’. Alternatively, after an impact, an operator may be asked, ‘Did the recent impact create damage?’ with responses: ‘Yes’ and ‘No’. After a certain amount of motor hours is recorded on the equipment, the question ‘Please bring vehicle in for maintenance’ may be asked, with responses: ‘Not now’ and ‘OK’.

FIG. 17C is an exemplary tree structure 1730 representative of a question list that may be utilized by the asset communicators 120 to ask questions directed to OSHA or for other purposes. In downloading the question lists to the asset communicators 120, the robust wireless communications system 100c is used to transfer pertinent questions and response text and actions to each asset communicator 120 associated with the assets 105, whereby only checklists relevant to the particular type of assets are stored on the associated asset communicator 120. Alternatively, asset communicators 120 may store multiple checklists if each checklist is defined to be associated with particular types of assets 105.

In order to provide the questions by operator type, the asset communicator 120 collects the operator identifier from the operator utilizing the asset 105. If the defined checklists of the asset 105 include operator-related questions, then, in one embodiment, the processor 328 of the asset communicator 120 determines the specific checklist or checklists to ask the operator for OSHA compliance or other business purposes. The operator may interface with the checklist via the display 333 and/or keypad 332 to answer questions. The checklist may be presented in a graphical user interface (GUI) format or text based format. If a GUI format is utilized, then selection menus may be presented for the operator to select an answer. In response to the operator selecting answers to the questions of the checklist, an appropriate action is processed by the processor 328 to proceed to presenting the subsequent question and responses. As shown, for example, Question N may have multiple alternative responses (i.e., Response 1, Response 2, . . . , Response X). Based on the response, a specific response action may be taken. The response action may be predetermined, but alternatively may be altered during operation of the asset based on time and/or location, for example. The same questions (e.g., Question N+1), alternative questions (e.g., Question N+1 or Question M), or no questions may be followed by the response action in response to the operator answering the questions.

For each response, the specific question and response identifier are stored and/or transmitted to the wireless infrastructure 202 and management computing system 302. In one embodiment, the asset communicator 120 stores each response in internal memory until the final checklist question is asked, as determined by a response action ‘end-of-checklist’. Once the first checklist is complete, if a second checklist is relevant, due to the operator, vehicle or vehicle condition, it may be presented in the same manner as the first checklist. In response to the question/response combinations being stored, the information may be uploaded via the robust wireless communications system 100c to the database (e.g., database 316a) for storage and further analysis utilizing the communications of FIG. 4. In another embodiment, each response is transferred immediately to the wireless infrastructure 202 utilizing the communications of FIG. 5 and the next question may be transferred back to the asset communicator 120 of the asset 105 for presentation.

### Two-Way Text Messaging

Two-way text messaging may be utilized on the robust wireless communications system of 100c in accordance with the communication technique of FIGS. 4, 6A, 6B, and 9. As suggested, the two-way text messaging is both a downlink and uplink communication technique that allows a message to be communicated to any vehicle, operator, group, or all assets. Each message may be associated with a set of responses communicated therewith. The receiver of the message may select one or more responses and communicate the responses back to the issuer of the message. Status information, such as time of receipt, time that the message is read, time of each response, and time when message is deleted, may also be communicated to the issuer. Two-way text messaging further may be used to set work instructions or other dispatch information to an operator of the asset 125. One exemplary use of two-way messaging includes warehouse management instructions. Additionally, the two-way text messaging may be used for the operator to communicate responses to the supervisor issuing the messages. While two-way text messaging may be performed utilizing the robust wireless communications system 100c, one-way text messaging or paging may also be performed on the system. As understood in the art, one-way text messaging does not require that information be communicated back to the device that issues the one-way text message.

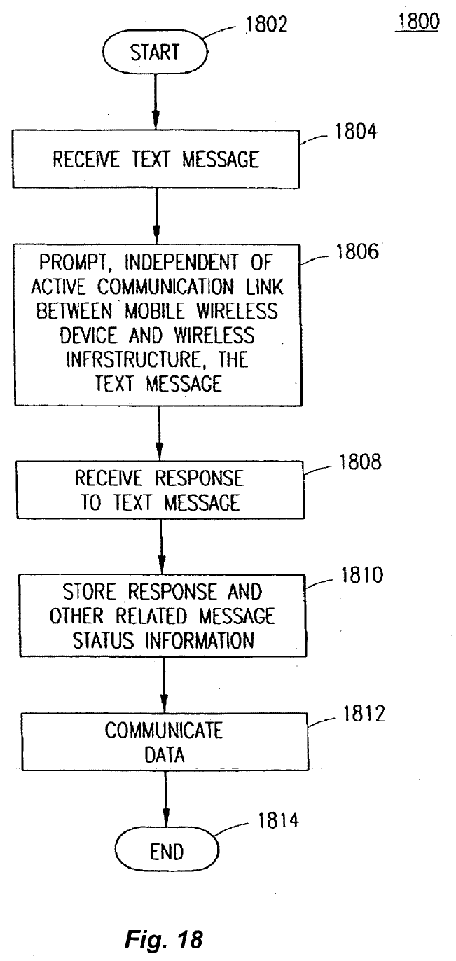

FIG. 18 is an exemplary flow diagram 1800 providing a process for performing the two-way messaging on the robust wireless communications system 100c. The process starts at step 1802. At step 1804, a text message is received via the downlink communication process of FIG. 6A. The mobile wireless device 120 only stores text messages associated with the vehicle number, current operator, or group identifier. All broadcast text messages are stored. Other related message status information, such as time of receipt, may be stored. At step 1806, the message is prompted on the mobile wireless device 120 on the display 333 independent of an active communication link between the mobile wireless device 120. Typically, an operator uses the keypad 332 and display 333 to read the contents of the text message and view the optional responses. The time that the text message is read may additionally be stored. At step 1808, the operator may respond to the text message, and the response and other related message status information may be stored at step 1810. The operator may respond multiple times to the same text message. Additionally, actions may be executed by the mobile wireless device 120 based on the response(s) to the text messages. For example, a response to a text message may cause the mobile wireless device 120 to shut off the associated asset. At step 1812, the stored data is communicated using the communication technique of FIG. 9. Once the responses and status data are stored in the management computing system database 312a, a supervisor may view the data using the supervisor interface 205.

### Battery Monitoring and Charging

A battery monitoring and charging application is capable of utilizing the robust wireless communications system 100c. Two concepts exist for the battery monitoring, including: (i) notification to the operator that the battery voltage level is low, and (ii) notification as to (a) which charger to mount the battery and (b) which charged battery to install in the asset.

Regarding the first concept (i.e., notification to the operator of low battery voltage), the battery monitoring and charging application provides information to an operator of a vehicle to which a battery is coupled, and utilizes both the downlink and uplink aspects of the robust wireless communications system 100c. Additionally, the communication techniques of FIGS. 4, 5, 6A, and 6B may be utilized.

In the downlink direction, the supervisor may set a low threshold value, such as 10.7 volts, for the battery voltage by utilizing the supervisor interface 205. The low threshold value is a system parameter that is downloaded to the asset communicator 120 using data from TABLE 6B and the downlink techniques of FIG. 4.

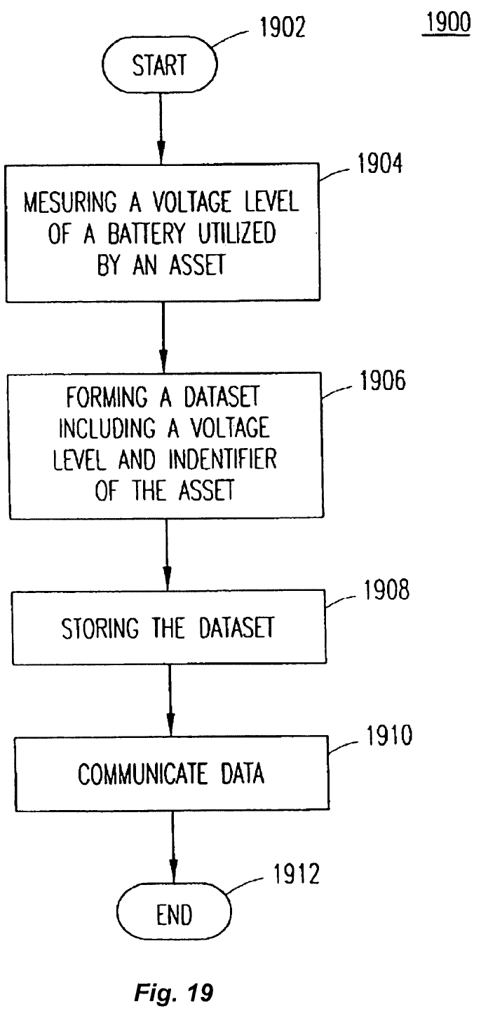

Referring now to FIG. 19, an exemplary flow chart 1900 provides a process for measuring battery voltage of an asset utilizing the robust wireless communications system of FIGS. 3 and 6B. The process starts at step 1902. At step 1904, a voltage level of a battery utilized by the asset is measured. The voltage level may be measured by the asset communicator 120 or by an external measuring device. Further, the voltage level may be measured at the battery or remotely (i.e., at another location within the asset and electrically coupled to the battery).

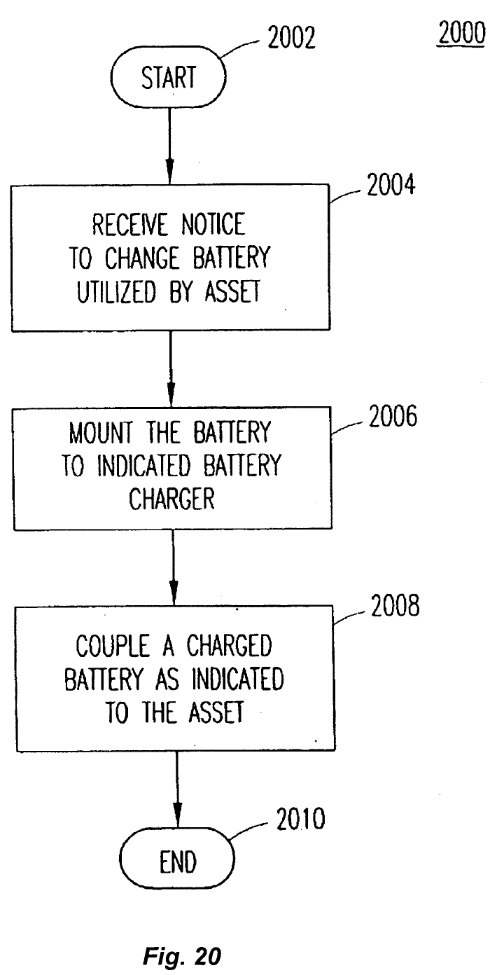

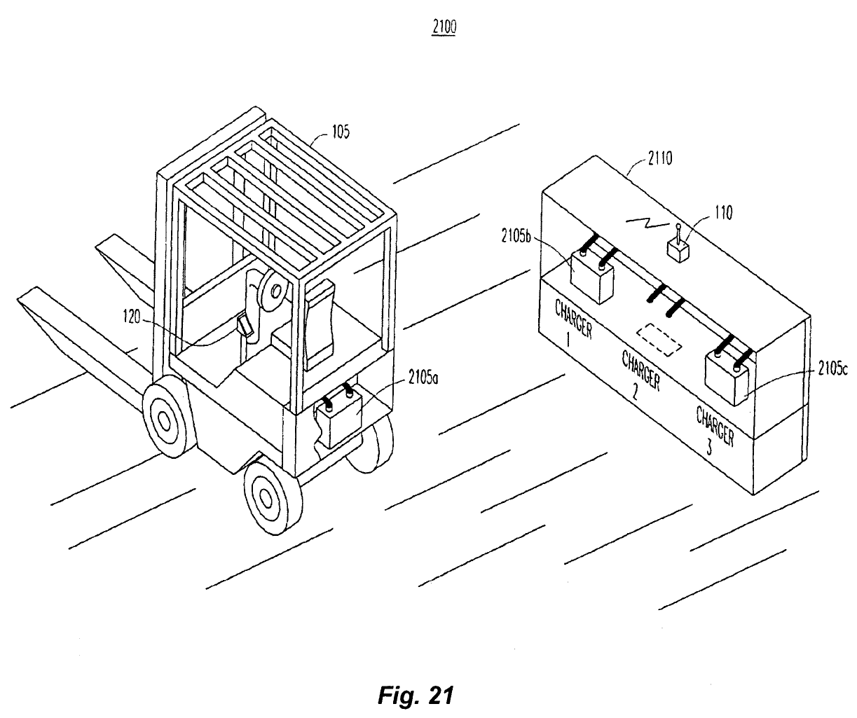

At step 1906, a dataset, including a voltage level and identifier (e.g., vehicle identifier) of the asset, is formed based on the threshold voltage level being surpassed. Additionally, the dataset may include data elements provided in TABLE 7, including a transaction code that is temporal with respect to other related datasets, transaction type specifier, event time, driver ID, asset assignment status, battery threshold, and location reading. A visual and/or audible indicator may be used to notify the operator of the vehicle that the battery level is low. The operator may respond to the indicator utilizing the process of FIG. 20, discussed hereinafter. The dataset is stored at step 1908, and communicated at step 1910 in accordance with the communication technique of FIG. 9. The process ends at step 1912.

TABLE 7
Low Battery Information

Transaction Type Specifier
Transaction Code
Vehicle Number
Event Time
Driver ID
Assignment Status
Battery Level
Battery Threshold
Location Reading

Referring now to FIG. 20, an exemplary flow diagram 2000 provides for a process of changing the battery with a charged battery utilizing the robust wireless communications system of FIGS. 3-5, 6A, and 6B. The process starts at step 2002. The operator of the asset 105 issues a notice to the asset communicator 120, utilizing the keypad 332, for example, that the associated battery should be changed with a charged battery. A message may be communicated from the asset communicator 120 to the management computing system 302 using the immediate messaging technique of FIG. 5. At this point, the management computing system may determine the appropriate replacement battery and charging station for the discharged battery to be placed. At step 2004, a message or notice may be received by the asset communicator 120 from the management computing system 302 using the immediate messaging technique of FIG. 5. The message may include: (i) replace battery, (ii) specific battery charger to mount the discharged battery, and (iii) specific charged battery to install into the asset 105.

Referring now to FIG. 21, a typical working environment 2100 is provide for a mobile asset 105 utilizing the robust wireless communications system of FIG. 3. As shown, the mobile asset 105 includes the asset communicator 120 and a battery 2105a for operating the mobile asset 105. Upon the operator receiving the message via the asset communicator 120, the operator removes the battery 2105a and replaces it with a charged battery, such as a charged battery 2105b or 2105c mounted on a battery charger station 2110 as indicated by the message. The battery charger station 2110 may include a battery voltage monitor device (not shown) as understood in the art to monitor battery voltage of the batteries being charged. A local monitor 110 may be coupled to the battery voltage monitor device to communicate status of batteries being charged to the management computer network 115 so that the management computer network 115 may maintain the status of all batteries being utilized by the assets 105.

Referring again to FIG. 20, at step 2006, the battery 2105a is mounted to the battery charger specified by the message. At step 2008, the charged battery 2105b, for example, indicated by the message is installed into the mobile asset 105. The asset communicator 120 further may prompt the operator to verify that the battery is successfully changed as instructed. If the operator is unable to change the battery as instructed, then the operator may override the instructions by entering (i) which battery charger station the discharged battery was placed, (ii) which charged battery was placed into the mobile asset 105, and/or (iii) a message indicating other occurrences in changing the battery. A swap confirmation message may be stored by the asset communicator 120 and communicated to the wireless infrastructure 202 using the communication technique of FIG. 9. The process ends at step 2010.

### Impact Monitoring

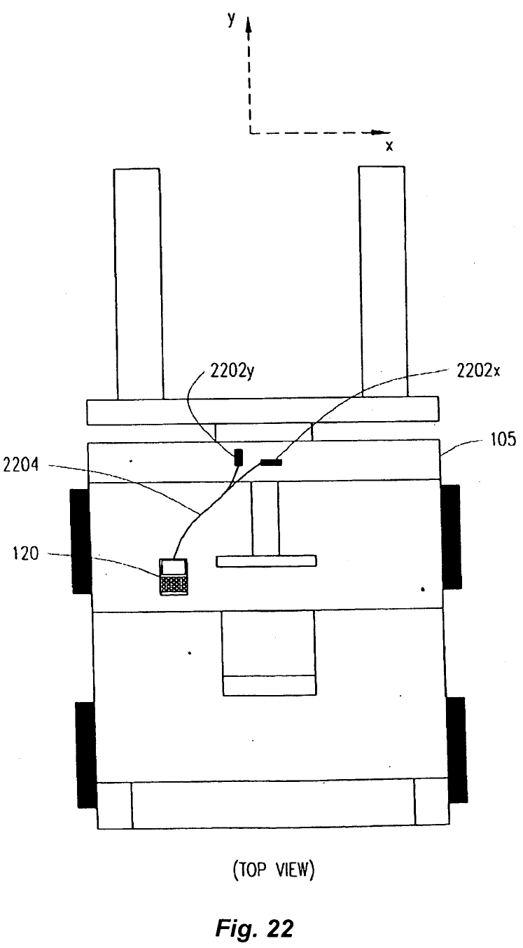

FIG. 22 is a top view of an exemplary mobile asset 105 capable of measuring impact of the mobile asset 105. To measure impact, impact sensors 2202x and 2202y (e.g., accelerometers) are mounted to the mobile asset 105 and electrically coupled via the wires 2204 to the asset communicator 120 associated with the mobile asset 105. As shown, the impact sensor 2202x is oriented in the x-axis direction, and the impact sensor 2202y is oriented in the y-axis direction. By utilizing multiple sensors having different axes of orientation, the asset communicator 120 is capable of receiving impact signals from the impact sensors 2202x and 2202y, and determining the level, duration, waveform, and angle of impact. It should be understood that the axes of orientation for the sensors 2202x and 2202y may be different and that the asset communicator 120 may be programmed to compute the level and angle of impact based on the orientations as understood in the art. It should be further understood that other impact sensors may be oriented in different orientations (e.g., z-axis) and utilized to measure impacts from different directions (e.g., vertical).

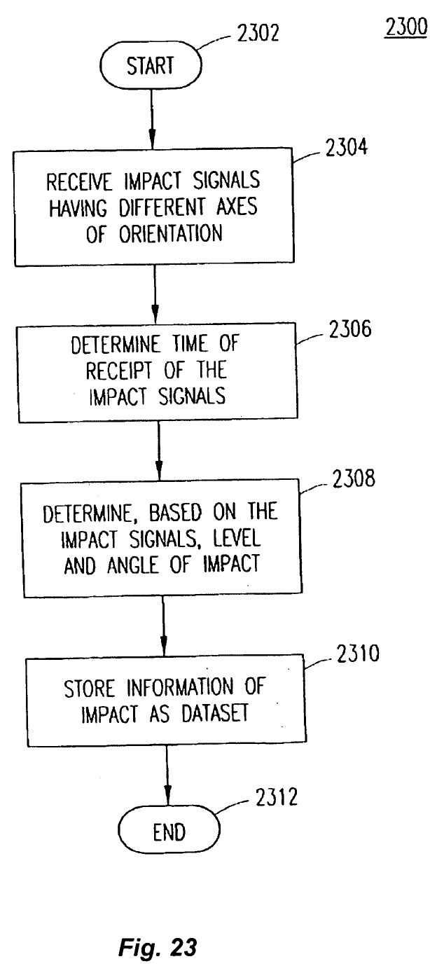

FIG. 23 is an exemplary flow diagram 2300 for monitoring for an impact to the mobile asset 105 of FIG. 22. The process starts at step 2302. At step 2304, an impact between the mobile asset 105 and another object occurs, and impact signals having different axes of orientation are received. The impact sensors 2202x and 2202y may be position, velocity, acceleration, force, and/or impact sensors. The signals generated from the impact sensors 2202x and 2202y may provide parameters to the asset communicator 120 for computing the g-force of impact or any other relevant impact parameter, including duration, waveform, and profile of impact, which may be utilized to distinguish a true impact from a bump.

At step 2306, the time of receipt of the impact signals are determined. In the case of utilizing the impact information to alert a rescuer, for example, the time of receipt of the impact may be important in terms of rescue efforts. The time may also be critical in replaying the historical locations of assets at the time of the impact. At step 2308, the level and angle of the impact may be determined based on the impact signals. The angle of impact may be computed by a software program operating in the asset communicator 120 or management computing system 302, where the software program may convert the impact levels received in Cartesian coordinates (i.e., x, y values) to polar coordinates (i.e., r, ⊖ values) to produce magnitude and angle of impact as understood in the art. At step 2310, information of the impact, including time, impact level, impact duration, impact profile, and impact angle, may be stored as a dataset. The process ends at step 2312.

TABLE 8 provides an exemplary list of parameters that may be stored with the dataset in an impact database. As discussed with regard to the robust wireless communications system 100c, a transaction code may be generated and stored with the dataset. Because the asset communicator 120 has other various pertinent information for impact analysis, such as driver ID, assignment status of the mobile asset 105, impact threshold (system parameter), engine state, and location, other relevant information may be included on the dataset. Of course, any other data stored or determinable by the asset communicator 120 may be included in the dataset.

TABLE 8
Impact Information

Transaction Code
Vehicle Number
Event Time
Driver ID
Assigned?
Impact Level
Impact Angle
Impact Thresholds
Engine State
Location Reading

The dataset may be communicated from the asset communicator 120 to the wireless infrastructure unit 225 using the communication technique of FIG. 9. Because impact of a mobile asset 105 may involve personal injury, real-time communication may be important, so the immediate communication technique of FIG. 5 may be utilized to inform authorities. Receipt of the page by the management computer system 115 may trigger a notification to local authorities via a paging message, e-mail, or telephone call. An impact may be considered a violation of a business rule and trigger one or more events, such as preventing the operator involved in the impact from accessing the same or other vehicles. The asset communicator may also (i) shut down the vehicle, (ii) put the vehicle into a creeper mode so that vehicle may be moved if necessary, but not used as normal, or (iii) turn on a signal such as a light or siren. The dataset may provide the supervisor or authorities with information for reconstruction of the impact. For example, if a collision occurs between two monitored assets, then the cause of the collision may be determined by the data generated from both asset communicators 120. One scenario may include an unutilized vehicle recording an impact with a vehicle that is being driven by an identified operator.

### Maintenance Monitoring

Scheduled maintenance of assets, including both fixed and mobile assets, may be managed by utilizing the robust wireless communications system 100c. The management computing system 302 may predetermine, forecast, or project an expiration date for a scheduled maintenance for the assets being managed by the management computing system 302 based on historical utilization information. Assets may also be scheduled based on responses from OSHA questions or by the asset communicator 120 sensing maintenance problems with the asset 105. Maintenance events also may be scheduled manually, such as by a maintenance supervisor. To determine the expiration date, the management computing system 302 may inspect the vehicle utilization information of TABLE 4 as stored in a database 312, for example, and extrapolate future utilization of the asset 105. Additionally, software may track global parameters for the assets 105 to determine the expiration date for the scheduled maintenance. Such global parameters may include mileage and hours of use, motion, and lift time, for example, as well as calendar time since last maintenance. Additionally, the system may prioritize based on scheduled maintenance discrepancies between the projected and scheduled maintenance times.

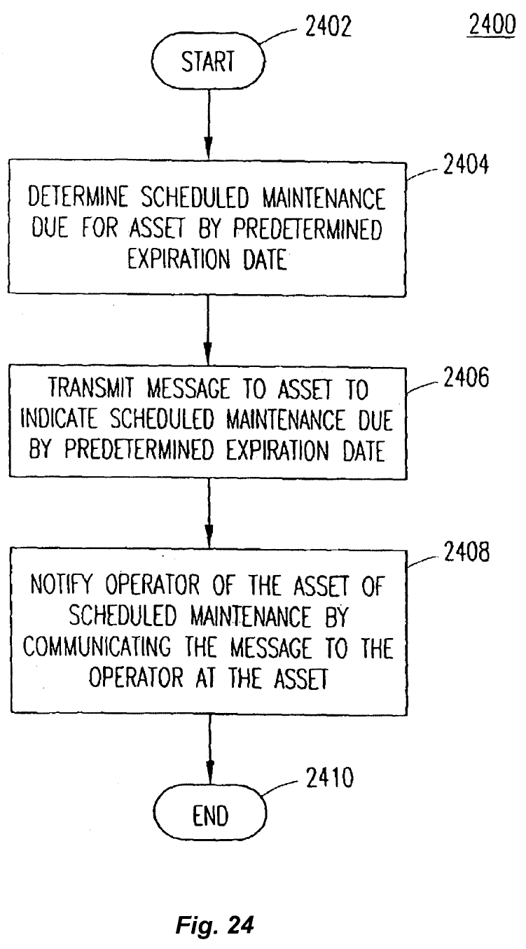

FIG. 24 is an exemplary block diagram 2400 indicative of a method for managing scheduled maintenance of assets. The process starts at step 2402. At step 2404, schedule maintenance due for an asset by a predetermined expiration date is determined. The determination may be made manually or automatically. At step 2406, a message is communicated to the asset using the communication technique of FIG. 9 to indicate that the scheduled maintenance is due by the predetermined expiration date. The message may be generated manually by a supervisor or automatically by the management computing system 302. In one embodiment, the message is transmitted to the asset communicator 120 via a paging message to ensure that the asset communicator 120 receives the message with an appropriate amount of time to have the scheduled maintenance performed on the asset.

At step 2408, an operator of the asset is notified of the scheduled maintenance by communicating the message to the operator at the asset via the asset communicator 120. The notification may be in the form of a visual display or an audible message. The process ends at step 2410.

The predetermined expiration date is a mandatory date for which maintenance is to be performed on the asset. In other words, the predetermined expiration date is the date by which the asset must be brought into a maintenance center, or a maintenance worker comes to the asset to perform the maintenance. Upon the asset having the scheduled maintenance performed, the asset communicator 120 and/or the management computing system 302 may be updated wirelessly. And, the asset communicator 120 may communicate with an on-board computer, such as an automobile computer, to assist with the diagnostics. If, however, the scheduled maintenance is not performed on the asset before the end of the predetermined expiration date, then the asset communicator 120 may disable, put into creeper mode, and/or disable certain features (e.g., lift). At this point, only an authorized user, such as a supervisor or maintenance personnel, may access the asset communicator 120 and operate the asset.

### Indirect Communications System

Fleet management and tracking of vehicles, railcars, and trucks, for instance, may be a difficult venture due to situations of remote distribution of the assets. Additionally, due to system coverage constraints, it is possible that various assets within a fleet rarely or never come within range of a local monitor 110. For example, railcars often times do not come within a certain minimum range of a station for an asset communicator 120 to form an asset communication link 130 with a local monitor 110 located at the station. As another example, large automobile lots may preclude asset communicators 120 mounted to automobiles located at the back of the parking lot from maintaining an active asset communication link 130 with the wireless infrastructure unit 225, thereby preventing updating of the databases within the asset communicator 120 during potentially long periods of time. Additionally, certain wireless infrastructure units 225 may not include a communication unit 230a, 230b, or 230c. In such a case, the wireless infrastructure unit 225 communicates with at least one other wireless infrastructure unit 225 in order to indirectly communicate with the management computing system 302. For these and other reasons, an alternative embodiment of the robust wireless infrastructure 100c is provided.

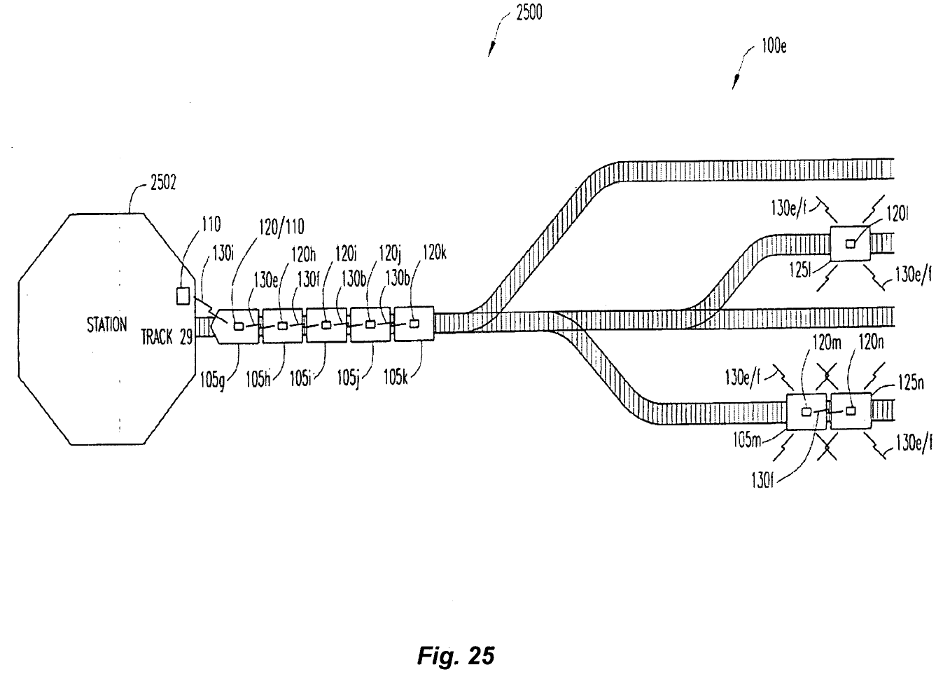

FIG. 25 is an exemplary embodiment of a wireless infrastructure 100e consistent with that of FIG. 1 for providing wireless communications on a remotely populated fleet of assets 2500, such as railcars. As shown, the assets include a locomotive 105g and attached railcars 105h-105k, and railcars 105l and 105m-105n unattached to the locomotive 105g. While the railcars 105h-105k may be within wireless communication range of the station 2502 and the local monitor 110, the railcars 105l-105n are unable to form a wireless communication link with the local monitor 110. However, it should be understood that the asset communicator/local monitor pair 120/110 may perform the same or similar functionality as the local monitor 110 having its databases (e.g., 312b, 314b, and 315b) being updated via the local monitor 110. It should be further understood that the hardware of the local monitor 110 may be substantially the same as asset communicator 120.

Coupled to the locomotive 105g is an asset communicator/local monitor pair 120/110, which is a device that performs both asset communicator 120 and local monitor 110 functions. Alternatively, only a local monitor may be deployed on the locomotive or key communication point. By including a local monitor 110 with the locomotive 105g, the asset communicator/local monitor pair 120/110 may operate as a mobile local monitor, and communicate with asset communicators 120 that are unable to communicate directly with the local monitor 110 mounted to the station 2502. Alternatively, the asset communicator/local monitor pair 120/110 may be two or more devices coupled via a wired or wireless communication link.

The asset communicators 120h-120n may operate in a “repeater” mode, where the asset communicators 120h-120n are capable of communicating through each other. In operating in the repeater mode, the asset communicators 120h-120n are capable of transmitting and receiving the information stored in their respective databases. The asset communicators 120h-120n may communicate directly with the asset communicator/local monitor pair 120/110 to form an asset communication link 130e or with another asset communicator (e.g., between asset communicators 120h and 120i) to form an asset communication link 130f. Asset communicator 120l is shown to be attempting a transmission of data with potential asset communication links 130e/f. By having the asset communicators 120h-120n communicating the data between each other and/or eventually to the asset communicator/local monitor pair 120/110, the data generated in the asset communicators 120h-120n eventually is capable of reaching the management computing system 302 via the local monitor 110.

The robust wireless communications system 100e is capable of determining the number of existing assets 105 operating on the system 100e without having direct communication links to each asset 105 (i.e., without complete coverage). Additionally, the system 100e may be able to determine the relative distances of the asset 105 from a local monitor 110. To determine the relative distances, an algorithm may be utilized to determine the number of “hops”, where the number of hops refers to the number of intermediary links between the asset communicator 105i and the local monitor 110, which is three in this case. To determine the number of hops, each asset communicator 120 may perform a query to determine if a direct communication link 130i to a local monitor 110 may be established. If so, then the number of hops is determined to be one. Otherwise, upon a communication link 130e between the asset communicator 120h and the asset communicator/local monitor pair 120/110, the asset communicator 120h determines that the number of hops is two by adding one to the number of hops returned by the asset communicator/local monitor pair 120/110. The process may repeat for each of the asset communicators 120i, 120j, and 120k, for example. It should be understood that the algorithm may be performed in other ways, but that the functionality should produce the same or similar results.

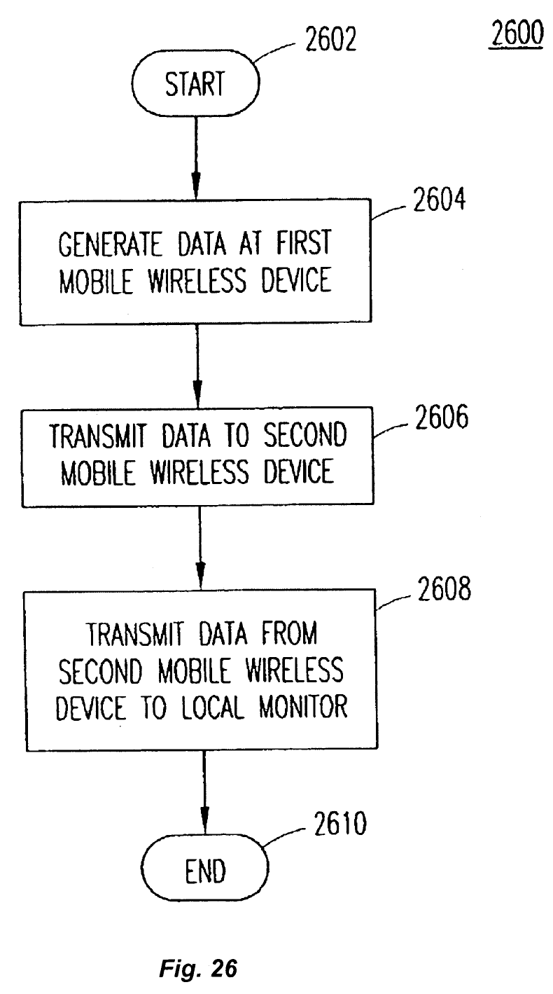

FIG. 26 is an exemplary flow diagram 2600 for an indirect uplink communication with remotely populated assets utilizing the robust wireless communications system 100e according to FIG. 3. The process starts at step 2602. At step 2604, data is generated at a first mobile wireless device, such as the asset communicator 120n. The data may be stored at the first mobile wireless device until a wireless communication link is established with a second mobile wireless device or remote local monitor. At step 2606, the data is transmitted from the first mobile wireless device to the second mobile wireless device. Again, the data may be stored at the second mobile wireless device or remote local monitor until a wireless communication link is established with a third mobile wireless device or local monitor. At step 2608, the data is transmitted from the second mobile wireless device to the local monitor, where the local monitor may be mounted to a mobile asset or fixed to a structure. Accordingly, the data may be in the form of datasets, and have transaction codes associated with each dataset as per the uplink communication technique of FIG. 9. As the datasets are communicated throughout the network of mobile wireless devices and remote local monitors, the transaction codes may be used to identify the temporal relationship between datasets produced by a mobile wireless device. It should be understood that the data may be communicated, in either the uplink or downlink direction, between any two mobile wireless devices without either of the mobile wireless devices having a wireless communication link to any other mobile wireless device or local monitor 110.

To avoid having endless loops of data communicating amongst the asset communicators 120, an algorithm is provided. The algorithm utilizes a listing of asset communicators 120 or remote local monitors through which the data has passed. An asset communicator 120 or remote local monitor does not send data through any asset communicator already in the list. The asset communicators choose a nearby asset communicator 120 or remote local monitor that is deemed “closer” to the local monitor 110, where “closer” indicates that fewer communication “hops” are required to reach the local monitor 110.

Work Request Dispatch Engine

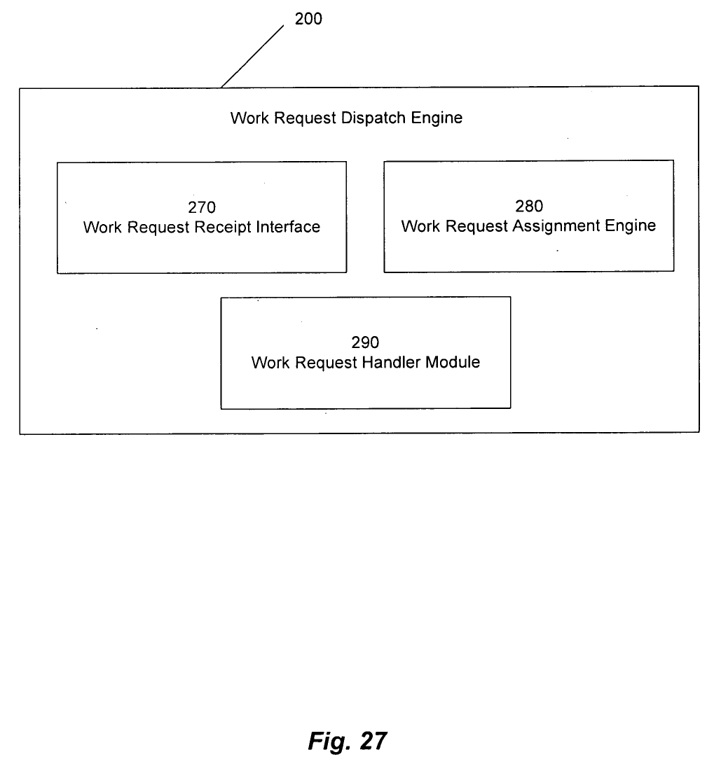

FIG. 27 illustrates a block diagram of an exemplary embodiment of the work request dispatch engine 200 in accordance with an exemplary embodiment of the present invention. The work request dispatch engine 200 may comprise a work request receipt interface 270, a work request assignment engine 280, and a work request handler module 290. The work request dispatch engine 200 may receive, process, and assign work requests from both internal and external sources.

In a warehouse environment, the work request dispatch engine 200 may receive an external shipping request to move a shelved item from storage to a shipping and handling location. The work request dispatch engine 200 may employ the real time mobile asset monitoring features described above to determine, based upon a set of heuristics, which asset in the fleet is best suited to completing the task. This determination may be made based upon at least the current operational status and location of the asset.

In an industrial setting, the work request dispatch engine 200 may receive internal requests. For example, in a manufacturing facility, a work unit may request from storage necessary parts that are running low using a electronic interface located at the work unit station such as a line asset communicator (LAC). The work request dispatch engine 200 may receive this request and assign a mobile asset the task of completing this work request. Again, the work request dispatch engine 200 may make this determination based upon a set of heuristics and at least the current operational status of the asset.

The tasks associated with the work requests may be assigned to an operator and dispatched to a vehicle asset communicator (VAC) coupled to the operator's mobile asset/vehicle via the paging system described above, or another suitable form of communication. Once the operator receives the task, he/she may have an option to accept or decline the work request using the interface of the VAC. Upon completion, the operator may indicate that the task has been or cannot be completed using the VAC interface, and the message may be transmitted to the work request dispatch engine 200 and processed as having been completed. For example, the operator may deliver a load to a location and indicate using the VAC that the work request is complete. Similarly, the operator may arrive at a pick up location and find that the item to be picked up is missing, and may indicate using the VAC that the work request cannot be completed.

The task may remain assigned to the particular operator until it is indicated as being completed, cannot be completed, canceled by the operator, or until a predetermined period of time passes without the task being completed when it may be reassigned to another operator. Additionally, if a predetermined period of time passes without completion, the operator may receive a reminder regarding the task.

The work request dispatch engine 200 may also maintain and manage the work requests. In particular, the work request dispatch engine 200 may load balance work between operators based on system configuration parameters and a set of heuristics. For example, if a task has been assigned to an operator who has failed to complete it after a predetermined amount of time, cancels the task, or is currently working on a different work request, the task may be reassigned to another operator that is available and can complete the task.

The work request dispatch engine 200 may use operational information obtained via the VAC as described above to dispatch or reassign work assignments. This information may be provided to the work request dispatch engine 200 in real-time to assist in management of work requests. For example, if a VAC detects that the battery of an asset is low, the work request dispatch engine 200 may reassign a task that has been assigned to this asset to another asset. Additionally, if the operational condition indicates that the asset will likely not be able to complete the task, the work request dispatch engine 200 may not assign the task to that asset in the first place. For example, if the asset has a low battery allowing for only 20 additional minutes of operation, a 30 minute task may not be assigned to that mobile asset/vehicle. Additionally, location information may be used to determine the closest available operator.

The work request dispatch engine 200 may also take into account the operator's schedule. For example, if an operator is 15 minutes from completing his/her shift, the work request dispatch engine 200 may determine not to assign a 30 minute task to that operator unless no better suited operator is available. Additionally, in an exemplary embodiment, the work request dispatch engine 200 may notify a supervisor or an overtime request prior to assigning a task that will hold an operator past the end of his/her shift.

The work request dispatch engine 200 may also take into account the type of jobs that the a mobile vehicle/asset has been designated to handle. For example, a forklift may be designated to only handle shipping jobs. Consequently, the work request dispatch engine 200 may only assign shipping work requests to that particular mobile vehicle/asset.

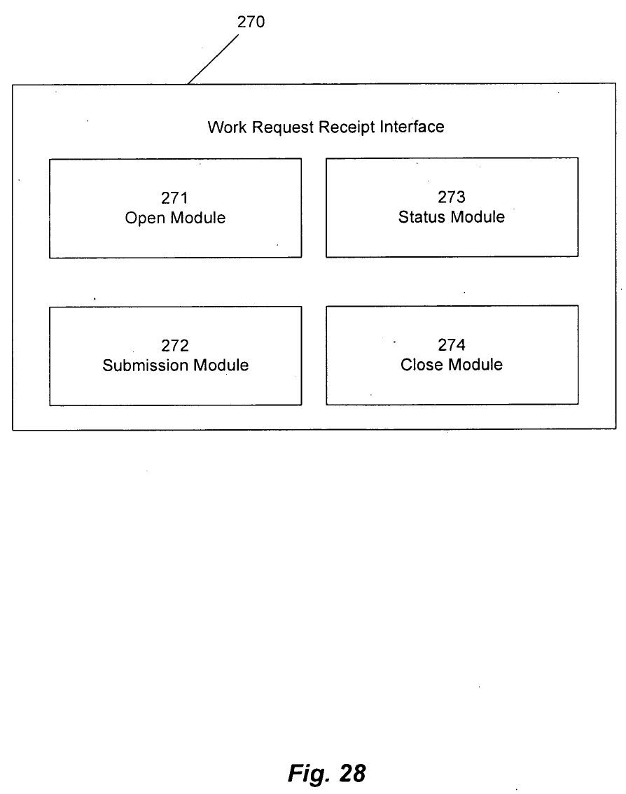

FIG. 28 illustrates a block diagram of an exemplary embodiment of a work request receipt interface. The work request receipt interface 270 may comprise a set of application programming interfaces (APIs) compiled into a web service for submitting work requests. The work request submission user interface 270 preferably enables a user within or outside of a facility to create and submit new work requests. A web based service may be available to external customers enabling them to electronically submit work requests. The work request receipt interface 270 may comprise a graphical user interface (GUI) enabling the user to interact with the work request dispatch engine 200.

The work request receipt interface 270 may be browser based such that the user does not need to download a dedicated application onto a computer. Alternatively, work request receipt interface 270 may comprise an application downloaded by the user onto their computer than is in communication with the work request dispatch engine 200 over the internet or network.

The work request receipt interface 270 may comprise an open module 271, a submission module 272, a status module 273, and a close module 274.

The open module 271 may enable a user to enter the work request receipt interface 270 to create a new work request to be completed. The open module 271 may include security features to limit user access to the work request receipt interface 270 without proper authentication. For example, the open module 271 may include a prompt for a user to enter a username and password. The open module may also require the user to submit an authentication certificate provided to the user upon registration by the administrator of the system. The work request receipt interface 270 may reject a request to establish a new work request from the open module 271 if the authentication fails or if the work request dispatch engine 200 or paging system is not running or functioning properly.

Once the connection has been established, the user may create a customized request using the submission module 272. The submission module may incorporate a work request submission user interface. The work request submission user interface may be a graphical user interface that will support the creation of new work requests. The user interface may display a facility floor plan with various pick and drop zones. The pick and drop zones may be predefined and selected by the user or may be customizable by the user.

When the user selects a pick zone, all of the possible routes to each drop zone may be illuminated and selectable. For example, an arrow may be provided from the pick zone to each drop zone to illustrate possible paths. The user may define a task by selecting a particular arrow to pick a route. The user may then associate a work request with the selected route. Once the work request has been created and designed, the submission module 272 may enable the user to submit the work request to the work request dispatch engine 200. Upon submission of the work request, the user may be provided with a work request ID assigned to the newly created work request.

The status module 273 may allow a user to track and monitor the status of a submitted work request as it is completed. The status module 273 may track the status of the work request by prompting the user to enter the work request ID assigned to the work request. The status module 273 may comprise a work request status graphical user interface that allows users to visually review the status of work requests they submitted. The status module 273 may also comprise a supervisor mode that enables an approved individual to monitor the status of all submitted work requests.

The work request status graphical user interface may display to the user a floor plan of the facility with pick and drop zones and related routes associated with work requests submitted by the user. The user may select a route by choosing an arrow from a pick zone to a drop zone. When the user selects a route, all the work requests associated with this route and their current status may be displayed to the user. The current status may include information related to the task as well as the option of canceling that task if the user no longer desires for it to be completed.

TABLE 9 provides an exemplary layout, including the field, input/output, types, and description, of parameters of the submission module 272 of the work request receipt interface 270. This table is provided as an example only and other data structures may be used if desired.

| Field | Input/Output | Type | Description |
|---|---|---|---|
| Process Type | Input | INTEGER | Encoded name of the process |
| | | | leveraging the work request |
| | | | dispatch engine. Many different |
| | | | types of services may use the |
| | | | dispatch engine. This |
| | | | classification supports multiple |
| | | | concurrent heuristic types by |
| | | | process. (ie KanBan Request vs |
| | | | Work Order Request) |
| | | | (a Mod Constant) |
| Request Type | Input | INTEGER | A request code type linked to |
| | | | the specific process type requested |
| | | | (the job code) |
| Request Text | Input | VARCHAR(255) | Dynamic text associated with request |
| | | | (text operator sees on VAC) |
| Request Start | Input | DATETIME | Date work request is scheduled |
| Datetime | | | to initiate |
| Request | Input | INTEGER | The number of minutes before |
| Expiration | | | the request should expire if not |
| Period in | | | dispatched |
| Minutes | | | |
| Submitter | Input | INTEGER | External Request ID |
| Identification | | | |
| Submitter | Input | VARCHAR(50) | Identifying text for the work |
| Identification | | | request submitter (i.e. LAC ID) |
| TimeOut | Input | INTEGER | Time out Interval in Minutes |
| | | | after job has been accepted |
| Work Request | Output | INTEGER | Unique Work Request ID |
| ID | | | assigned if work request is |
| | | | accepted |
| Status Code | Output | INTEGER | Work Request Status code |
| Status | Output | VARCHAR(255) | Work Request Status |
| Message | | | description |

TABLE 10 provides exemplary validation codes, status steps, and status messages for the validation routines and return codes of the submission module 272 of the work request receipt interface 270. This table is provided as an example only and other data structures may be used if desired.

| Status | | |
|---|---|---|
| Code | Validation Step | Status Message |
| 0 | Successful Execution | Success |
| 1 | Is Work Request Service | Work Request Service is not operational. |
| | running? | |
| 2 | Is Page Dispatch Service | Message Dispatch Service is not |
| | running? | operational. |
| 3 | Is database accessible? | Database connection is not available |
| 4 | Is this a known Process Type? | Process Type “Process Type” is |
| | | unknown. |
| 5 | Is the Request Code valid for this | Request Code “Request Code” is not |
| | process type? | valid for Process Type “Process Type”. |
| 6 | Is Web Service Login/Password | Cannot authenticate web service login |
| | valid? | |
| 7 | Duplicate Request. | Work Request already exists |
| 8 | Internal Database Error | Unable to perform Insert Operation |

TABLE 11 provides an exemplary layout, including the field, input/output, types, and description, of parameters for a submission module 272 of the work request receipt interface 270 that employs web based protocols. This table is provided as an example only and other data structures may be used if desired.

| Field | Input/Output | Type | Description |
|---|---|---|---|
| Process Type | Input | INTEGER | Encoded name of the process |
| | | | leveraging the work request |
| | | | dispatch engine. Many different |
| | | | types of services may use the |
| | | | dispatch engine. This |
| | | | classification supports multiple |
| | | | concurrent heuristic types by |
| | | | process. (ie KanBan Request vs |
| | | | Work Order Request) |
| | | | (Some Constant) |
| Request Type | Input | INTEGER | A request code type linked to |
| | | | the specific process type requested |
| | | | (decode) |
| Request Text | Input | VARCHAR(255) | Dynamic text associated with request |
| | | | (decode) |
| Request Start | Input | DATETIME | Date work request is scheduled to |
| Datetime | | | initiate |
| | | | GetTimefromDatabase( ) |
| Request | Input | INTEGER | The number of minutes before |
| Expiration | | | the request should expire if not |
| Period in | | | dispatched |
| Minutes | | | (tlookup) |
| Time to | Input | INTEGER | How much time the operator has |
| Accept Task | | | to accept the task (tlookup) |
| Submitter | Input | VARCHAR(50) | Identifying text for the work |
| Identification | | | request submitter (i.e. |
| | | | lACLogicid) |
| TimeOut | Input | INTEGER | Timeout in minutes after the job |
| | | | has been accepted. |
| Web Service | Input | VARCHAR(50) | Web service login id |
| Login | | | |
| Web Service | Input | VARCHAR(50) | Web service login password |
| Password | | | |
| Work Request | Output | INTEGER | Unique Work Request ID |
| ID | | | assigned if work request is |
| | | | accepted |
| Status Code | Output | INTEGER | Work Request Status code |
| Status | Output | VARCHAR(255) | Work Request Status |
| Message | | | description |

TABLE 12 provides exemplary validation codes, status steps, and status messages for the validation routines and return codes of the submission module 272 of the work request receipt interface 270 that employs web based protocols. This table is provided as an example only and other data structures may be used if desired.

| Status | | |
|---|---|---|
| Code | Validation Step | Status Message |
| 0 | Successful Execution | Success |
| 1 | Is Work Request Service | Work Request Service is not operational. |
| | running? | |
| 2 | Is Page Dispatch Service | Message Dispatch Service is not |
| | running? | operational. |
| 3 | Is database accessible? | Database connection is not available |
| 4 | Is this a known Process Type? | Process Type “Process Type” is |
| | | unknown. |
| 5 | Is the Request Code valid for this | Request Code “Request Code” is not |
| | process type? | valid for Process Type “Process Type”. |
| 6 | Is Web Service Login/Password | Cannot authenticate web service login |
| | valid? | |

TABLE 13 provides an exemplary layout, including the field, input/output, types, and description, of parameters a status module 273 of the work request receipt interface 270. This table is provided as an example only and other data structures may be used if desired.

| | Input/ | | |
|---|---|---|---|
| Field | Output | Type | Description |
| Submitter | Input | VARCHAR(50) | Identifying text for the work |
| Identification | | | request submitter |
| Work | Input | INTEGER | Unique Work Request ID |
| Request ID | | | assigned if work request is |
| | | | accepted |
| Status Code | Output | INTEGER | Work Request Status code |
| Status | Output | VARCHAR(255) | Work Request Status |
| Message | | | description |

TABLE 14 provides exemplary validation codes, status steps, and status messages for the validation routines and return codes of the status module 273 of a work request receipt interface 270. This table is provided as an example only and other data structures may be used if desired.

| Status Code | Validation Step | Status Message |
|---|---|---|
| 0 | Is Work Request Confirmed | Work Request has been completed |
| | Completed? | |
| 1 | Is Work Request ID passed in | Work Request ID provided is not valid |
| | valid | |
| 2 | Is work request scheduled in the | Work Request is not yet due for |
| | future? | assignment |
| 3 | Is work request pending | Work Request Is Pending Assignment. |
| | assignment? | |
| 4 | Has work request expired | Work Request has expired without |
| | without being assigned? | assignment. |
| 5 | Is work request assigned but | Work request is assigned, dispatched and |
| | awaiting acceptance? | awaiting acceptance. |
| 6 | Is Web Service Login/Password | Cannot authenticate web service login |
| | valid? | |
| 7 | Is work request assigned, | Work request is in progress. |
| | accepted and in progress | |

TABLE 15 provides an exemplary layout, including the field, input/output, types, and descriptions, of parameters for canceling a work request with the work request receipt interface 270. This table is provided as an example only and other data structures may be used if desired.

| | Input/ | | |
|---|---|---|---|
| Field | Output | Type | Description |
| Submitter | Input | VARCHAR(50) | Identifying text for the work |
| Identification | | | request submitter |
| Work | Input | INTEGER | Unique Work Request ID |
| Request ID | | | assigned if work request is |
| | | | accepted |
| Status Code | Output | INTEGER | Work Request Status code |
| Status | Output | VARCHAR(255) | Work Request Status |
| Message | | | description |

TABLE 16 provides exemplary validation codes, status steps, and status messages for the validation routines and return codes for canceling a work request with the work request receipt interface 270. This table is provided as an example only and other data structures may be used if desired.

| Status Code | Validation Step | Status Message |
|---|---|---|
| 0 | Is Work Request Confirmed | Work Request has been cancelled. |
| | Cancelled? | |
| 1 | Is Work Request ID passed in | Work Request ID provided is not valid |
| | valid? | |
| 2 | Has Work Request been | Work Request has been completed and |
| | completed? | cannot be cancelled. |
| 3 | Is Work Request in progress? | Work Request has been assigned and is in |
| | | progress and cannot be cancelled. |
| 4 | Reserved for future use | |
| 5 | Reserved for future use | |
| 6 | Is Web Service Login/Password | Cannot authenticate web service login |
| | valid? | |

TABLE 17 provides an exemplary layout, including the field, input/output, types, and descriptions, of parameters for indicating a work request as being completed with the work request receipt interface 270. This table is provided as an example only and other data structures may be used if desired.

| | Input/ | | |
|---|---|---|---|
| Field | Output | Type | Description |
| Submitter | Input | VARCHAR(50) | Identifying text for the work |
| Identification | | | request submitter |
| Work | Input | INTEGER | Unique Work Request ID |
| Request ID | | | assigned if work request is |
| | | | accepted |
| Status Code | Output | INTEGER | Work Request Status code |
| Status | Output | VARCHAR(255) | Work Request Status |
| Message | | | description |

TABLE 18 provides exemplary validation codes, status steps, and status messages for the validation routines and return codes for indicating a work request as being completed with the work request receipt interface 270. This table is provided as an example only and other data structures may be used if desired.

| Status Code | Validation Step | Status Message |
|---|---|---|
| 0 | Is Work Request Confirmed | Work Request has been completed. |
| | Completed? | |
| 1 | Is Work Request ID passed in | Work Request ID provided is not valid |
| | valid? | |
| 2 | Has Work Request been | Work Request has been completed and |
| | completed? | cannot be cancelled. |
| 3 | Is Work Request in progress? | Work Request has been assigned and is in |
| | | progress and cannot be cancelled. |
| 4 | Reserved for future use | |
| 5 | Reserved for future use | |
| 6 | Is Web Service Login/Password | Cannot authenticate web service login |
| | valid? | |

The work request assignment engine 280 may determine distribution of work requests among the assets and operators in the fleet. The work request assignment engine 280 may make this determination based upon a set of heuristics. Upon determining distribution of work requests, the work request assignment engine 280 may create dispatch entries that may be processed by the work request dispatch engine 200 such that the work requests are properly conveyed to the assigned operator and asset.

As work requests are submitted, it is preferable to determine the order in which they are dispatched, which assets and operators the work requests are dispatched to, and for how long the work requests will remain dispatched without being completed or accepted before they are reassigned. The work request assignment engine 280 may manage each of these operations. Preferably, the work request assignment engine 280 operates in conjunction with at least one of work request dispatch engine 200, a work request handler module 290, and a heuristics evaluator.

The work request assignment engine 280 may have access to real-time data of the operational status and location of each asset in the fleet. This information may be used by the work request assignment engine 280 to determine which asset is best suited to complete a particular work request. For example, an asset whose current location is closest to the pick up zone and is not currently assigned a task or not loaded may be selected over more distant assets. Similarly, an asset that is scheduled for maintenance or is malfunctioning may not be selected. Additionally, an asset whose operator is nearing the end of his shift may not be selected over other asset operators that can better accommodate the work request within their scheduled shifts. Further, work request assignment engine 280 may maintain a hierarchy of operator seniority for assigning work requests. For example, operators may select preferred types of work requests and receive those types of work requests based upon seniority.

The work request assignment engine 280 may choose a particular work request to process by employing a timer based event to poll the submitted requests. The selected work request may be evaluated by the heuristics evaluator to determine which asset and operator it should be assigned to. The work request may then be dispatched to the asset and operator using the paging system and the work request handler module 290 described below.

If the work request assignment engine 280 is not capable of finding a suitable asset and operator to assign the work request to, the work request may return to the queue with a note, or status flag, indicating that an asset could not be matched to the work request and the last time at which the work request was processed. If a match for the work request is found, the work request may be dispatched to the operator of the assigned asset by the work request handler module 290. If the operator declines the work request, the work request may be returned to the queue with a note indicating that the work request was declined by the operator along with a time stamp. Similarly, if an operator accepts a work request but fails to complete the task within a predetermined timeframe, the work request may be returned to the queue with a note indicating that the work request was not completed by the operator and a timestamp. Additionally, a message may be sent to the operator's supervisor indicating that the work request has timed out.

The work request receipt interface 270 may insert submitted work requests into a queuing table. The work request assignment engine 280 may retrieve the submitted work requests by accessing the queuing table. The work request assignment engine 280 may also manage and update the work requests in the queuing table.

Upon entering the work requests into the queuing table, certain parameters may be defined. In particular, the task expiration date, status, and request start time are preferably set when the work request is entered into the queuing table. The task expiration length is preferably defined in minutes, and is used to assess whether the task is still active or not by adding the amount of minutes set as the expiration length to the creation date and comparing to the current system time.

Each work request in the queuing table may be assigned a status identifier. There are a variety of possible status identifiers that may be employed and assigned to work requests. TABLE 19 provides a variety of exemplary status identifiers, their descriptions, associated processes, and their values.

| Status | Description | Process | Value |
|---|---|---|---|
| Not Submitted | New request that has never been | Work Req. | 0 |
| | submitted for dispatch. | Receipt | |
| Resubmit | Last dispatch was not successful | Work Req. | 1 |
| | and needs to be resubmitted. | Assignment | |
| Assigned | Dispatch entry has been | Work Req. | 2 |
| | successfully inserted into the | Assignment | |
| | tPageDispatch table. | | |
| Received | The dispatched page has been | Work Req. | 3 |
| | sent successfully, and is | Handler | |
| | available for view on the VAC. | | |
| Accepted | Dispatch entry has been accepted | Work Req. | 4 |
| | by the operator, and the | Handler | |
| | completion is pending. | | |
| *Declined | The operator has chosen not to | Work Req. | 5 |
| | do the work and presses | Handler | |
| | ‘Decline’. | | |
| *Timed Out | The operator has accepted the | Work Req. | 6 |
| | work, and has allowed the | Assignment | |
| | expected task duration to pass | | |
| | without completing the task. | | |
| *Timed Out | The dispatched page was | Work Req. | 7 |
| Unack | received, and no action was | Assignment | |
| | taken to ‘Accept’ or ‘Decline’. | | |
| *Task Expired | The request has surpassed its | Work Req. | 8 |
| | “time to life” minutes and will | Assignment | |
| | no longer be processed. | | |
| Finished | The request was completed | Work Req. | 9 |
| | properly. Using in conjunction | Assignment | |
| | with Operator/Originator | | |
| | Completed/Cancelled field to | | |
| | determine type | | |
| Operator | The task has been completed by | Work Req. | 10 |
| Completed | the operator and he/she has sent | Handler | |
| | a response of ‘Complete’. | | |
| *Operator | The operator has pressed the | Work Req. | 11 |
| Cancelled | ‘Cancel’ button from the page | Handler | |
| | after pressing ‘Accept’ | | |
| *Originator | The task has been verified by the | Work Req. | 12 |
| Completed | sender, at the LAC/GV/etc . . . | Receipt | |
| | and the request is now closed. | | |
| *Originator | A user has cancelled the work | Work Req. | 13 |
| Cancelled | request through either the | Receipt | |
| | LAC/Graphical Viewer/etc . . . | | |
| *Originator | The Cancelled message has been | Work Req. | 14 |
| Cancelled | received by the VAC operator, | Handler | |
| Completed | and he has responded “Ok”. | | |

Work requests having any of the status identifiers preceded by an asterisk are preferably moved from the regular active work request queuing table to a completed work request table.

The priority that each work request is given regarding when it should be evaluated and assigned may be determined by the work request start date assigned to each work request. If the requested start date of the work request is older than the current system time, then the work request is preferably entitled to be processed and evaluated. The older the request start date, the higher priority level is assigned to the work request.

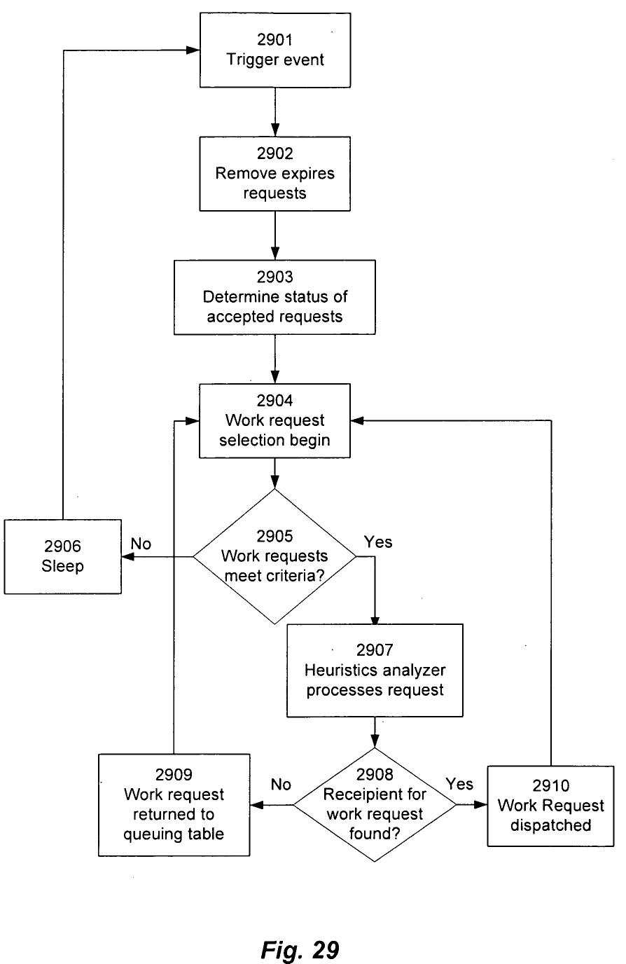

The management and updating of the queuing table is preferably conducted by the work request assignment engine 280. FIG. 29 is a flow diagram illustrating the assignment and queuing table management process of the work request assignment engine 280 in accordance with an exemplary embodiment of the present invention.

At 2901 a trigger event may cause the work request assignment engine 280 to enter the assignment loop. The trigger event may be an automatic timer or an external event such as the receipt of a new work request, cancellation or a work request, completion of a work request, etc. The trigger event could also be a manual operation initiated by a user.

At 2902 any expired requests are preferably removed from the queuing table and placed in a completed work request table. The status of expired work request is preferably changed to “Expired.”

At 2903 work requests that have been accepted may be reviewed to determine how long their status has been set to “accepted.” The date and time at which the task was accepted is compared to current system time to determine whether it exceeds the overall time assigned for the completion of the task before expiration. If the time since acceptance exceeds the expiration time assigned for the task, the assigned work request may be determined to have timed out. Work requests deemed to have timed out may be copied to the work request completed table and their status changed to “timed out.” The work request may also remain in the queuing table and its status updated to “resubmit,” indicating that the work request should be assigned to a different operator. The work request may have its next evaluation date set to the current time.

A message may be sent to the operator indicating that the work request has been cancelled and to cease work on the task. In a contemplated embodiment, the operator may be given the option of responding to the message by stating that the work request is currently being processed and near completion. The status of the work request may then be reset to “accepted” and the operator given additional time to complete the work request.

Additionally, at 2903, work requests cancelled by the operator or the originator of the work request may be processed. Such cancelled work requests may be copied to the work requests completed table and their status set to “user cancelled.” Further, the status field of such requests in the work request queuing table may be updated to “resubmit.” The work requests next evaluation date in the queuing table may be set to the current time.

At 2904, a work request may be selected for processing and assignment from the queuing table by the work request assignment engine 280. The next work request to be processed may be selected based upon the evaluation dates and status of the pending work requests. Any work request having a evaluation date that is prior to the current system time is eligible for processing. The work request with the oldest evaluation date is preferably given priority and selected for processing. If two work requests have the same evaluation dates, then the work request may be selected based upon its status. For example, a work request with a “resubmit” status may be given priority over a work request having a “not submitted” status.

At 2905, the work request assignment engine 280 determines whether any of the work requests meet the criteria for selection. If no work request has an evaluation date before the current system time, then at 2906 the work request assignment engine 280 goes to sleep for a predetermined amount of time. The expiration of the sleep time or the awakening of the work request assignment engine 280 may be a trigger event for restarting the process at 2901.

Once a work request is selected, at 2907 the heuristics analyzer may process the request to determine the most fit asset and operator to assign the request to. Factors that may be considered in selecting an asset may include but are not limited to, asset location, type of vehicle needed to complete the task, whether the driver is currently assigned to a task, whether the driver has previously been assigned to the task, or operational status of the asset.

If at 2908 a recipient for the task cannot be found, the work request may be returned to the queuing table at 2909 with an evaluation date set to the current system time and its status set to “Resubmit.” If a recipient is successfully identified at 2908, then the status of the work request in the queuing table may be changed to “assigned” at 2910 and the work request can be dispatched by the work request handler module 290. Upon dispatching the assigned work request at 2910, the work request assignment engine 280 can return to 2904 to determine the next work request to process.

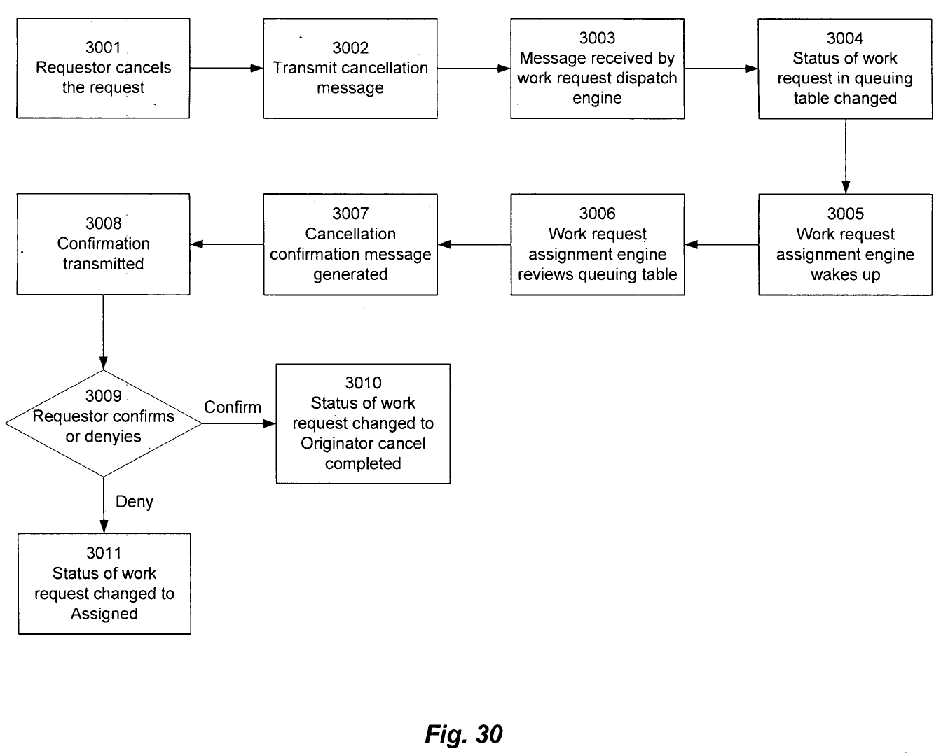

The work request assignment engine 280 may also process cancellations of work requests and update the status of the work requests in the queuing table. FIG. 30 is a flow diagram illustrating the cancellation process administered by the work request assignment engine 280 in accordance with an exemplary embodiment of the present invention. At 3001, the requestor may cancel a work request. The requestor may be internal or external and may employ the work request receipt interface 270 to cancel a submitted work request. Similarly, in industrial settings the requester may cancel the work request using a LAC.

At 3002, a message is transmitted containing information that the operator or requester has cancelled a particular request. In the case of the cancellation coming from a LAC, the message may be sent to a gateway or wireless asset manager for retransmission. At 3003, the cancellation request may be received by the work request dispatch engine 200. At 3004 the status of the work request in the queuing table may be changed to “originator cancelled.” At 3005, the work request assignment engine 280 wakes up after sleeping for a predetermined period of time.

At 3006, the work request assignment engine 280 preferably sorts through the work request queuing table and selects work requests with a status of “originator cancelled.” At 3006 the work request assignment engine 280 may generate a confirmation message for transmission to the originator of the work request to confirm cancellation. At 3007, the status of the work request in the work request completed table is updated to “originator canceled pending.”

At 3008, the work request handler module 290 may transmit a message to the originator asking for confirmation that the work request is to be canceled. At 3009, the originator may either confirm the request to cancel or deny the cancellation request. If the originator confirms the cancellation request, at 3010 the status of the work request may be changed to “originator cancelled completed” and the work request may be moved to the work requests completed table. If the originator denies the cancellation of the work request, at 3011 the work request status may be changed to assigned, and the task may remain assigned to the asset and operator that it was previously assigned to.

The work request assignment engine 280 may also include a work request heuristics evaluator to determine the best operator/vehicle entity for a given work request. To determine the best operator/vehicle entity, the work request heuristics evaluator may process the parameters of the work request to extract data necessary for finding the best mobile asset/vehicle to complete the task. For example, the work request heuristics evaluator may extract the process type, request code, submitter identification, etc. from the work request queuing table using a work request ID assigned to the work request.

The work request heuristics evaluator may access a list of currently operational assets and analyze the parameters related to the assets to determine which is best suited for the work request. The parameters of the asset/operator may include, but are not limited to, whether the operator and asset are currently active, operational status of the vehicle, type of vehicle, tasks currently assigned to the vehicle, duration of operation of the asset/operator, asset and operator location, etc. For example, if the work request parameters indicate the task requires a forklift, the work request heuristics evaluator can preferably consider only assets that are identified as forklifts.

Further, the work request heuristics evaluator may consider the current locations of available assets to determine which is closest to the pick-up zone, and hence may begin the task soonest. Similarly, the work request heuristics evaluator may analyze the drop zone of the last task assigned to each available asset to determined which asset will be closet to the pick-up zone of the current task at the completion of their work load to reduce unnecessary travel. The asset/operator parameters may be gathered and made available to the work request heuristics evaluator in real time by leveraging the wireless system described above.

The work request heuristics evaluator may also query the work requests completed table to determine whether the current work request has been previously assigned to any of the available operators. For example, if an operator has previously been assigned a particular task and canceled the work request or allowed it to expire, then the work request heuristics evaluator preferably will avoid assigning the work request again to that operator.

Similarly, the work request heuristics evaluator may query the work request queuing table to determine the number of tasks already assigned to available operators. For example, if an operator already has a large number of assigned tasks, the work request heuristics evaluator may avoid assigning an additional task to that operator if other operators with lighter work loads are available.

The work request handler module 290 may transmit work requests processed by the work request assignment engine 280 and convey them to the operator of the asset to which the work request is assigned via a VAC. The paging architecture described above may be employed for transmitting the messages. The paging system enables the work request handler module 290 to send and receive formatted messages between the operator and the work request dispatch engine 200.

An initial message sent to the operator by the work request handler module 290 may request the operator to accept or decline the work assignment using prompts on the VAC. If an operator accepts a work request, then the work request is preferably assigned that operator, and the VAC may display a prompt to cancel the work request or to indicate that the work request has been completed. If the operator declines a work request, then the work request is preferably reissued to the work request assignment engine 280. Similarly, if an operator accepts a work request and later cancels it, the work request is reissued to and processed by the work request assignment engine 280.

A barcode or RFID reader may also be coupled to the VAC. The reader may scan barcodes or RFID tags affixed to objects. The VAC may determine whether a work request has been accepted or update the status of a work request based upon scans from the barcode reader. For example, if an operator fails to indicate that he accepts a work request, but the barcode reader scans an object related to the work request as it is loaded onto the mobile asset/vehicle, the VAC may determine that the work request has been accepted and send a corresponding message to the work request handler module 290. Similarly, if a task is accepted and the barcode reader scans an object related to the work request as it is loaded onto the mobile asset/vehicle, the VAC may send a message to the work request handler module 290 updating the status of the work request to indicate that the work request is in progress. Further, the VAC may determine that a work request has been completed based upon a reading from the bar code scanner that an item has been unloaded.

All work requests preferably have an expiration time length indicating the amount of time that the operator is allowed to complete the task. If the work request assignment engine 280 does not receive a notification from the operator that the task has been completed before the expiration time length is exceeded, the work request may be “timed out.” Timed out work requests may be processed by the work request assignment engine 280 and the status of the work request may be changed to “resubmit.” A message may be sent by the work request assignment engine 280 via work request handler module 290 to the operator's VAC that the work request has timed out. The operator may be given a prompt to indicate that the work request is in progress and/or near completion. The work request assignment engine 280 may respond by reassigning the task to the operator and providing additional time for completion.

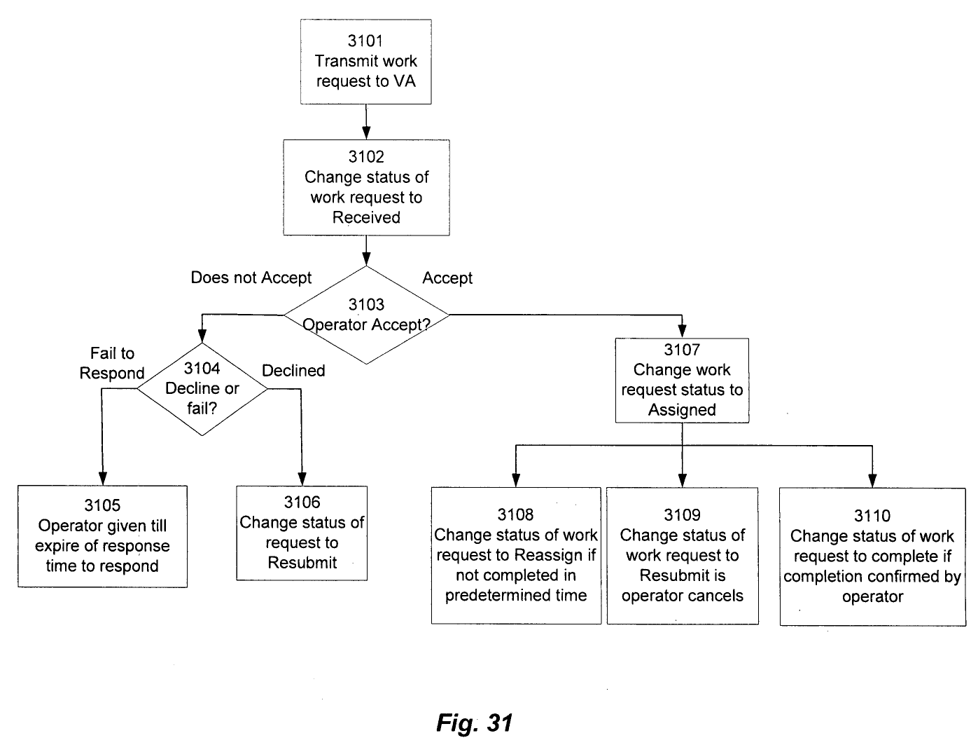

FIG. 31 is a flow diagram illustrating the operation of the work request handler module 290 in accordance with an exemplary embodiment of the present invention. At 3101, the work request handler module 290 may transmit a work request to the VAC of an assigned asset. At 3102, after the message is transmitted, the status of the work request in the queuing table may be updated to “received.” At 3103, the operator may be notified via the VAC that a new work request has been assigned to him and may be prompted to either accept or decline the task.

If at 3103 the operator does not accept the work request, at 3104 it may be determined whether the operator declined the task or simply has not yet responded to the prompt. If the operator has not declined the task and the time for responding to the prompt has not expired, at 3105 the operator may be given until expiry of the response time to make a selection. If the time for response time has expired, the status of the work request may be changed to “reassign” and the work request assignment engine 280 may search for another suitable operator. If the operator declines the task, at 3106 the status of the work request in the queuing table may be changed to “Resubmit.” If at 3103 the operator accepts the work request, at 3107 the status of the work request may be changed to “Accepted.”

If after accepting the task at 3107, the operator fails to complete the task within a predetermined amount of time, at 3108 the operator may be notified that the time has expired, and the status of the work request may be changed by the work request assignment engine 280 to “Reassign.” If after accepting the task at 3107 the operator cancels the work request, at 3109 the operator may be prompted to confirm cancellation and the work request status may be changed by work request assignment engine 280 to “Resubmit” upon confirmation. If after accepting the task at 3107 the operator indicates that the work request is complete, at 3110 the operator may be prompted to confirm completion and the work request status may be changed by work request assignment engine 280 to “complete” upon confirmation.

The work request assignment engine 280 is preferably tasked with populating a work request dispatch table of outbound messages containing work request assignments for the work request handler module 290 to convey to the assigned assets and operators. The work request handler module 290 preferably employs the paging architecture of the wireless asset network to communicate the work request assignments to the vehicle asset communicators coupled to each asset.

Two parameters provided in the work request dispatch table may be the source type and the source name. The source type and the source name may be used to define the originator of the outgoing work request assignment or message. These two parameters are preferably uniquely populated by the work request assignment engine 280 to account for different types of pages and work request assignment messages.

When the work request assignment engine 280 inserts an outbound message into the work request dispatch table, it preferably retrieves or creates a primary key value. The primary key value, which may comprise a page creation date and a page transaction code, may be stored in the work request dispatch table.

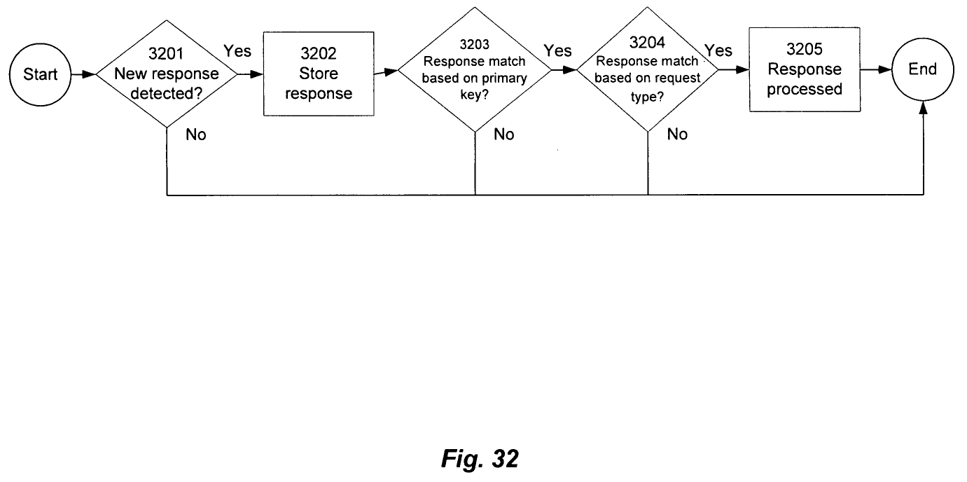

The process of identifying and matching incoming responses to pages may be based upon identifying page source type data and retrieving primary key data. FIG. 32 illustrates a flow diagram of a process for identifying work request handler module 290 responses. At 3201, the work request handler module 290 may enter a mode to detect new responses. If a new response is not detected, the process may end. If a new response is detected at 3201, the response may be stored in a page response table at 3202.

At 3203, the work request handler module 290 may analyze the stored response to determine whether the response matches the page dispatch table based on the primary key value. If at 3203 the work request handler module 290 determines that the response does not match any entries in the page dispatch table based on the primary key value, the process may end. If are 3203 the work request handler module 290 matches the stored response to one or more entries based on primary key value, then at 3204 the work request handler module 290 may be determine whether the response matches table entries based upon work request type.

If at 3204 the work request handler module 290 determine that the response does not match the entries based upon work request type, the process may end. If at 3204 the work request handler module 290 determines that the response matches the entries based upon the work request type, then at 3205 the response may be processed by the work request handler module 290.

The work request receipt interface 270 is preferably tasked with populating the work request queuing table. The work request queuing table may be processed and evaluated by the work request assignment engine 280 to order and stage work requests in conjunction with the work request handler module 290 via the wireless paging architecture. Within the queuing table, the status field of the work request may dictate how the work request assignment engine 280 will process and handle the work request. A set of available status values and/or identifiers may serve an internal loop-up constant to depict possible pending processing actions. As the responses to the work requests are evaluated and processed by the work request handler module 290 as described above, their status in the queuing table may be updated as necessary.

The specific changes to the status of the work requests may depend upon the operators reply via the vehicle asset communicator. For example, the operator may be given the option to indicate that he/she accepts, declines, cancels, and completes an assigned work request.

Additionally, the changes to the status of the work request in the queuing table may be based upon the operator accepting a work request and failing to follow-up with an indication that the work request has been completed or is canceled. This special case of the operator failing to follow-up may be identified by examining a statistical record. The statistical record may include a summary of the responses for given work request pages sent to an operator. The record may include time-stamped responses to the work request pages. If the only response to a work request is an acceptance, the date and time the acceptance may be examined to determine whether a predetermined time to complete the task has expired. If the amount of time to complete the task has expired, the work request may be determined to have timed out. A notification may be sent to the operator asking for the operator to cancel or complete the task, or a message may be sent to notify the operator that the work request has been canceled and will be reassigned.

When a work request is finished and the operator confirms completion, the work request may be moved to the work request completed table. The work request completed table may include other conditions that mark the end of a particular assignment of a work request. For example, the work request completed table may include, but is not limited to, work requests declined by the operator and marked for reassignment, cancelled by the operator and marked for reassignment, and accepted work requests that have timed-out. Work requests in the work request completed table may also be listed in the work request queuing table for reassignment and/or further processing.

The work request dispatch engine 200 may track, maintain, and compile the start and stop times of work requests. The work request dispatch engine 200 may sort the times based upon the task type. The work request dispatch engine 200 may maintain the times for completing tasks for each operator. This data may be analyzed by the work request dispatch engine to determine standard or average times for completing various types of task and for ranking and evaluating operator efficiency. Standardized task times may be used by the work request assignment engine 280 to determine which mobile asset/vehicle or operator to assign a work request to.

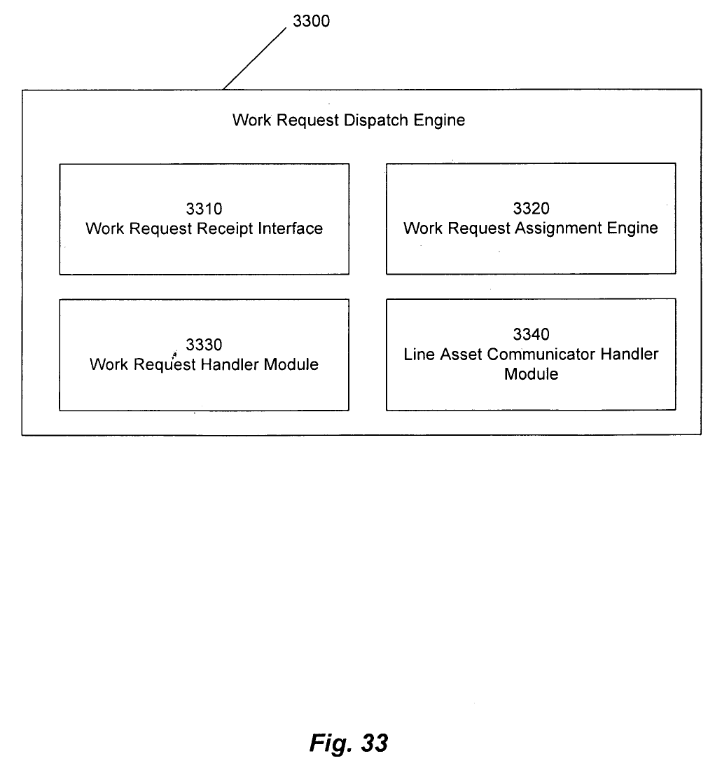

FIG. 33 illustrates an exemplary embodiment of a work request dispatch engine 3300. In accordance with an exemplary embodiment, the work request dispatch engine 3300 may comprise a work request receipt interface 3310, a work request assignment engine 3320, a work request handler module 3330, and a line asset communicator handler module (LAC handler module) 3340. The work request receipt interface 3310, a work request assignment engine 3320, and a work request handler module 3330 are preferably substantially similar to the work request receipt interface 270, work request assignment engine 280, and work request handler module 290.

The LAC handler module 3340 may be a part of the work request dispatch engine 3300 and may be stored on the same processor or computing system as the work request dispatch engine 3300. The LAC handler module 3340 may be in direct communication with the work request receipt interface 3310, a work request assignment engine 3320, and work request handler module 3330, or may communicate with these elements indirectly via the work request dispatch engine 3330. Additionally, the LAC handler module 3340 may communicate with various elements indirectly by passing communications through other LAC handler modules or a VAC. For example, the LAC handler module 3340 may transmit a message to work request dispatch engine 3300, which may relay the message to the work request assignment engine 3320. For the sake of simplicity, communications from the LAC handler module 3340 are described below as being of the indirect form through the work request dispatch engine 3300. All of the processes and functionalities described below, however, may include embodiments wherein the LAC handle module 3340 communicates directly with the work request receipt interface 3310, a work request assignment engine 3320, a work request handler module 3330, or other elements.

The LAC handler module 3340 may receive and process work request messages from a line asset communicator (LAC). A LAC may be substantially structurally similar to a VAC as described above. A LAC may be mounted in a fixed position within a facility. For example, the LAC may be mounted at or near an assembly line or work station in a manufacturing facility. In other contemplated embodiments, a LAC may be mounted at or near a location at which workers perform tasks. The LAC may comprise an interface enabling a user to submit work requests. For example, if a user at a work station is running low on parts needed in a manufacturing process, the user may request additional part using the LAC interface. Preferably, the user may also track the status of the request using the LAC.

A barcode, proximity or RFID reader may be coupled to the LAC. The reader may assist a user in generating work requests and checking the status of work requests. For example, rather than selecting a part type, the user may scan a barcode, tag, card or fob on a bin containing the parts, or otherwise associated with a part or parts, to indicate that more of this type of part is necessary. Similarly, after the work request is submitted, the user may scan the code again to view via the LAC the status of work requests related to that part.

The LAC handler module 3340 may also receive work request messages from controller coupled to a work machine within a facility. For example, a machine in an assembly line may be tasked with adding a component to a product in a manufacturing process. If the controller of the machine determines that that the quantity of the component is diminishing, it may generate and transmit a work request to the work request dispatch engine 3300 to replenish that component. Similarly, a work request may be generated via a VAC in substantially the same manner as using a LAC.

The LAC handler module 3340 serves as an interface between the LAC and the work request dispatch engine 3300. The LAC handler module 3340 may perform the following functions: 1) parsing and decoding messages from the LAC to obtain a work request; 2) maintaining a communication history between a LAC and a gateway or wireless asset manager; 3) submitting a work request to the work request dispatch engine; and 4) manage a LAC pending work request table.

Messages from the LAC may comprise parameters including, but not limited to, message type and job code. The message type may include, but is not limited to, the following types: a new work request, an originator complete work request, and a cancelled work request. A message identified as a new work request type message may be a message representing a new work request entered by a user at a LAC. For example, it may be a work request to supply one or more parts from a warehouse location to the user submitting the message. A message identified as a originator complete work request type message may be a message from the LAC indicating that a previously submitted work request has been completed. For example, it may be a message from a user that a requested part has been successfully delivered and received. A message identified as a cancelled work request type message may indicate that a user is cancelling a previously submitted and pending work request. For example, it may be a message from a user that a part that the user previously ordered is no longer in demand and that the user wishes to cancel the work request. The LAC handler module 3340 processes each incoming message from a LAC to determine the message type.

The job code parameter embedded in each message may relate to a checklist response. Alternatively, the job code parameter may relate to alternative job or task identifiers. The job code parameter may comprise the job name and description. The LAC handler module 3340 may validate the job code in an incoming message by comparing the job code parameter of the message to a job code table comprising job names and descriptions.

A LAC may communicate wirelessly with the LAC handler module 3340 and work request dispatch engine 3330 via a gateway or wireless asset manager. Because the LAC may have a fixed location, it may communicate with the LAC handler module 3340 through a dedicated gateway or wireless asset manager. The LAC, however, may be capable of communicating with the LAC handler module 3340 through other gateways or wireless asset managers within range if the dedicated gateway or wireless asset manager is unavailable. The LAC handler module 3340 may maintain a list of current and historic gateway or wireless asset manager identifier values. The gateway or wireless asset manager identifier values may represent gateways or wireless asset managers known to have successfully communicated with the LAC. Maintaining a list of gateway or wireless asset manager identifiers may ensure proper communication between the LAC handler module 3340 and the LAC.

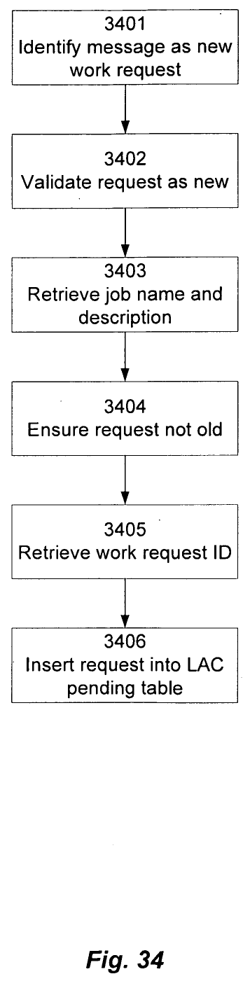

Upon receiving, parsing, and decoding a message from a LAC, the LAC handler module 3340 may submit the work request to the work dispatch engine 3300. The process of parsing, decoding, and submitting may vary depending upon the message type. FIG. 34 illustrates a flowchart of an exemplary embodiment of a process for submitting a new job request from a LAC. At 3401, the LAC handler module 3401 may identify an incoming message from a LAC as a new job request from the message type parameter. At 3402, the LAC handler module 3340 may validate whether the message relates to a new work request or a repeat of a previous work request. At 3403, the LAC handler module 3340 may retrieve the job name and description from the job code in the message.

Before submitting the work request to the work request dispatch engine 3300, at 3404 the LAC handler module 3340 may ensure the work request is indeed new based upon unique key data. Upon submitting the work request to the work request dispatch engine 3300, at 3405 the LAC handler module 3340 may retrieve a work request ID from the work request dispatch engine 3300 for later identifying and tracking the status of the work request. After submitting the work request to the work request dispatch engine 3300, at 3406 the LAC handler module 3340 may insert the work request into the LAC pending work request table.

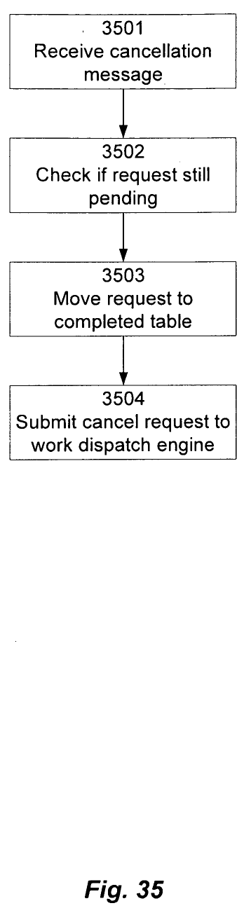

After a work request has been submitted to the work request dispatch engine 3300, it may be cancelled by the originator or completed. The LAC handler module 3340 may receive a message identifying either condition and update the status of the work request with the work dispatch engine 3300. FIG. 35 illustrates a flowchart of an exemplary embodiment of a process for canceling a work request submitted by a LAC. At 3501, the LAC handler module 3340 may receive a cancellation message sent by the originator via the LAC. After receiving the message, at 3502 the LAC handler module 3340 may determine whether the status of the work request is still pending. If the work request is still pending, at 3503, the LAC handler module 3340 may move the request from a LAC pending work request table to a LAC completed work request table. At 3504, the LAC handler module can submit a message to the work request dispatch engine 3300 to cancel the work request. The process of canceling the work request by the work request dispatch engine 3300 may be substantially similar to the work request cancellation process discussed above.

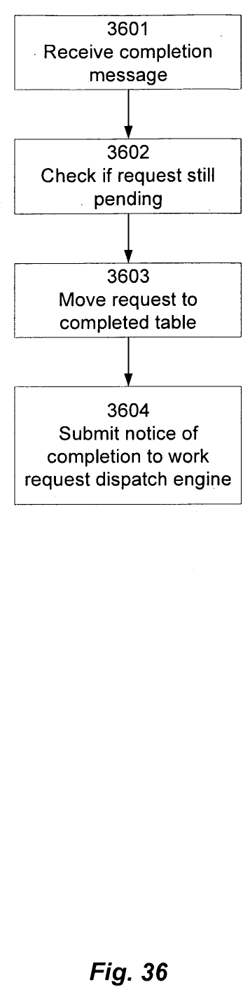

The LAC handler module 3340 may receive a message from an originator of a request that the job is complete. The process for handling such a message may be analogous to the cancellation process. FIG. 36 illustrates a flowchart of an exemplary embodiment of a process for completed work requests submitted by a LAC. At 3601, the LAC handler module 3340 may receive a completion message sent by the originator via the LAC indicating that a requested job has been completed. After receiving the message, at 3602 the LAC handler module 3340 may determine whether the status of the work request is still pending. If the work request is still pending, at 3603, the LAC handler module 3340 may move the request from the LAC pending work request table to the LAC completed work request table listing completed or canceled work requests. At 3604, the LAC handler module 3340 may submit a message to the work request dispatch engine 3300 that the work request has been completed.

The LAC handler module 3340 may manage the LAC pending work request table listing the status of work requests submitted by a LAC. The LAC pending work request table may contain work requests having a status other than completed or canceled. The pending work request table may be separate from a work request queue in the work request dispatch engine 3300. The LAC handler module 3340 may periodically process the LAC pending work request table and update the status of the pending work requests by querying the status of those requests in the work request queue maintained by the work request dispatch engine 3300. The work request queue in the work request dispatch engine may contain information not available to the LAC handler module 3340, such as work request cancellations and completions submitted by operators that a work request is assigned to.

The status of a work request in the pending work request table may be available to a user submitting the working request via the LAC. The display and interface of the LAC may allow a user to view a real-time status of a work request the user submitted by means of the LAC handler module 3340.

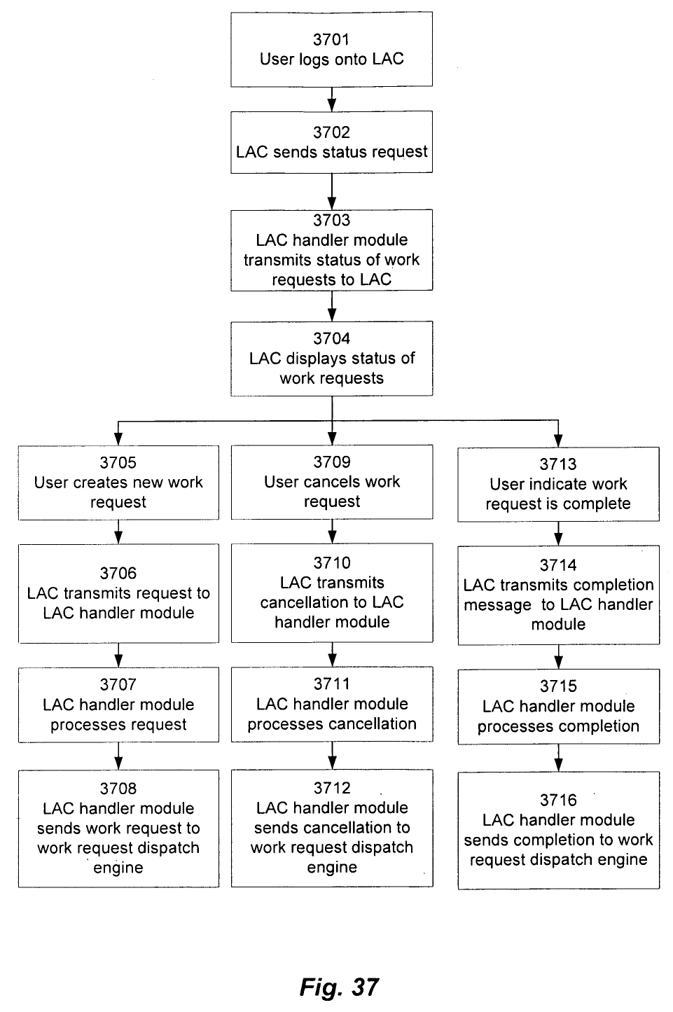

FIG. 37 illustrates a flowchart of an exemplary embodiment of an interaction process between a LAC and a LAC handler module 3340. At 3701, a user may log onto a LAC. The log on process may require the user to enter a PIN, scan a card or badge, or simply wake the LAC from sleep mode. After a user logs on, at 3702 the LAC may transmit a request to the LAC handler module 3340 for an updated status of pending work requests. The LAC may request the status of work requests submitted from that LAC, submitted by the user who is currently logged on to the LAC, or all pending work requests. At 3703, the LAC handler module 3340 may transmit to the LAC the updated status of the pending work requests. The LAC handler module 3340 may maintain a LAC pending work request table as described above.

After receiving the updated status of the pending work requests from the LAC handler module 3340, at 3704 the LAC may display a list of the pending work requests and their current status for the user to review. The list may be substantially longer than can be displayed on the screen at once. The LAC may have buttons allowing the user to scroll up or down through the list and select certain work requests. Additionally, the LAC may comprise LED's to indicate the status of each task.

At 3705, a user may create a new work request using the interface of the LAC. The LAC display may comprise menus and lists of work requests for the user to select the type of work request and work request parameters such as quantities of items requested, a desired completion date/time, priority of work request, delivery destination, or other information related to the work request. The LAC interface may also comprise a keypad or keyboard allowing the user to enter codes, acronyms, or type information related to the work request.

After a user enters the necessary information to create a new work request, at 3706 the LAC may transmit the work request to the LAC handler module 3340. The LAC may transmit the work request wirelessly via a gateway or wireless asset manager as described above. In other embodiments, the LAC may comprise a wired connection to the LAC handler module 3340.

Upon receipt of the work request, at 3707 the LAC handler module 3340 may process the work request. Processing the work request by the LAC handler module 3340 may comprise parsing and decoding the work request to determine the work request type and job code, as described above. The LAC handler module 3340 may enter the work request into a LAC pending work request table maintained by the module 3340. The LAC handler module 3340 may update the status of work request as received and enter other information decoded from the work request message into the table.

After processing the new work request and updating the pending work request table, at 3708, the LAC handler module 3340 may submit the work request to the work request dispatch engine 3300. The LAC handler module 3340 may submit the work request to the work request receipt interface 3310 or directly to the work request assignment engine 3320. The work request assignment engine 3320 may enter the work request into the work request queue where it will remain until it is assigned to an operator as described above. The work request assignment engine 3340 may treat work requests from a LAC as having the same priority as those submitted by other users through the work request receipt interface 3310, and assign tasks to operators based upon their submission date.

In other embodiments, the work request assignment engine 3320 may prioritize work requests based upon a priority level assigned by the user or give preference to work requests submitted by a LAC. In assigning work requests, the work request assignment engine 3320 may also factor the position of a LAC in a manufacturing hierarchy. For example, if a LAC is assigned to a work station responsible for the first stages a manufacturing process, the work request engine may prioritize requests from that LAC over a LAC at a work station responsible for later stages of the process to maximize production efficiency and minimize delays caused by pending work requests.

The LAC may also allow a user to cancel a previously submitted work request. At 3709, a user may decide to cancel a work request. The user may choose a work request from a list of pending work requests displayed on the LAC. The list of pending requests may be downloaded and updated from the LAC pending work request table maintained by the LAC handler module 3340 as described above. After choosing the desired work request, the user may select to cancel the work request. At 3710, the LAC may transmit the cancellation to the LAC handler module 3340 in a manner as described above.

At 3711, the LAC handler module 3340 may process the cancellation message to determine to which pending work request it applies. If the cancellation message is directed to a pending work request, the LAC handler module 3340 may move the work request from the LAC pending work request table to the LAC completed work request table. The LAC handler module 3340 may send a confirmation message to the LAC prompting the user to confirm that the cancellation message was correctly sent prior to removing the work request from the LAC pending work request table.

After processing the cancellation message, at 3712 the LAC handler module 3340 may transmit the cancellation message to the work request dispatch engine 3340, which may redirect the message to the work request assignment engine 3320. The work request assignment engine 3320 may change the status of the canceled work request to Originator Canceled. The work request assignment engine 3320 may also forward a cancellation message to the work request handler module 3330, which may transmit the message to the VAC of the mobile asset/vehicle that the work request is assigned to in order to notify the operator that the work request has been canceled.

The LAC handler module 3340 may also update the LAC pending work request table as certain work requests are completed. At 3713, the user may select a work request that has been completed from a list of pending requests displayed by the LAC. After selecting the work request, the user may indicate that the work request has been completed. For example, the user may have received the parts he/she ordered and can use the LAC to notify the LAC handler module 3340 that the work request is now complete.

At 3714, the LAC may transmit the completion message to the LAC handler module 3340. Upon receiving the completion message from the LAC, at 3715, the LAC handler module 3340 may process the message to determine which work request it applies to. The LAC handler module 3340 may move the completed work request from the LAC pending work request table to the LAC completed work request table. The LAC handler module 3340 may send a confirmation message to the LAC prompting the user to confirm that the work request has been completed.

After processing the completion message, at 3716 the LAC handler module 3340 may transmit the message to the work request dispatch engine 3300, which may redirect the message to the work request assignment engine 3320. Alternatively, as described above, the LAC handler module 3340 may transmit the completion message directly to the work request assignment engine 3320. The work request assignment engine 3320 may process the completion message and change the status of the work request to the Completed. The status of the work request may already be Completed because the operator assigned to the work request may have send a message via the VAC to the work request assignment engine 3320 that the request is complete.

If the status of the work request has not already changed to the Completed, the work request dispatch engine may send confirmation messages to both the operator and the user to confirm that the work request has been completed. The confirmation message may be sent to the operator via the work request handler module 3330, which may transmit the message to the operator's VAC. The confirmation message may be sent to the user via the LAC handler module 3340, which may send the message to the user's LAC. If both the user and operator confirm that the request has been completed, the work request assignment engine 3320 may change the status of the work request to Completed. If both the user and the operator indicate the work request is not complete, the work request assignment engine 3320 may maintain the current status of the work request. If either the user or the operator indicate that the work request is not complete, the work request assignment engine 3320 may notify a system supervisor of the discrepancy.

Job Code Selection

In addition to the above described features and functionalities, the VAC may require an operator to select a job code for the particular work request or task that the operator is currently performing. The VAC interface may include a menu of possible job codes for the user to select. The available job codes may be preselected based upon the type of vehicle that the VAC is associated with. For example, specific codes may be present in a VAC coupled to a forklift that are not included in a VAC coupled to other vehicles, and vice-a-versa.

The VAC may include certain job codes for pallet rider jobs. TABLE 20 provides an exemplary list of pallet rider jobs and corresponding job codes.

| Pallet Rider Job | Job Code |
|---|---|
| Receiving | PRRCV1 |
| Shipping | PRSHP1 |
| Office | PROFF1 |
| Fixed | PRFIX1 |

The VAC may include certain job codes for sit down rider jobs. TABLE 21 provides an exemplary list of sit down rider jobs and corresponding job codes.

| Sit Down Rider Job | Job Code |
|---|---|
| Replenishment | SDRPL1 |
| Paint | SDPNT1 |

The jobs and job codes in the TABLES 20 and 21 are exemplary. Various types of job codes may be employed depending on the job type.

Upon logging onto the VAC, the user may be prompted to select a job code. The VAC may display a message that a job code must be entered and display a list of job codes upon confirmation from the operator that he has read the message. The VAC may prevent the operator from proceeding to other features of the VAC before selecting a job code. Alternatively, the VAC may allow the user to access other features of the VAC before selecting a job code.

Upon selecting a job code, the user may be prompted to complete a checklist. The checklist may be specific to the vehicle and/or job code. This checklist may be separate from the vehicle safety checklist. The operator may be required to complete the checklist once per shift or each time the operator selects that job code.

The operator may access the job code menu and select different job codes throughout the shift. The data monitored by the VAC may be correlated to the particular job code for later statistical analysis. For example, breaks, stops, motion, idle, lifts, moving with loads, and other operational parameters of the mobile asset/vehicle monitored by the VAC may be associated with the currently selected job code.

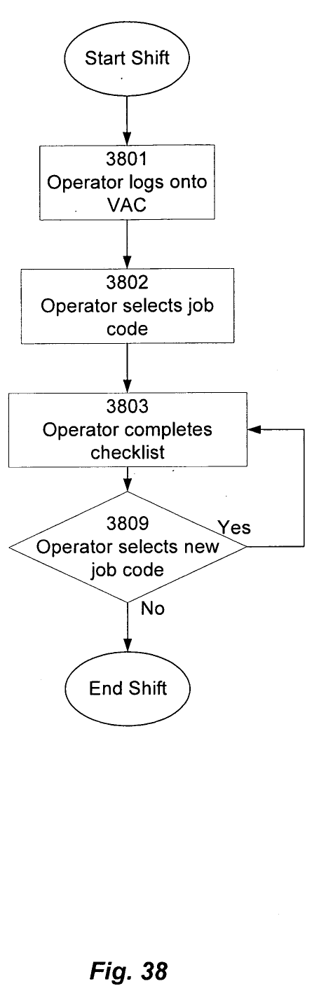

FIG. 38 is a flowchart of an exemplary embodiment of a job code selection process. At beginning of a shift, at 3801 an operator may log onto a VAC. The log on process may require the operator to enter a PIN using the VAC's keypad, scan a card or badge, or simply wake the VAC from sleep mode.

Upon logging onto the VAC, at 3802 the operator may be prompted to select a job code from a menu of available job codes as described above. After selecting the appropriate job code, at 3803 the operator may be required to complete a checklist relating to the job code and/or the vehicle type. After completing the checklist, the operator may commence with the shift and perform the task or job. During operation of the mobile asset/vehicle, the VAC may monitor various operational parameters of the mobile asset/vehicle. These parameters may be stored and associated with the currently selected job code.

At 3809, if the operator completes a task and selects a different job code during his shift, the operator may be required to complete a different checklist related to the newer job code. If a different job code is selected, all parameters of the mobile asset/vehicle monitored by the VAC after the second job code is selected may be stored and associated with the second job code. If the operator does not select a different job code at 3809, the operator may complete his/her shift without executing further checklists.

Therefore, while embodiments of this invention have been described in detail with particular reference to exemplary embodiments, those skilled in the art will understand that variations and modifications can be effected within the scope of the invention as defined in the appended claims. Accordingly, the scope of various embodiments of the present invention should not be limited to the above discussed embodiments, and should only be defined by the following claims and all equivalents.

1. A system for managing a mobile asset/vehicle fleet, the system comprising:
a first vehicle asset communicator adapted to couple to a first mobile asset/vehicle and monitor operational parameters of the first mobile asset/vehicle;
a second vehicle asset communicator adapted to couple to a second mobile asset/vehicle and monitor operational parameters of the second mobile asset/vehicle;
a first controller having a wireless transceiver, the first controller capable of communication with the first vehicle asset communicator and the second vehicle asset communicator, the first controller comprising a logic element configured to:
receive a work request to be performed by a mobile asset/vehicle;
determine whether to assign the work request to the first mobile asset/vehicle or the second mobile asset/vehicle based at least in part upon the operational parameters of the first mobile asset/vehicle and the operational parameters of the second mobile asset/vehicle; and
transmit the work request to the first vehicle asset communicator if the first mobile asset/vehicle is selected to perform the work request.

2. The system of claim 1, the logic element being further configured to:
manage a queue of work requests; and
determine which work request in the queue to next assign to a mobile asset/vehicle.

3. The system of claim 1, wherein the logic element is further configured to determine whether the first mobile asset/vehicle or the second mobile asset/vehicle can complete the work request first.

4. The system of claim 1, wherein the first vehicle asset communicator is adapted to display to a first operator an indication that the first work request is assigned to the first mobile asset/vehicle and to receive a response from the first operator indicating to the controller that the first operator accepts or declines the work request.

5. The system of claim 4, the logic element being further configured to receive the response from the first operator and reassign the work request to the second mobile asset/vehicle if the first operator declines the work request.

6. The system of claim 4, the logic element being further configured to reassign the work request to the second mobile asset/vehicle if the first operator fails to accept or decline the work request within a predetermined amount of time.

7. The system of claim 1, the first vehicle asset communicator being adapted to receive a cancel task command from the first operator indicating that a previously accepted task will not be completed.

8. The system of claim 7, the logic element being further configured to reassign the work request to the second mobile asset/vehicle if the first operator cancels the work request after accepting the work request.

9. The system of claim 1, the operational parameters of the first mobile asset/vehicle comprising the location of the first mobile asset/vehicle, the operational parameters of the second mobile asset/vehicle comprising the location of the second mobile asset/vehicle.

10. The system of claim 1, further comprising a first local monitor having a wireless transceiver, the local monitor capable of communication with the first vehicle asset communicator, the second vehicle asset communicator, and the first controller, the first local monitor being operative to provide communications between the first and second vehicle asset communicators and the first controller.

11. An asset control system for managing a fleet of mobile assets/vehicles, the control system comprising:
a work request receipt interface for receiving a work request from a user and storing the work request to a work request queue;
a work request assignment engine for:
receiving operational parameters for a plurality of mobile asset/vehicles;
selecting a work request from the work request queue to assign to a mobile asset/vehicle; and
determining which mobile asset to assign the task to based on the operational parameters of the mobile asset/vehicles; and
a work request handler module for transmitting the work request to the assigned mobile asset/vehicle.

12. The asset control system of claim 11, the work request assignment engine receiving data related to the operational status of the fleet and applying the set of heuristics to the data to determine which mobile asset/vehicle to assign the selected work request to.

13. The asset control system of claim 11, the work request assignment engine selecting a work request based upon the status of the work request in the queue.

14. The asset control system of claim 11, the work request assignment engine applying the operational requirements of the selected work request to the set of heuristics to determine which mobile asset/vehicle to assign the selected work request to.

15. The asset control system of claim 12, the operational status including the location of each mobile asset/vehicle in the fleet, the work request assignment engine determining which mobile asset/vehicle in the fleet is closest to a start area of the selected work request and assigning the work request to the mobile asset/vehicle closest to the start area.

16. The asset control system of claim 11, the work request handler module wirelessly transmitting a work request to a vehicle asset communicator of a mobile asset/vehicle that the work request assignment engine assigned the work request to and receiving a response from an operator of the mobile asset/vehicle that the operator accepts or declines the task.

17. The asset control system of claim 11, the work request assignment engine determining which mobile asset/vehicle in the fleet can begin the work request first by analyzing the current work load of each mobile asset/vehicle in the fleet and assigning the selected to work request to the mobile asset/vehicle that can begin the work request first.

18. A method for managing a plurality of mobile assets/vehicles each having a vehicle asset communicator, the method comprising:
receiving a work request to be executed by one or more of the plurality of mobile asset/vehicles, the work request having associated operational requirements;
monitoring one or more operational parameters of the mobile assets/vehicles;
selecting a first mobile asset/vehicle of said plurality of mobile asset/vehicles to assign the work request to based upon the monitored operational parameters of the mobile assets/vehicles and the operational requirements of the work request; and
transmitting the work request to the vehicle asset communicator of the first mobile asset/vehicle.

19. The method of claim 18 further comprising,
providing an internet based interface to a user for creating a new work request and checking the status of the new work request after it is submitted.

20. The method of claim 18 further comprising,
providing an indication to an operator of the first mobile asset/vehicle via the vehicle asset communicator indicating that a work request has been assigned to the first mobile asset/vehicle.

21. The method of claim 20 further comprising,
prompting the operator of the first mobile asset/vehicle to accept or decline the work request.

22. The method of claim 20 further comprising,
receiving an accept command from a user of the first mobile asset/vehicle indicating that the work request has been accepted.

23. The method of claim 20, further comprising receiving a decline command indicating that a user of the first mobile asset/vehicle has declined the work request.

24. The method of claim 23, further comprising,
selecting a second mobile asset/vehicle of said plurality of mobile asset/vehicles to assign the work request to based upon the monitored operational parameters of the mobile assets/vehicles and the operational requirements of the work request; and
transmitting the work request to the vehicle asset communicator of the second mobile asset/vehicle.

25. The method of claim 20, further comprising receiving a cancel command indicating that a user of the first mobile asset/vehicle will not complete an accepted work request.

26. The method of claim 25, further comprising,
selecting a second mobile asset/vehicle of said plurality of mobile asset/vehicles to assign the work request to based upon the monitored operational parameters of the mobile assets/vehicles and the operational requirements of the work request; and
transmitting the work request to the vehicle asset communicator of the second mobile asset/vehicle.

27. The method of claim 20 further comprising,
selecting a second mobile asset/vehicle of said plurality of mobile asset/vehicles to assign the work request to based upon the monitored operational parameters of the mobile assets/vehicles and the operational requirements of the work request if the user of the first mobile asset/vehicle does not accept the work request within a predetermined period of time; and
transmitting the work request to the vehicle asset communicator of the second mobile asset/vehicle.

28. The method of claim 18, wherein operational parameters comprise vehicle location.

29. The method of claim 18, wherein operational parameters comprise vehicle type.

30. The method of claim 18, wherein operational parameters comprise a number of pending work requests.

31. The method of claim 18, wherein operational parameters comprise mobile asset/vehicle operator training level.

32. The method of claim 18, wherein operational parameters comprise maintenance status.

33. The method of claim 18, wherein operational parameters comprise maximum payload size.

34. The method of claim 18, wherein operational parameters comprise current load status.

35. The method of claim 18, wherein operational parameters comprise maximum speed.

36. The method of claim 18, wherein operational parameters comprise current speed.

37. The method of claim 18, wherein operational parameters comprise time since last stop.

38. The method of claim 18, wherein operational parameters comprise time since last lift.

39. The method of claim 18, wherein operational requirements comprise operator training level.

40. The method of claim 18, wherein operational requirements comprise payload size.

41. The method of claim 18, wherein operational requirements comprise work request completion time.

42. The method of claim 18, wherein operational requirements comprise work request completion date.

43. The method of claim 18, wherein operational requirements comprise location data.

44. The method of claim 18, wherein operational requirements comprise mobile asset/vehicle type.

45. The method of claim 18, wherein selecting a first mobile asset/vehicle of said plurality of mobile asset/vehicles to assign the work request to based upon the monitored operational parameters of the mobile assets/vehicles and the operational requirements of the work request comprises selecting the mobile asset/vehicle of said plurality of mobile asset/vehicles that is closest to a location associated with the work request.

46. The method of claim 18, wherein selecting a first mobile asset/vehicle of said plurality of mobile asset/vehicles to assign the work request to based upon the monitored operational parameters of the mobile assets/vehicles and the operational requirements of the work request comprises selecting the mobile asset/vehicle of said plurality of mobile asset/vehicles that meets the operational requirements of the work request and is closest to a location associated with the work request.

47. The method of claim 18 further comprising, selecting a first mobile asset/vehicle of said plurality of mobile asset/vehicles to assign the work request to based upon the seniority of an operator assigned to the first mobile asset/vehicle.

48. The method of claim 18 further comprising, monitoring completion times of assigned work requests to determine an average time for completing a work request based upon work request type.
